(19) United States
(12) Patent Application Publication
(10) Pub. No.: US 2012/0188052 A1
(43) Pub. Date: Jul. 26, 2012

(54) SYSTEM AND METHOD FOR SIMPLIFIED CONTROL OF ELECTRONIC DEVICES

(75) Inventors: Michael Rosenblatt, Campbell, CA (US); Gloria Lin, San Ramon, CA (US); Sean Anthony Mayo, Dover, NH (US); Taido Lantz Nakajima, Cupertino, CA (US)

(73) Assignee: APPLE INC., Cupertino, CA (US)

(21) Appl. No.: 13/436,529

(22) Filed: Mar. 30, 2012

Related U.S. Application Data
(63) Continuation of application No. 12/286,457, filed on Sep. 30, 2008.

(51) Int. Cl. G05B 19/02

(52) U.S. Cl. 340/4.3

(57) ABSTRACT

Systems, methods, and devices for simplified control over electronic devices are provided. For example, a method for controlling a variety of electronic devices using another single electronic device may include receiving control information associated with a controllable electronic device via near field communication, determining a control scheme for controlling the controllable electronic device based on the control information, and controlling the controllable electronic device using the determined control scheme. The control information may be received from a near field communication interface of the controllable electronic device or from a radio frequency identification tag associated with the controllable electronic device.

### CROSS REFERENCE TO RELATED APPLICATIONS

The present application is a Divisional Application of U.S. patent application Ser. No. 12/2986,457 filed on Sep. 30, 2008.

### BACKGROUND

1. Technical Field

The present disclosure relates generally to controlling an electronic device using another electronic device and, more particularly, to controlling an electronic device using another electronic device in a simplified manner.

2. Description of the Related Art

This section is intended to introduce the reader to various aspects of art that may be related to various aspects of the present disclosure, which are described or claimed below. This discussion is believed to be helpful in providing the reader with background information to facilitate a better understanding of the various aspects of the present disclosure. Accordingly, it should be understood that these statements are to be read in this light, and not as admissions of prior art.

A person may use a wide variety of electronic devices each day, including computers and media players, televisions and other entertainment devices, thermostats and other utility devices, and/or consumer electronics such as digital cameras. Each electronic device may generally be controlled locally or using an associated remote control device. Initiating and establishing control of each device may involve a series of complicated, unintuitive procedures using separate remote controls.

### SUMMARY

Certain aspects commensurate in scope with the disclosed embodiments are set forth below. It should be understood that these aspects are presented merely to provide the reader with a brief summary of certain forms the invention might take and that these aspects are not intended to limit the scope of the invention. Indeed, the invention may encompass a variety of aspects that may be set forth below.

By way of example, a method for controlling a variety of electronic devices using another single electronic device may include receiving control information associated with a controllable electronic device via near field communication, determining a control scheme for controlling the controllable electronic device based on the control information, and controlling the controllable electronic device using the determined control scheme. The control information may be received from a near field communication interface of the controllable electronic device or from a radio frequency identification tag associated with the controllable electronic device.

### BRIEF DESCRIPTION OF THE DRAWINGS

Advantages of the invention may become apparent upon reading the following detailed description and upon reference to the drawings in which:

FIG. 1 is a block diagram illustrating an electronic device configured to control or be controlled by another electronic device;

FIG. 2 is a schematic of a handheld device representing an embodiment of a controlling electronic device of FIG. 1;

FIG. 3 is a schematic of a computer representing an embodiment of a controlling electronic device of FIG. 1;

FIG. 4 is a schematic of a standalone media player representing an embodiment of a controllable electronic device of FIG. 1;

FIG. 5 is a schematic of a remote controller for the standalone media player of FIG. 4;

FIG. 6 is a schematic of a video game controller for the standalone media player of FIG. 4 or a video game system;

FIG. 7 is a block diagram representing communication channels that may be established between a controlling electronic device and a controllable electronic device;

FIG. 8 is a schematic of an RFID tag configured to provide control information regarding a controllable electronic device to a controlling electronic device;

FIG. 9 is a matrix barcode configured to provide control information regarding a controllable electronic device to a controlling electronic device;

FIG. 10 is a flowchart describing a method for establishing control over a controllable electronic device using a controlling electronic device;

FIGS. 11A-E are schematics of screens that may be displayed on a controlling electronic device for establishing control over a controllable electronic device;

FIG. 12 is a schematic of a control initiation operation for establishing control over a controlling electronic device;

FIG. 13 is a block diagram representing communication that may take place during the control initiation operation of FIG. 12;

FIGS. 14A-E are schematics of screens that may be displayed on the controlling electronic device for obtaining and installing control software;

FIG. 15 is a block diagram representing communication that may take place during the installation procedures of FIGS. 14A-E;

FIG. 16 is a block diagram representing alternative communication that may take place during the installation procedure of FIGS. 14A-E;

FIG. 17 is a schematic of a device control operation for controlling the standalone media player of FIG. 5 from the handheld device of FIG. 2;

FIG. 18 is a flowchart describing a method for establishing control over a controllable electronic device;

FIG. 19 is a schematic of a control initiation operation for establishing control over a controllable electronic device;

FIG. 20 is a block diagram representing communication that may take place during the control initiation operation of FIG. 19;

FIG. 21 is a schematic of a screen that may be displayed on a controlling electronic device as a prompt to initiate control;

FIG. 22 is a flowchart describing a alternative method of establishing control over a controllable electronic device;

FIGS. 23A-B are schematics of screens that may be displayed on a controlling electronic device for establishing control over a controllable electronic device;

FIG. 24 is a schematic of a control initiation operation for establishing control over a controllable electronic device;

FIG. 25 is a block diagram representing communication that may take place during the control initiation operation of FIG. 24;

FIG. 26 is a block diagram representing communication that may take place following the control initiation operation of FIG. 24;

FIG. 27 is a block diagram representing alternative communication that may take place following the control initiation operation of FIG. 24;

FIG. 28 is a block diagram describing an alternative method for establishing control over a controllable electronic device;

FIGS. 29A-C are schematics of screens that may be displayed for the alternative manner of establishing control of the flowchart of FIG. 28;

FIG. 30 is a schematic of a control initiation operation for establishing control over a controllable electronic device according to the method of the flowchart of FIG. 28;

FIG. 31 is a block diagram representing communication that may take place during the control initiation operation of FIG. 30;

FIG. 32 is a flowchart describing an alternative method of establishing control over a controllable electronic device;

FIGS. 33A-E are schematics of screens that may be displayed in carrying out the method of the flowchart of FIG. 32;

FIG. 34 is a flowchart describing a method of establishing control over a controllable electronic device;

FIGS. 35A-E are schematics of screens that may be displayed in carrying out the method of the flowchart of FIG. 34;

FIG. 36 is a block diagram representing communication that may take place in carrying out the method of the flowchart of FIG. 34;

FIG. 37 is a block diagram representing alternative communication that may take place in carrying out the method of the flowchart of FIG. 34;

FIG. 38 is a flowchart describing an alternative method of establishing control over a controllable electronic device;

FIG. 39 is a flowchart describing an alternative method of establishing control over a controllable electronic device;

FIG. 40 is a control initiation operation for establishing control over a controllable electronic device when the controllable electronic device is capable of playing digital media;

FIGS. 41A-B are schematics of screens that may be displayed following control initiation operation of FIG. 40;

FIG. 42 is a schematic of a control operation for controlling a controllable electronic device;

FIG. 43 is a schematic of an alternative control initiation operation for establishing control over a controllable electronic device;

FIG. 44 is a schematic of a control initiation operation for controlling a video game system;

FIGS. 45A-C are schematics of screens that may be displayed for controlling a video game system;

FIG. 46 is a schematic of a control initiation operation for establishing control over a digital video recorder (DVR);

FIGS. 47A-D are schematics of screens that may be displayed following the display for controlling the DVR of FIG. 46;

FIG. 48 is a schematic of a control initiation operation for establishing control over an optical disc player;

FIGS. 49A-C are schematics of screens that may be displayed for controlling the optical disc player;

FIG. 50 is a schematic of a control initiation operation for establishing control over a satellite television or cable television receiver;

FIGS. 51A-C are schematic of screens that may be displayed for controlling the satellite television or cable television receiver of FIG. 50;

FIG. 52 is a schematic of a control initiation operation for establishing control over a video game system;

FIG. 53 is a schematic of a screen that may be displayed for controlling the video game system of FIG. 52;

FIG. 54 is a control initiation operation for establishing control over a television;

FIGS. 55A-C are schematics of screens that may be displayed for controlling the television of FIG. 54;

FIG. 56 is a schematic of a control initiation operation for establishing control over an audio/video (A/V) receiver;

FIGS. 57A-C are schematics of screens that may be displayed for controlling the A/V receiver of FIG. 56;

FIGS. 58A-F are schematics of screens that may be displayed for controlling a variety of the electronic devices of FIG. 1 from a single device;

FIGS. 59A-G are schematics of screens that may be displayed for controlling a variety of controllable electronic devices from a single controlling electronic device;

FIG. 60 is a schematic of a control initiation operation for establishing control over software that may run on a controllable electronic device;

FIGS. 61A-C are schematics of screens that may be displayed for controlling presentation software that may run on a controllable electronic device;

FIG. 62 is a schematic of a control operation for controlling presentation software on a controllable electronic device;

FIGS. 63A-B are schematics of screens that may be displayed for controlling 3-D computer aided design (CAD) software that may run on a controllable electronic device;

FIG. 64 is a schematic of a control operation for controlling the 3-D CAD software that may run on a controllable electronic device;

FIGS. 65A-E are schematics of screens that may be displayed for controlling a pointer or character entry on a controllable electronic device;

FIG. 66 is a schematic of a control operation for controlling a pointer on a controllable electronic device;

FIGS. 67A-B are schematics of screens that may be displayed for controlling a web browser that may run on a controllable electronic device;

FIG. 68 is a schematic of a control initiation operation for establishing control over a digital projector;

FIGS. 69A-B are schematics of screens that may be displayed for controlling the projector of FIG. 68;

FIG. 70 is a schematic of a control initiation operation for establishing control over a thermostat;

FIGS. 71A-E are schematics of screens that may be displayed for controlling the thermostat of FIG. 70;

FIG. 72 is a schematic of a control initiation operation for establishing control over a networked light switch;

FIGS. 73A-E are schematics of screens that may be displayed for controlling the networked light switch of FIG. 72;

FIG. 74 is a schematic of a control initiation operation for establishing control over a home security system;

FIGS. 75A-D are schematics of screens that may be displayed for controlling the home security system of FIG. 74;

FIG. 76 is a schematic of a control initiation operation for establishing control over a garage door opener or security gate;

FIGS. 77A-D are schematics of screens that may be displayed for controlling the garage door opener or security gate of FIG. 76;

FIG. 78 is a schematic of a control initiation operation for establishing control over a sprinkler system;

FIGS. 79A-D are schematics of screens that may be displayed for controlling the sprinkler system of FIG. 78;

FIG. 80 is a schematic of a control initiation operation for establishing control over a digital camera;

FIGS. 81A-B are schematics of screens that may be displayed for controlling the digital camera of FIG. 80

### DETAILED DESCRIPTION OF SPECIFIC EMBODIMENTS

The myriad electronic devices a person may own may frequently be controlled individually. For example, the person may control a television with a television remote controller and an audio/video (A/V) receiver with an A/V receiver remote controller. Using the techniques described below, a user may control many electronic devices from a single device. Moreover, control may be initiated in a simplified manner; to control one device from another, the user may simply tap the two devices together.

One or more specific embodiments of the present invention are described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

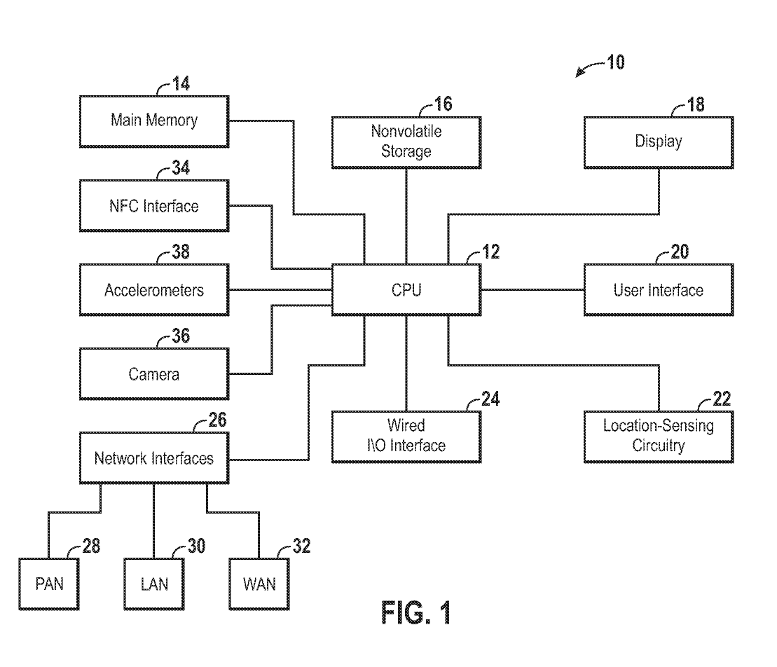

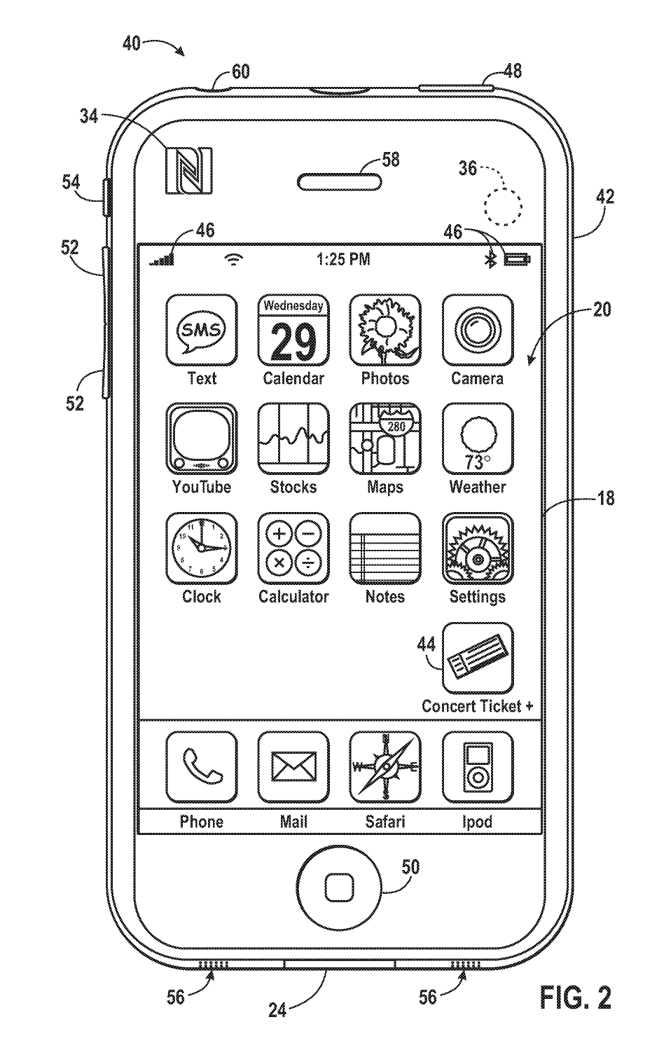

FIG. 1 illustrates an electronic device 10 that may be configured as a controllable device or a controlling device. As discussed below with reference to FIGS. 2-7, the electronic device 10 may represent, among other things, a handheld device, a computer, a media player, a remote controller or a game controller associated with the media player or the computer, or other consumer devices, such as a digital video recorder (DVR), optical disc player, television, etc. As such, the electronic device 10 may represent, for example, an iPhone®, iPod®, iMac®, MacBook®, or AppleTV® available from Apple, Inc., or other devices by any manufacturer. It should be appreciated that embodiments of the electronic device 10 may include more or fewer elements than depicted in FIG. 1. Indeed, in one embodiment, the electronic device 10 may be an iPhone® configured as a controlling device to control one or more controllable devices, which may be computers, televisions, DVRs, optical disc players, standalone media players, satellite television or cable television receivers, audio/video (A/V) receivers, digital projectors, networkable thermostats, networkable security systems, networkable lighting, networkable garage door or security gate openers, networkable sprinkler systems, or digital cameras, etc.

The electronic device 10 may include at least one central processing unit (CPU) 12. For example, the CPU 12 may represent one or more microprocessors, and the microprocessors may be “general purpose” microprocessors, a combination of general and special purpose microprocessors, or ASICS. Additionally or alternatively, the CPU 12 may include one or more reduced instruction set (RISC) processors, video processors, or related chip sets. The CPU 12 may provide processing capability to execute an operating system, run various applications, and/or provide processing for one or more of the techniques described herein. Applications that may run on the electronic device 10 may include, for example, software for managing and playing audiovisual content, software for managing a calendar, software for controlling telephone capabilities, and software for controlling other electronic devices 10, as noted below.

A main memory 14 may be communicably coupled to the CPU 12, which may store data and executable code. The main memory 14 may represent volatile memory such as RAM, but may also include nonvolatile memory, such as read-only memory (ROM) or Flash memory. In buffering or caching data related to operations of the CPU 12, the main memory 14 may store data associated with applications running on the electronic device 10.

The electronic device 10 may also include nonvolatile storage 16. The nonvolatile storage 16 may represent any suitable nonvolatile storage medium, such as a hard disk drive or nonvolatile memory, such as Flash memory. Being well-suited to long-term storage, the nonvolatile storage 16 may store data files such as media (e.g., music and video files), software (e.g., for implementing functions on the electronic device 10), preference information (e.g., media playback preferences), lifestyle information (e.g., food preferences), exercise information (e.g., information obtained by exercise monitoring equipment), transaction information (e.g., information such as credit card information), wireless connection information (e.g., information that may enable media device to establish a wireless connection such as a telephone connection), subscription information (e.g., information that maintains a record of podcasts or television shows or other media a user subscribes to), as well as telephone information (e.g., telephone numbers). It should be appreciated that data associated with controlling certain other electronic devices 10, such as control software plug-ins, may be saved in the nonvolatile storage 16, as discussed further below.

A display 18 may display images and data for the electronic device 10. It should be appreciated that only certain embodiments may include the display 18. The display 18 may be any suitable display, such as liquid crystal display (LCD), a light emitting diode (LED) based display, an organic light emitting diode (OLED) based display, a cathode ray tube (CRT) display, or an analog or digital television. In some embodiments, the display 18 may function as a touch screen through which a user may interact with the electronic device 10.

The electronic device 10 may further include a user interface 20. The user interface 20 may represent indicator lights and user input structures, but may also include a graphical user interface (GUI) on the display 18. In practice, the user interface 20 may operate via the CPU 12, using memory from the main memory 14 and long-term storage in the nonvolatile storage 16. In an embodiment lacking the display 18, indicator lights, sound devices, buttons, and other various input/output (I/O) devices may allow a user to interface with the electronic device 10. In an embodiment having a GUI, the user interface 20 may provide interaction with interface elements on the display 18 via certain user input structures, user input peripherals such as a keyboard or mouse, or a touch sensitive implementation of the display 18.

As should be appreciated, one or more applications may be open and accessible to a user via the user interface 20 and displayed on the display 18 of the electronic device 10. The applications may run on the CPU 12 in conjunction with the main memory 14, the nonvolatile storage 16, the display 18, and the user interface 20. As will be discussed in greater detail below, instructions stored in the main memory 14, the nonvolatile storage 16, or the CPU 12 of the electronic device 10 may enable a user to control another electronic device 10. For example, a user may control many other electronic devices 10 from a single electronic device 10, rather than control the other electronic devices 10 individually. As such, it should be appreciated that the instructions for carrying out such techniques on the electronic device 10 may represent a standalone application, a function of the operating system of the electronic device 10, or a function of the hardware of the CPU 12, the main memory 14, the nonvolatile storage 16, or other hardware of the electronic device 10.

In certain embodiments, the electronic device 10 may include location sensing circuitry 22. The location sensing circuitry 22 may represent global positioning system (GPS) circuitry, but may also represent one or more algorithms and databases, stored in the nonvolatile storage 16 or main memory 14 and executed by the CPU 12, which may be used to infer location based on various observed factors. For example, the location sensing circuitry 22 may represent an algorithm and database used to approximate geographic location based on the detection of local 802.11x (Wi-Fi) networks or nearby cellular phone towers. As discussed below, the electronic device 10 may employ the location sensing circuitry 22 as a factor for carrying out certain device control techniques. By way of example, the location sensing circuitry 22 may be used by the electronic device 10 to determine a user's location during an event; the location during the event may cause different information to be displayed on the electronic device 10.

With continued reference to FIG. 1, the electronic device 10 may also include a wired input/output (I/O) interface 24 for a wired interconnection between one electronic device 10 and another electronic device 10. The wired I/O interface 24 may represent, for example, a universal serial bus (USB) port or an IEEE 1394 or FireWire® port, but may also represent a proprietary connection. Additionally, the wired I/O interface 24 may permit a connection to user input peripheral devices, such as a keyboard or a mouse.

An infrared (IR) interface 25 may enable the electronic device 10 to receive and/or transmit signals with infrared light. By way of example, the IR interface 25 may comply with an infrared IrDA specification for data transmission. Alternatively, the IR interface 25 may function exclusively to receive control signals or to output control signals. In this way, the electronic device 10 may issue signals to control other electronic devices 10 that may lack other interfaces for communication.

One or more network interfaces 26 may provide additional connectivity for the electronic device 10. The network interfaces 26 may represent, for example, one or more network interface cards (NIC) or a network controller. In certain embodiments, the network interface 26 may include a personal area network (PAN) interface 28. The PAN interface 28 may provide capabilities to network with, for example, a Bluetooth® network, an IEEE 802.15.4 (e.g., ZigBee) network, or an ultra wideband network (UWB). As should be appreciated, the networks accessed by the PAN interface 28 may, but do not necessarily, represent low power, low bandwidth, or close range wireless connections. The PAN interface 28 may permit one electronic device 10 to connect to another local electronic device 10 via an ad-hoc or peer-to-peer connection. However, the connection may be disrupted if the separation between the two electronic devices 10 exceeds the range of the PAN interface 28.

The network interface 26 may also include a local area network (LAN) interface 30. The LAN interface 30 may represent an interface to a wired Ethernet-based network, but may also represent an interface to a wireless LAN, such as an IEEE 802.11x wireless network. The range of the LAN interface 30 may generally exceed the range available via the PAN interface 28. Additionally, in many cases, a connection between two electronic devices 10 via the LAN interface 30 may involve communication through a network router or other intermediary device.

For some embodiments of the electronic device 10, the network interfaces 26 may include the capability to connect directly to a wide area network (WAN) via a WAN interface 32. The WAN interface 32 may permit a connection to a cellular data network, such as the Enhanced Data rates for GSM Evolution (EDGE) network or other 3G network. When connected via the WAN interface 32, the electronic device 10 may remain connected to the Internet and, in some embodiments, to another electronic device 10, despite changes in location that might otherwise disrupt connectivity via the PAN interface 28 or the LAN interface 30. As will be discussed below, the wired I/O interface 24 and the network interfaces 26 may represent high-bandwidth communication channels for transferring user data using the simplified data transfer techniques discussed herein.

Certain embodiments of the electronic device 10 may also include a near field communication (NFC) interface 34. The NFC interface 34 may allow for extremely close range communication at relatively low data rates (e.g., 464 kb/s), and may comply with such standards as ISO 18092 or ISO 21521, or it may allow for close range communication at relatively high data rates (e.g., 560 Mbps), and may comply with the TransferJet® protocol. The NFC interface 34 may have a range of approximately 2 to 4 cm. The close range communication with the NFC interface 34 may take place via magnetic field induction, allowing the NFC interface 34 to communicate with other NFC interfaces 34 or to retrieve information from tags having radio frequency identification (RFID) circuitry. As discussed below, the NFC interface 34 may provide a manner of initiating or facilitating a transfer of user data from one electronic device 10 to another electronic device 10.

The electronic device 10 of FIG. 1 may also include a camera 36. With the camera 36, the electronic device 10 may obtain digital images or videos. In combination with optical character recognition (OCR) software, barcode-reading software, or matrix-code-reading software running on the electronic device 10, the camera 36 may be used to input data from printed materials having text or barcode information. Such data may include information indicating how to control another device from a matrix barcode that may be printed on the other device, as described below.

In certain embodiments of the electronic device 10, one or more accelerometers 38 may sense the movement or orientation of the electronic device 10. The accelerometers 38 may provide input or feedback regarding the position of the electronic device 10 to certain applications running on the CPU 12. By way of example, the accelerometers 38 may include a 3-axis accelerometer from ST Microelectronics.

FIGS. 2-7 illustrate various specific embodiments of the electronic device 10 of FIG. 1. It should be appreciated that the specific embodiments of the electronic device 10 depicted in FIGS. 2-7 are representative only and should not be understood as exclusive. Turning first to FIG. 2, a handheld device 40 may represent an embodiment of the electronic device 10 of FIG. 1. By way of example, the handheld device 40 may be a portable phone or a portable media player, such as an iPhone® or an iPod® available from Apple Inc.

The handheld device 40 may have an enclosure 42 of plastic, metal, composite materials, or other suitable materials in any combination. The enclosure 42 may protect the interior components of the handheld device 40 from physical damage and electromagnetic interference (EMI). Additionally, the enclosure 42 may allow certain frequencies of electromagnetic radiation to pass through to wireless communication circuitry within the handheld device 40 to facilitate wireless communication.

The display 18 of the handheld device 40 may include the user interface 20 in the form of a GUI, which may have a number of individual icons representing applications that may be activated. In some embodiments of the handheld device 40, the display 18 may serve as a touch-sensitive input device and the icons may be selected by touch. In some embodiments, a device control application icon 44 may be selectable by a user. Here, the device control application is designated as “Remote” to indicate that selection of the icon 44 will allow the user to remotely control other devices.

When the device control application icon 44 is selected, the device control application may open, as described further below. The device control application may enable a user to control other electronic devices 10 using the techniques described herein. The user interface 20 on the display 18 of the handheld device 40 may also include certain status indicator icons 46, which may indicate the status of various components of the handheld device 40. For example, the status indicator icons may include a cellular reception meter, an icon to indicate when the PAN interface 28 is active (e.g., when a Bluetooth network is in use), or a battery life meter.

The handheld device 40 may connect to another electronic device 10, such as a computer, through the wired I/O interface 24 located at the bottom of the device. For example, the wired I/O interface 24 may be a proprietary connection for interconnecting the handheld device 40 and another electronic device 10 via USB or FireWire®. Once connected, the devices may synchronize and/or transfer certain data, such as information indicating how one device may control the other.

User input structures 48, 50, 52, and 54 may supplement or replace the touch-sensitive input capability of the display 18 for interaction with the user interface 20. By way of example, the user input structures 48, 50, 52, and 54 may include buttons, switches, a control pad, keys, knobs, a scroll wheel, or any other suitable input structures. The user input structures 48 and 50 may work in conjunction with the display 18 to control functions of the device. Particularly, the user input structure 48 may be a lock/unlock sliding button to lock or unlock the handheld device 40; the user input structure 50 may be a navigation button for navigating the user interface 20 to a default or home screen; the user input structures 52 may be a pair of buttons for navigating up or down a screen of the user interface 20 or for controlling volume; and the user input structure 54 may be an on/off button.

Certain embodiments of the handheld device 40 may include telephone functionality. As such, the handheld device 40 may include audio input structures 56 and an audio output structure 58. The audio input structures 56 may be one or more microphones for receiving voice data from a user, and the audio output structure 58 may be a speaker for outputting audio data, such as data received by the handheld device 40 over a cellular network. In certain embodiments, an audio port 60 may facilitate peripheral audio input and output devices, such as headsets, speakers, or microphones for use with the handheld device 40. It should be appreciated that telephone functionality associated with the handheld device 40 may also include emitting a ringtone through the audio output structure 58, causing the handheld device 40 to vibrate, or changing images on the display to indicate an incoming phone call.

As noted above, some embodiments of the electronic device 10 may include the NFC interface 34. The handheld device 40 depicted in FIG. 2 may include the NFC interface 34 in any suitable location within the enclosure 42. Because the NFC interface 34 may permit communication at a very short range, the location of the NFC interface 34 in the handheld device 40 may be indicated on exterior of the enclosure 42, as illustrated in FIG. 2. The NFC interface 34 may enable the handheld device 40 to engage in near field communication (NFC) with RFID tags or other NFC enabled electronic devices 10. For example, the NFC interface 34 may provide a manner of receiving information indicating how to control another device from an NFC interface 34 or an RFID tag located on the other device, as described further below.

The handheld device 40 of FIG. 2 may additionally include the camera 36, which may be located, for example, on the back of the handheld device 40. As discussed further below, the camera 36 may be used to obtain a digital image of a matrix barcode located on another electronic device 10. The handheld device 40 may thereafter employ matrix-code-reading software to extract control information from the image, as described further below.

It should also be appreciated that the handheld device 40 may include the location sensing circuitry 22 or the accelerometers 38. Certain applications running on the handheld device 40 may obtain information relating to the position, orientation, or movement of the handheld device from the location sensing circuitry 22 or the accelerometers 38. The position, orientation, or movement information may enable applications to display personalized data or to display data in an innovative manner in response to user movement.

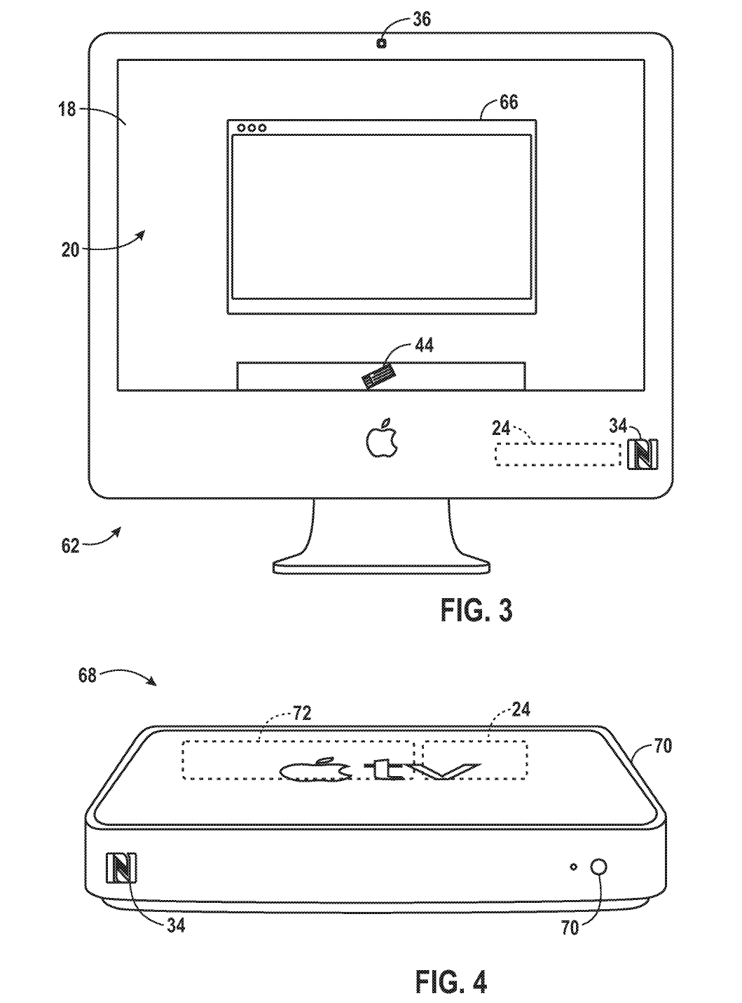

Turning to FIG. 3, a computer 62 may represent another embodiment of the electronic device 10 of FIG. 1. The computer 62 may be any computer, such as a desktop computer, a server, or a notebook computer, but may also be a standalone media player or video gaming machine. By way of example, the computer 62 may be an iMac®, a MacBook®, or an AppleTV® by Apple Inc. It should be noted that the computer 62 may also represent a personal computer (PC) by another manufacturer. An enclosure 64 may protect internal components of the computer 62. Such internal components may include, for example, the CPU 12, the main memory 14, the nonvolatile storage 16, certain network interfaces 26, and/or the NFC interface 34.

The location of the NFC interface 34 may be noted by a label on the exterior of the enclosure 64. The NFC interface 34 may permit near field communication between the computer 62 and other NFC enabled electronic devices 10, such as the handheld device 40. As should be appreciated, the NFC interface 34 may also enable the computer 62 to receive information indicating how to control another device from an NFC interface 34 or an RFID tag located on the other device, as described further below.

The display 18 of the computer 62 may display the user interface 20 in the form of a GUI. The user interface 20 of the computer 62 may depict any user data associated with applications 66 running on the computer 62. Additionally, the user interface 20 may include a variety of icons related to applications installed on the computer 62. One such icon may be the device control application icon 44. When the device control application icon 44 is selected, the device control application may open. The device control application may enable a user to control another device using the techniques described herein.

A user of the computer 62 may interact with the user interface 20 with various peripheral input devices, such as a keyboard or mouse, which may connect to the computer 62 via the wired I/O interface 24. The wired I/O interface 24 may also provide a high bandwidth communication channel for interconnecting other electronic devices 10, such as the handheld device 40, to the computer 62.

The computer 62 may also include the camera 36. As discussed further below, the camera 36 may obtain, among other things, a digital image of a matrix barcode encoding information relevant to device control. With the digital image, the handheld device 40 may employ matrix-code-reading software to extract control information from the image.

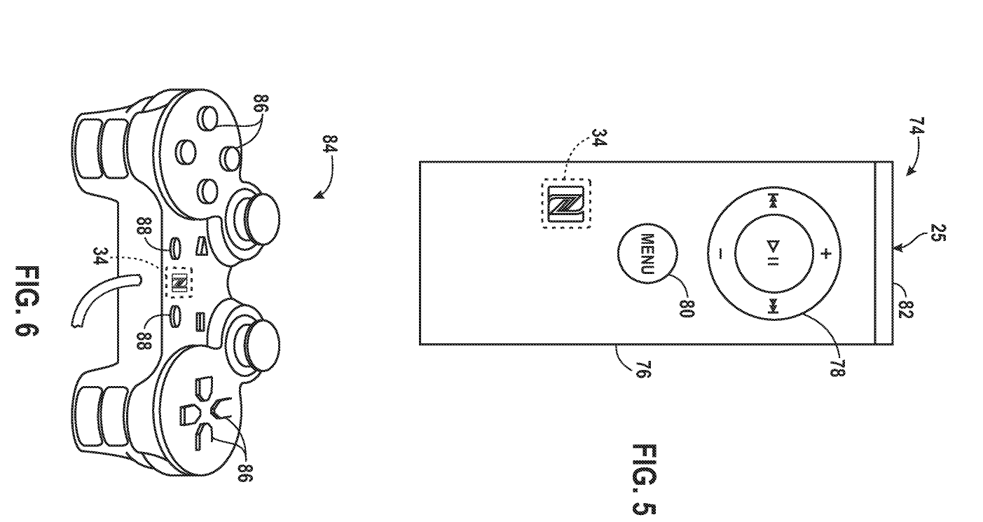

FIG. 4 depicts a standalone media player 68 representing another embodiment of the electronic device 10 of FIG. 1 that may be configured to operate using the techniques described herein. By way of example, the standalone media player 68 may be an AppleTV® device by Apple, Inc. However, the standalone media player 68 may also represent a media player or video game console by another manufacturer.

Within an enclosure 70 of the standalone media player 68 may reside various components of the electronic device 10. For example, the enclosure 70 may house the nonvolatile storage 16 for storing media files and media playback software and the CPU 12 for processing the media files. Wireless network interfaces 26, such as the PAN interface 28 and LAN interface 30, may also be located within the enclosure 70, allowing the standalone media player 68 to communicate with other electronic devices 10 or to connect to the Internet. Using the wireless network interfaces 26, the standalone media player 68 may obtain or exchange media content as well as gain access to the Internet.

The standalone media player 68 may also include, among other things, an indicator light and infrared (IR) port 72 and audio/video (A/V) outputs 74. The indicator light and IR port 72 may include the IR port 25, and may receive an IR control signal from a remote control. Further, the indicator light and IR port 72 may indicate to a user when the standalone media player 68 is on, off, receiving or exchanging content, or obtaining data in accordance with techniques described herein. The A/V outputs 74 may provide a manner for connecting the standalone media player 68 to an analog or digital television or other media display devices. The standalone media player 68 may additionally include the wired I/O interface 24, which may permit the standalone media player 68 to communicate rapidly with a wired connection to another electronic device 10.

The standalone media player 68 may also include the NFC interface 34. With the NFC interface 34, the standalone media player 68 may communicate with another electronic device 10 having another NFC interface 34. By way of example, as described further below, the NFC interface 34 may enable the standalone media player 68 to transmit control data to another NFC-enabled electronic device 10.

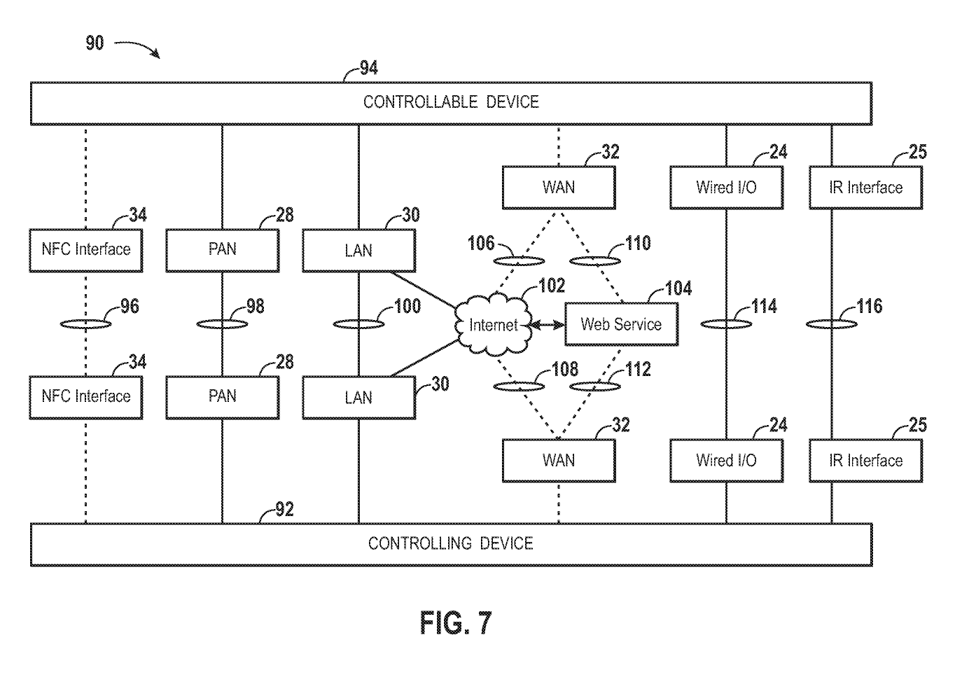

FIG. 5 illustrates a remote control 74, which may be used to control the standalone media player 68 of FIG. 4 or the computer 62 of FIG. 3. For example, the remote control 74 may represent another embodiment of the electronic device 10 of FIG. 1 and may be configured to operate with the simplified device control techniques described herein. By way of example, the remote control 74 may be an AppleTV® remote control adapted to perform the simplified device control techniques described below. It should be understood, however, that the remote control 74 may represent any remote control device capable of performing the simplified device control techniques.

An enclosure 76 of the remote control 74 may protect the internal components of the remote control 74 from physical damage or extraneous electromagnetic radiation, while permitting control signals, such as IR control signals, to exit for controlling the standalone media player 68 or the computer 62. Internal components protected by the enclosure 76 may include, for example, the CPU 12, the main memory 14, the nonvolatile storage 16, the IR interface 25, or the wireless network interfaces 26 of the PAN interface 28 or the LAN interface 30. The internal components may permit the remote control 74 to run device control software, to obtain a control software plug-in, and/or to control another device using the techniques discussed below.

The remote control 74 may include a multifunction button 78, which may permit a user to play, pause, fast forward, or rewind media, increase or decrease volume, or navigate a menu. Additionally, the remote control 74 may include a menu button 74 for navigating the standalone media player 68 or the computer 62 to a main menu screen. To control the standalone media player 68 or the computer 62, an infrared (IR) window 82 may permit control signals from the IR interface 25 to exit the enclosure 76 of the remote control 74. The control signals which exit the IR window 82 may be received by the indicator light and IR port 72 of the standalone media player 68 or by a peripheral device adapted for infrared communication communicably coupled to the computer 62.

As indicated by FIG. 5, the remote control 74 may also include the NFC interface 34. With the NFC interface 34, the remote control 74 may communicate with another electronic device 10 having another NFC interface 34. Using NFC communication via the NFC interface 34, the remote control 74 and the other electronic device 10 may initiate a simplified device control procedure that may transfer control over the other electronic device 10 to the remote control 74, or transfer control from the remote control 74 to the other device 10, according to techniques described in greater detail below.

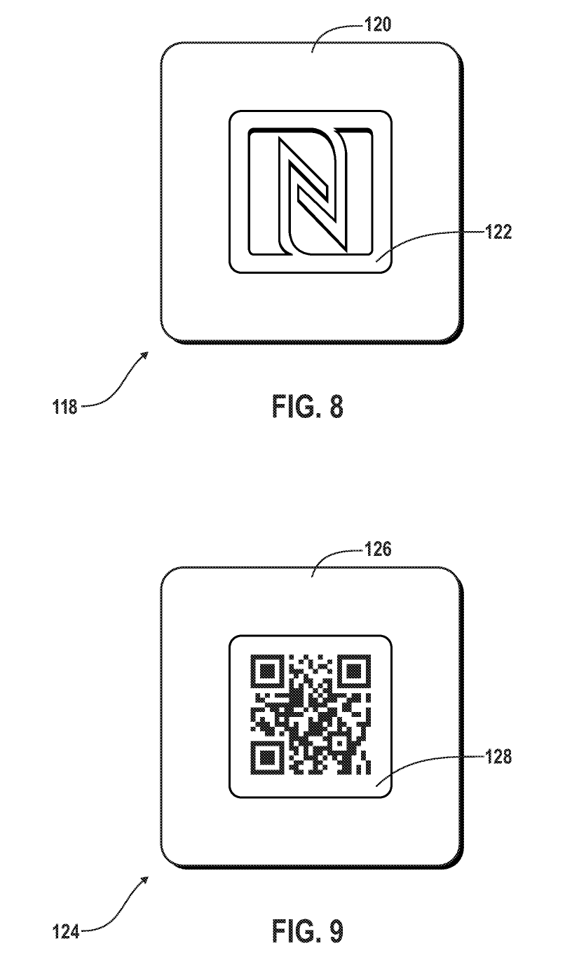

FIG. 6 illustrates a game controller 84 for use with a video gaming system, the computer 62, or the standalone media player 68. The game controller 84 may represent another embodiment of the electronic device 10 of FIG. 1 configured to perform the simplified device control techniques described below. The game controller 84 may provide a manner of interfacing with a game running on another electronic device 10, such as the standalone media player 68. An enclosure 85 of the game controller 84 may protect the internal components of the remote control 74 from physical damage or extraneous electromagnetic radiation. Internal components protected by the enclosure 85 may include, for example, the CPU 12, the main memory 14, the nonvolatile storage 16, or the wireless network interfaces 26 of the PAN interface 28 or the LAN interface 30. The internal components may permit the game controller 84 to store and transfer user data (e.g., game save data, digital photos, or music) using the simplified data transfer techniques discussed below.

To interface with the video gaming system, the computer 62, or the standalone media player 68, the game controller 84 may include various control buttons 86, such as a directional pad or other selection buttons. Indicator lights 88 may indicate to a user, among other things, when the game controller 84 is on, off, or communicating with another electronic device 10.

The game controller 84 may also include the NFC interface 34. With the NFC interface 34, the game controller 84 may communicate with another electronic device 10 having another NFC interface 34. Using NFC communication via the NFC interface 34, the game controller 84 and the other electronic device 10 may initiate a simplified device control procedure to or from the game controller 84 according to techniques described in greater detail below.

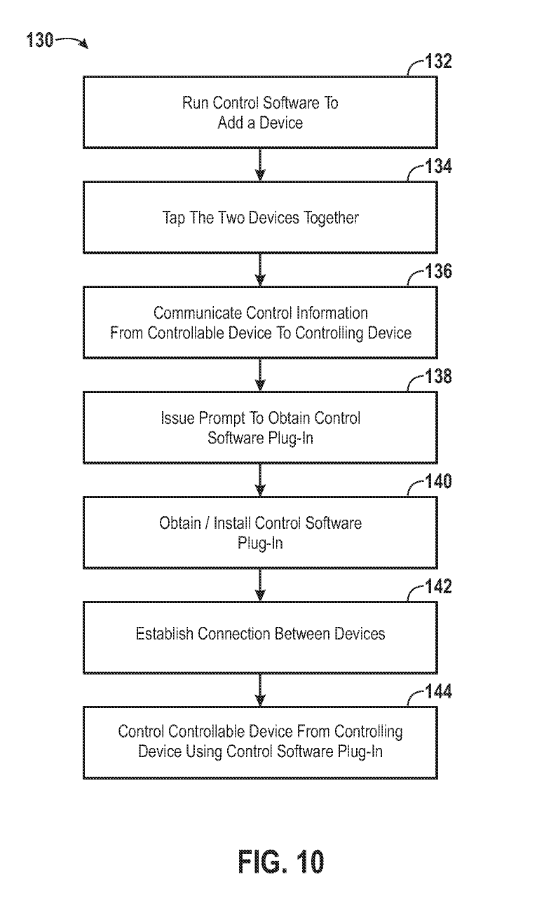

FIG. 7 is a block diagram of potential communication channels 90 over which communication between two electronic devices 10, denoted as a controlling device 92 and a controllable device 94, may take place during a simplified device control procedure. It should be appreciated that the communication channels 90 of FIG. 7 may be formed between any two electronic devices 10. Each communication channel 90 shared between the controlling device 92 and the controllable device 94 may be used for any data transfer that may take place between the two devices, and may include, for example, a transfer of control information indicating how the controllable device 94 may be controlled, a transfer of a control software plug-in for controlling the controllable device 94, or various intercommunication that may take place in a control stream for controlling the controllable device 94 using the controlling device 92.

Discussing each of the communication channels 90 in turn, a near field communication (NFC) communication channel 96 may be employed for data transfer between the controllable device 94 and the controlling device 92. The NFC communication channel 96 may arise if both the controlling device 92 and the controllable device 94 have NFC interfaces 34 that are placed in close proximity, such as may occur when the devices are tapped together. It should be appreciated that the NFC communication channel 96 may generally remain open for a relatively short period of time and may operate at a lower bandwidth. As such, the NFC communication channel 96 may generally accommodate a relatively small amount of initial data transfer; a follow-up data transfer may generally take place via another of the communication channels 90 described below.

As noted above, the controlling device 92 and the controllable device 94 may additionally be connected through any of the communication channels 90 other than the NFC communication channel 96. Particularly, if either device lacks the NFC interface 34, data transfer instead may take place over the other of the communication channels 90. As noted below, such a data transfer may begin when a user initiates a transfer using the device control application on the controlling device 92. In some embodiments, although the controlling device 92 and the controlled device 40 may both include the NFC interface 34, a user may elect to have the data transfer take place over another one of the communication channels 90.

Among the possible communication channels 90 other than the NFC communication channel 96 is a personal area network (PAN) communication channel 98, connected through the PAN interfaces 28 of each device. By way of example, the PAN communication channel 98 may represent a peer-to-peer Bluetooth® connection, an IEEE 802.15.4 (e.g., ZigBee) network, or an ultra wideband network (UWB) between the controlling device 92 and the handheld device 40.

The controlling device 92 and the controllable device 94 may additionally or alternatively be connected via a local area network (LAN) communication channel 100. The respective LAN interfaces 30 of the controlling device 92 and the controllable device 94 may share a peer-to-peer connection directly to one another via the LAN communication channel 100, or may connect to one another via a router or a network controller along the LAN communication channel 100. The LAN communication channel 100 may represent a wired connection, such as an Ethernet connection, but may also represent a wireless connection, such as an IEEE standard 802.11.x wireless network, or Wi-Fi.

It should be appreciated that the controlling device 92 and the controllable device 94 may establish the PAN communication channel 98 or the LAN communication channel 100 using a device identification networking protocol. By way of example, the device identification networking protocol may be Bonjour® by Apple Inc. Each of the controlling device 92 and the controllable device 94 may broadcast using internet protocol (IP) their identifications and services, programs, and/or communication capabilities that each device may have. The controlling device 92 or the controllable device 94 may receive information via the device identification networking protocol so as to open peer-to-peer connections via the PAN communication channel 98 or the LAN communication channel 100. As should be appreciated, more than one electronic device 10 may be broadcasting information using the device identification networking protocol. As such, the handheld device 40 may select based on preferences with which electronic device 10 to connect.

While the controlling device 92 or the controllable device 94 may be connected via the PAN communication channel 98 or the LAN communication channel 100, the devices may also be connected by way of the Internet 102. By connecting to one another via the Internet 102, the controlling device 92 and the controllable device 94 may remain physically remote from one another while the data transfer occurs. Connecting via the Internet 102 may also allow the controlling device 92 and the controllable device 94 to retain communicative capabilities if a local or peer-to-peer connection via the communication channel 98 or 100 is disrupted or lost.

To locate one another over the Internet 102, the controlling device 92 or the controllable device 94 may first query a web service 104 to obtain an internet protocol (IP) address of the other. The web service 104 may represent a dynamic domain name system (DNS) service, which may maintain the current IP address of each device by communicating with a plugin associated with the simplified data transfer application residing on each device. By way of example, the web service 104 may be a function of the Back to My Mac® service from Apple, Inc.

With further reference to FIG. 7, the controllable device 94 may reach the Internet 102 via its LAN interface 30 or via a wide-area network (WAN) communication channel 106, which may represent, for example, a cellular data network such as EDGE or a 3G network. Similarly, the controlling device 92 may connect to the Internet 102 via its LAN interface 30 or its WAN interface 32. If the controlling device 92 connects to the Internet via the WAN interface 32, it may do so via a wide area network (WAN) communication channel 108, which may also represent, for example, a cellular data network such as EDGE or a 3G network.

It should be appreciated that the controlling device 92 and the controllable device 94 may also establish a connection directly to the web service 168 directly via the respective WAN interfaces 32 of the devices. The controllable device 94 may connect to the web service 104 via a wide area network (WAN) communication channel 110, which may represent, for example, a cellular data network such as EDGE or a 3G network. Similarly, the controlling device 92 may connect to the web service 104 via a wide area network (WAN) communication channel 112, which may also represent, for example, a cellular data network such as EDGE or a 3G network.

The controlling device 92 and the controllable device 94 may also be connected to one another via a wired input/output (I/O) communication channel 114. The wired I/O communication channel 114 may generally permit an exceptionally rapid transfer of data between the controlling device 92 and the controllable device 94. As discussed below, any of the potential communication channels 90 may provide a manner of communicating during an initial data transfer or a subsequent data transfer involving a simplified device control procedure.

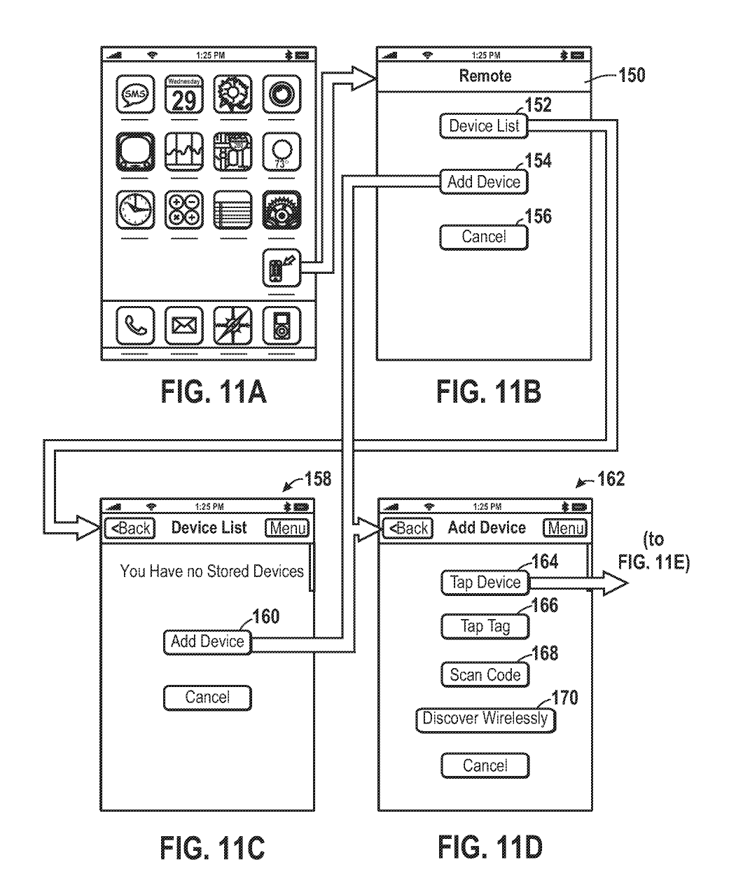

FIG. 8 illustrates an RFID tag 118 that may be associated with the controllable device 94. The RFID tag 118 may adhere to the controllable device 94, and may provide certain control information to the controlling device 92 that may be used to control the controllable device 94. By way of example, the RFID tag 118 may instruct the controlling device 92 where software for controlling the controllable device 94 may be obtained and/or how to locate the controllable device 94 over a network. Thus, the RFID tag 118 may be particularly effective when the controllable device 94 lacks an NFC interface 34. Components of the RFID tag 118 may include, for example, an adhesive portion 120 and an RFID microchip 122.

The RFID microchip 122 may passively or actively transfer certain data related to controlling the controllable device 94 when the NFC interface 34 of the controlling device 92 is placed nearby (e.g., within 2-4 cm). Accordingly, the RFID microchip 122 may comply with such standards as ISO 14443 or ISO 15693 for proximity or vicinity RFID. To enable the controlling device 92 to control the controllable device 94, the RFID microchip 122 may include certain control information. The information stored on the RFID microchip 122 may include, among other things, a serial number and/or an XML message having various information identifying the controllable device 94. For example, the serial number may enable the controlling device 92 to search a database at the web service 104. Based on the serial number from the RFID microchip 122, the web service 104 may provide information identifying the type of device, an internet protocol (IP) address of the controllable device 94, a location where a control software plug-in for controlling the controllable device 94 may be obtained, and/or the control software plug-in. The XML message may provide similar information, such as the serial number, the type of device, and/or a location where the control software plug-in may be obtained.

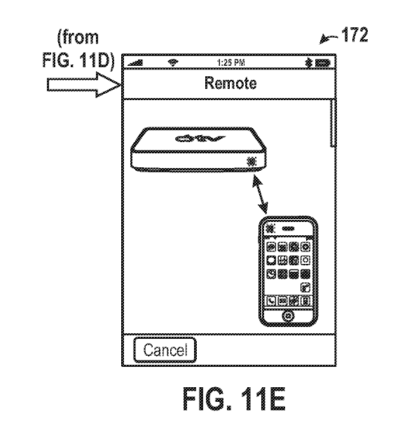

FIG. 9 illustrates a matrix barcode tag 124 that may be associated with the controllable device 94. In the manner of the RFID tag 118 of FIG. 8, the matrix barcode tag 124 may be placed on the controllable device 94 to provide control information to the controlling device 92 that may be used to control the controllable device 94. By way of example, the matrix barcode tag 124 may instruct the controlling device 92 where software for controlling the controllable device 94 may be obtained and/or how to locate the controllable device 94 over a network. Thus, the matrix barcode tag 124 may be particularly effective when placed on a controllable device 94 that lacks an NFC interface 34. The matrix barcode tag 124 may include an adhesive 126 with a printed matrix barcode 128.

The matrix barcode 128 may be any 2-D matrix code capable of encoding a serial number or other data pertaining to the controllable device 94 with which it may be associated. By way of example, the matrix barcode 128 may be a QR code, an Aztec Code, or a Data Matrix code. The matrix barcode 128 may be read by a camera 36 or a matrix barcode reader associated with the controlling device 94, as described below. To enable the controlling device 94 to control the controllable device 94, the matrix barcode 128 may encode certain control information. Like the control information of the RFID microchip 122, the control information encoded in the matrix barcode 128 may include a serial number and/or an XML message having information identifying the controllable device 94. For example, the serial number may enable the controlling device 92 to search a database at the web service 104. Based on the serial number from the matrix barcode 128, the web service 104 may provide information identifying the type of device, an internet protocol (IP) address of the controllable device 94, a location where a control software plug-in for controlling the controllable device 94 may be obtained, and/or the control software plug-in. The XML message may provide similar information, such as the serial number, the type of device, and/or a location where the control software plug-in may be obtained.

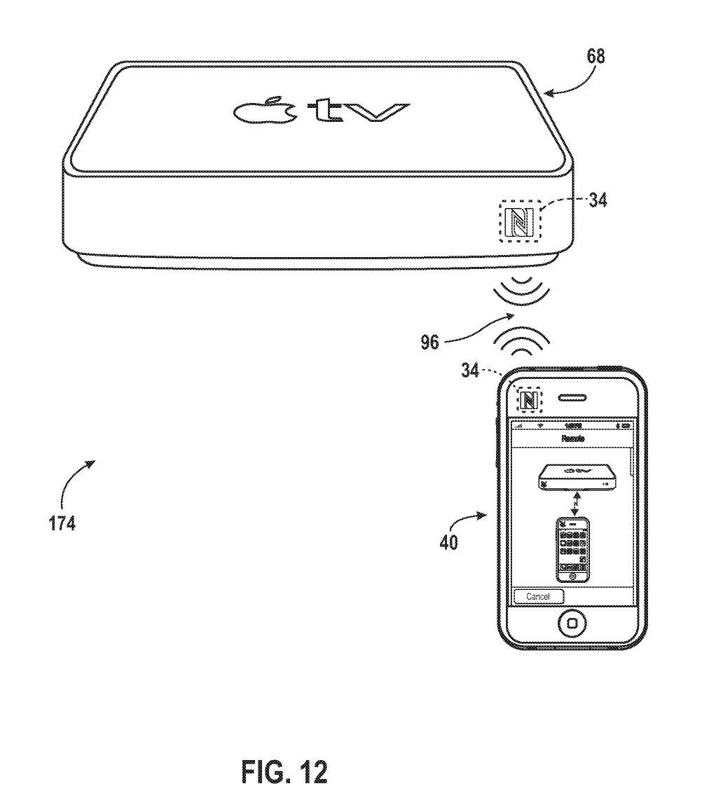

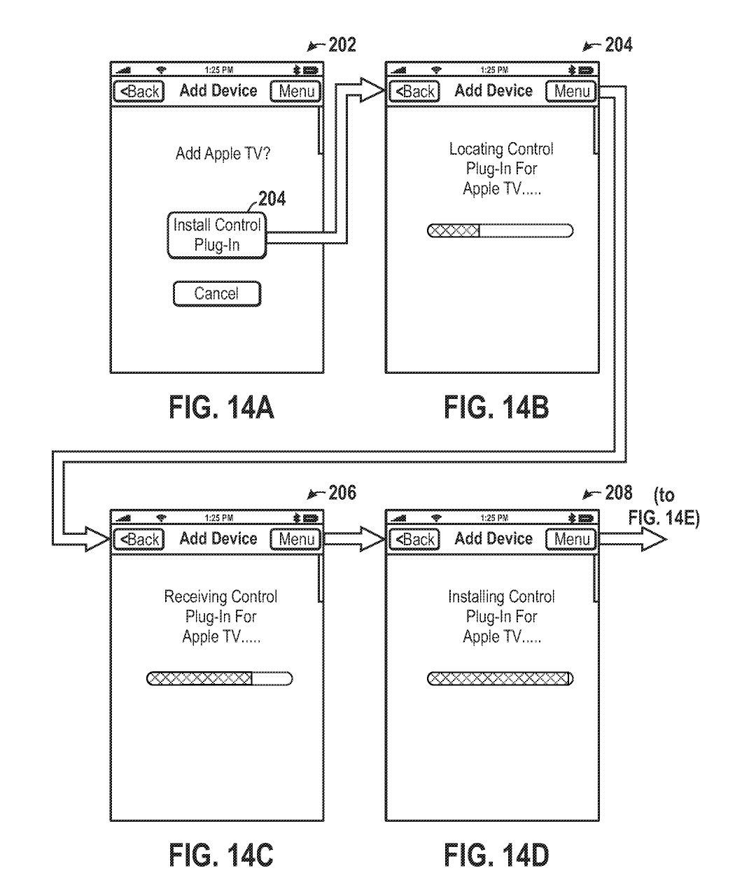

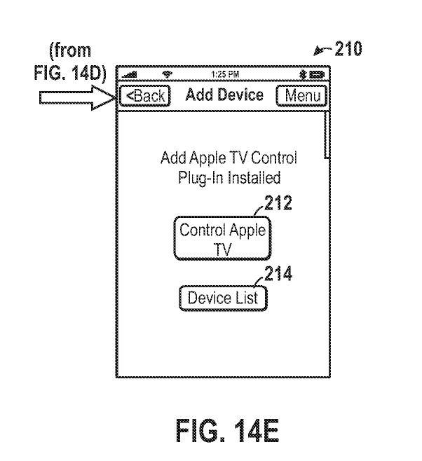

Turning to FIG. 10, a flowchart 130 may describe a technique for using the controlling device 92 to control the controllable device 94. Particularly, the technique described in the flowchart 130 may be employed when both the controlling device 92 and the controllable device 94 include NFC interfaces 34. In a first step 132, a user may launch control software on the controlling device 92. Such control software may be, for example, the device control application described above with reference to FIG. 2 above. The control software may prepare the controlling device 92 for controlling the controllable electronic device 94 by placing the NFC interface 34 of the controlling device 92 into a “host mode,” the significance of which is described below with reference to FIGS. 12-13.

In step 134, the user may tap the NFC interface 34 of the controlling device 92 to the NFC interface 34 of the controllable device 94, causing the two devices to establish the NFC communication channel 96. In step 136, control information may be communicated to the controlling device 92 over the NFC communication channel 96. The control information may provide information sufficient to enable the controlling device 92 to control the controllable device 94. By way of example, the control information may include a serial number and/or an XML message having information identifying the controllable device 94. The serial number may enable the controlling device 92 to search a database at the web service 104. Based on the serial number, the web service 104 may provide information identifying the type of device, an internet protocol (IP) address of the controllable device 94, a location where a control software plug-in for controlling the controllable device 94 may be obtained, and/or the control software plug-in. If the control information includes an XML message, the XML message may provide similar information, such as the serial number, the type of device, and/or a location where the control software plug-in may be obtained.

Turning to step 138, either the controlling device 92 or the controllable device 94 may issue a prompt to the user to obtain the control software plug-in described in the control information, which may be used by the controlling device 92 to control the controllable device 94. Once the user elects to obtain the control software plug-in, the controlling device 92 may obtain the control software plug-in from any number of possible sources in step 140. For example, the controlling device 92 may contact the web service 104 to obtain an appropriate control software plug-in for the controllable device 94 based on the control information, or the controlling device 92 may communicate directly with the controllable device 94 to obtain the control software plug-in. After obtaining the control software plug-in, the controlling device 92 may install the control software plug-in for use with the device control application. It should be appreciated that if the control software plug-in indicated by the control information already exists on the controlling device 92, step 140 may be omitted.

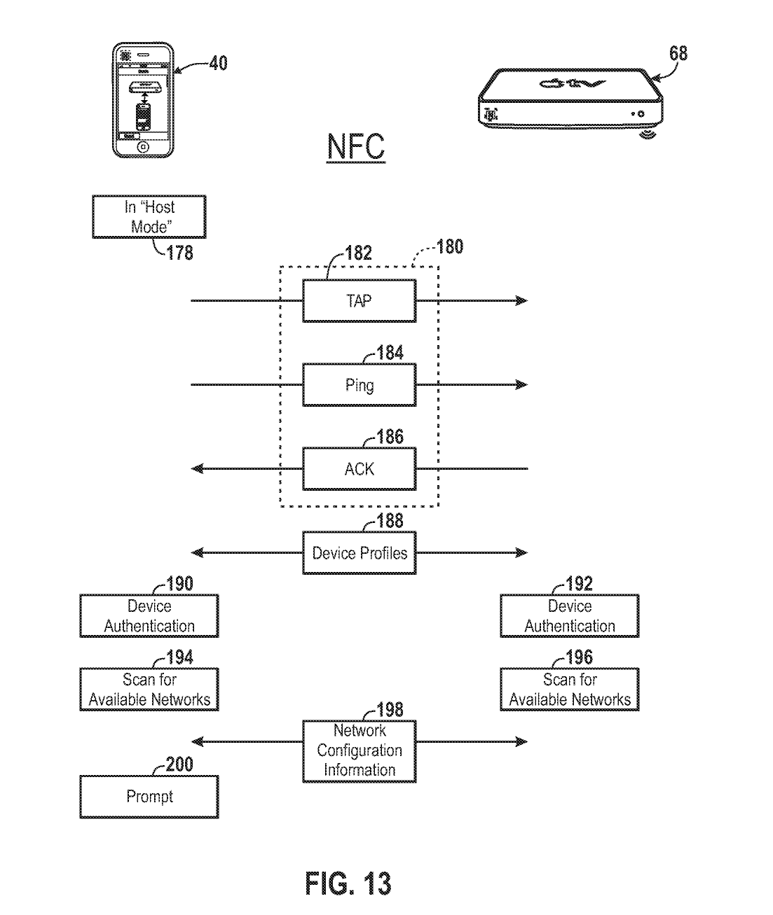

Having obtained and installed the control software plug-in, the user may choose to begin to control the controllable device 94 from the controlling device 92. Accordingly, in step 142, a connection may be established between the devices. The connection may take place over any of the communication channels 90, as illustrated in FIG. 7. In step 144, the controlling device 92 may control the controllable device 94 in a control stream of data between the devices, based on the control software plug-in obtained in step 138. FIGS. 11-17 that follow may illustrate an embodiment of the technique described in the flowchart 130.

FIGS. 11A-E illustrate screens that may be displayed on the controlling device 92 while performing step 132 of the flowchart 130 of FIG. 10. Particularly, FIGS. 11A-E may depict screens for display on the controlling device 92 when the controlling device 92 is the handheld device 40; accordingly, in the following examples, the controlling device 92 is discussed as the handheld device 40. However, it should be understood that the controlling device 92 may be any electronic device 10, and thus the screens depicted in FIGS. 11A-E may be adapted for any controlling device 92 having the display 18.

Turning first to FIG. 11A, a screen 146 may represent a home screen on the handheld device 40, which may represent the controlling device 92. The screen 146 may include, among other things, the device control application icon 44. As noted above, the device control application icon 44 may be labeled “Remote” to indicate that the device control application may allow a user to remotely control other electronic devices. Upon selection of the device control application icon 44, a device control application may begin to run on the handheld device 40.

FIG. 11B illustrates a screen 148 that may be displayed when the device control application begins to run on the handheld device 40. The screen 148 may include a title bar 150 indicating the name of the application, “Remote,” which may assist with navigation through the application. Additionally, the screen 148 may include several user-selectable buttons 152-156. The button 152 may be labeled “Device List,” and may provide access to a list of controllable devices 94 for which the handheld device 40 has software capabilities to control; the button 154 may be labeled “Add Device,” and may enable a user to install appropriate software to control another controllable device 94; and the button 156 may be labeled “Cancel,” and may enable the user to exit the application, returning the user to the screen 146 of FIG. 11A.

When the button 152 of FIG. 11B is selected, a screen 158 may be displayed, as illustrated by FIG. 11C. If the appropriate software to control a controllable device 94 has not been installed on the handheld device 40, no devices may be listed as controllable from the handheld device 40. Thus, the screen 158 may list an option to add a device to be controlled, as shown by a button 160, labeled “Add Device.”

Turning to FIG. 11D, if a user selects the button 160 of FIG. 11C or the button 154 of FIG. 11B, a screen 162 may be displayed. The screen 162 may enable a user to add the capability to control a given controllable device 94 using a variety of techniques, as indicated by buttons 164-170. As depicted in FIG. 11D, the button 164 may be labeled “Tap Device,” the button 166 may be labeled “Tap Tag,” the button 168 may be labeled “Scan Code,” and the button 170 may be labeled “Discover Wirelessly.”

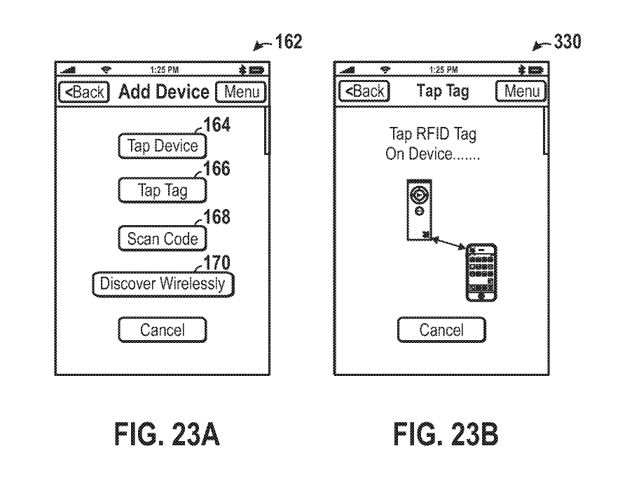

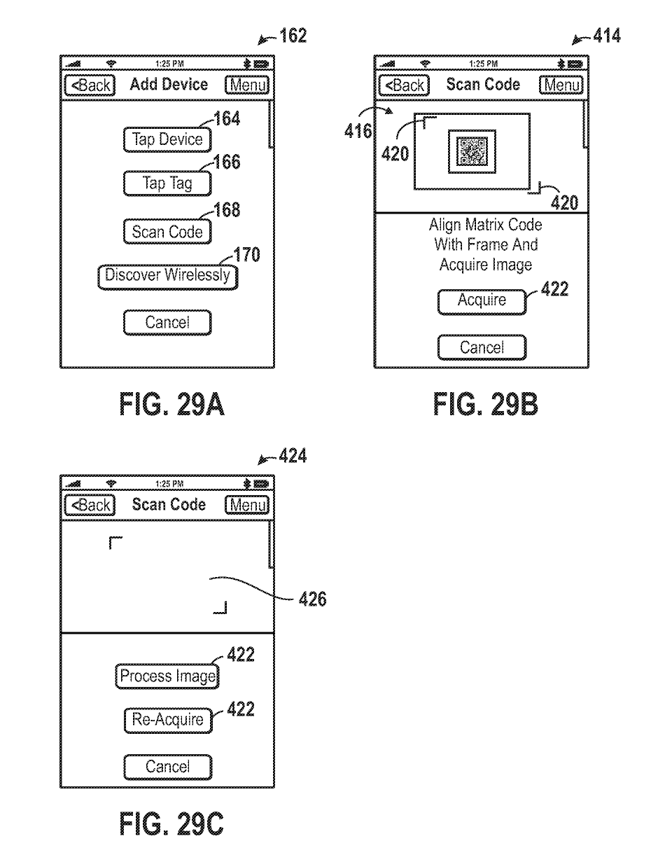

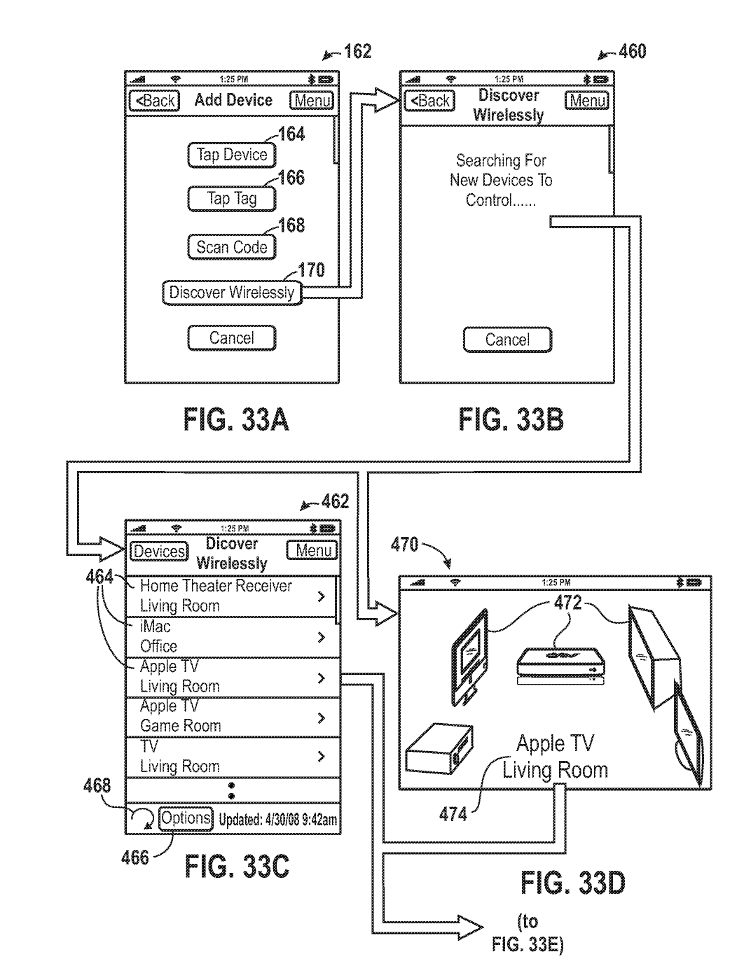

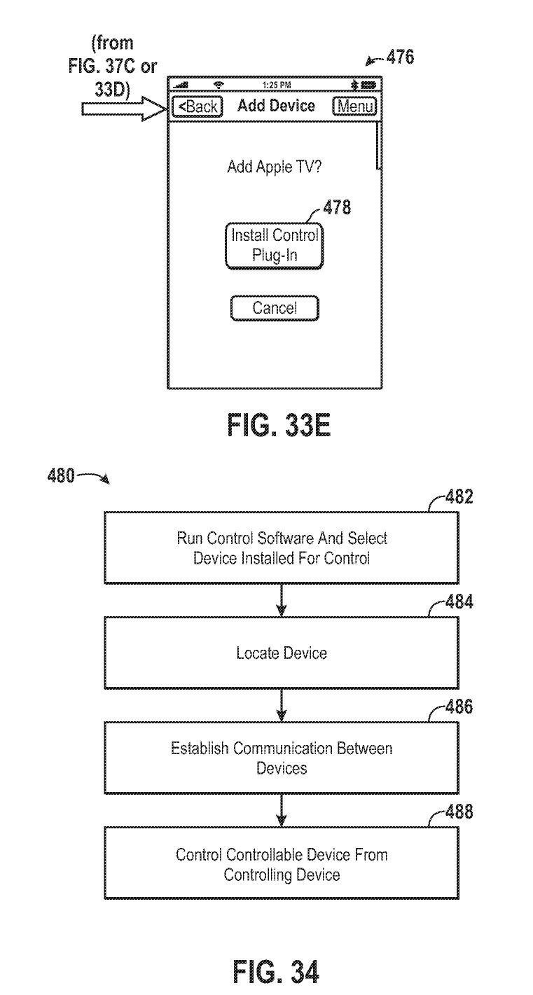

Selecting each of the buttons 164-170 may enable the user to add capabilities to control controllable devices 94 according to different techniques. Particularly, selecting the button 164 may enable the user to add a controllable device 94 by tapping the NFC interface 34 of the controllable device 94, as described with reference to FIGS. 11E-21. Selecting the button 166 may enable the user to add a controllable device 94 by tapping an RFID tag 118 located on the controllable device 94, as described with reference to FIGS. 22-27. Selecting the button 168 may enable the user to add a controllable device 94 by scanning a matrix barcode tag 124 located on the controllable device 94, as described with reference to FIGS. 28-31. Selecting the button 170 may enable the user to add a controllable device 94 by locating the controllable device 94 wirelessly, as described with reference to FIGS. 32-33.

It should be appreciated that although the “Back,” “Menu,” and “Cancel” buttons are not labeled with numerals in FIG. 11D or subsequent figures below, the buttons may function in the manners described above. As such, the “Back” button may navigate a user to a prior screen, the “Menu” button may navigate a user to the main screen 148 of the device control application, and the “Cancel” button may cancel a pending transaction or return a user to a prior screen.

To add a device by tapping the devices together, a user may select the button 164, labeled “Tap Device.” When the button 164 is selected, the handheld device 40 may display a screen 172, as illustrated in FIG. 11E. The screen 172 may place the NFC interface 34 of the handheld device 40 into a “host mode,” the significance of which is described below, and may instruct the user to tap the NFC interfaces of the two devices together to add the device.

Turning to FIG. 12, a control initiation operation 174 represents a manner of obtaining control over a controllable device 40 using the NFC communication channel 96. For exemplary purposes, the control initiation operation 174 depicts the handheld device 40 as the controlling device 92 and the standalone media player 68 as the controllable device 94. However, it should be understood that any other electronic devices 10 having NFC interfaces 34 may take the place of the handheld device 40 or the standalone media player 68 in the control initiation operation 174. The control initiation operation 174 may represent, among other things, step 134 of the flowchart 130.

As shown in FIG. 12, the NFC interface 34 of the handheld device 40 may be placed in close proximity to the NFC interface 34 of the standalone media player 68. As such, the NFC communication channel 96 may become established between the two devices. Thereafter, the handheld device 40 and the standalone media player 68 may communicate information relevant to the control of the standalone media player 68 over the NFC communication channel 96, as illustrated further below.

Turning to FIG. 13, a communication diagram 176 may illustrate an embodiment of communication that may take place between the handheld device 40 and the standalone media player 68. Though the communication diagram 176 of FIG. 13 illustratively depicts communication between the standalone media player 68 and the handheld device 40, it should be understood that the communication diagram 176 may apply to communication between any NFC-enabled electronic devices 10 following the control initiation operation 174 of FIG. 12. Further, it should be understood that the communication of the communication diagram 176 may be represented by the steps 136 and 138 of the flowchart 130 of FIG. 10.

The communication diagram 176 may begin when the NFC interface 34 of the handheld device 40 is placed in a “host mode,” as indicated by block 354. The NFC interface 34 of the handheld device 40 may enter the “host mode” when the button 164 of the screen 162 of FIG. 11D is selected by the user. An NFC handshake 180 may next take place between the handheld device 40 and the standalone media player 68 over the NFC communication channel 96. To begin the NFC handshake 180, a user may tap the NFC interfaces 34 of the handheld device 40 and the standalone media player 68, as indicated by block 182. Because the handheld device 40 may be operating in the “host mode,” as discussed above, the handheld device 40 may emit periodic NFC pings. One of the NFC pings may be transmitted to the standalone media player 68, as indicated by block 184. After receiving the NFC ping of the block 184, the standalone media player 68 may reply with an NFC acknowledgement packet, as indicated by a block 186, labeled “ACK.”

With NFC communication established between the devices, the handheld device 40 and the standalone media player 68 may exchange device profiles, as shown by the block 188. The device profiles may include a variety of information regarding the capabilities of the handheld device 40 and the standalone media player 68. For example, the device profiles may include messages of any form, including extensible markup language (XML), which may denote the device name, serial number, owner name, type of device, as well as other identifying information. The other identifying information may include, for example, a hash of the user's account for a web service, such as iTunes®, or a public or private encryption key. The device profiles may further denote capabilities of the handheld device 40 or the standalone media player 68 by indicating which applications, drivers, or services may be installed on each device.

The device profiles exchanged in block 188 may additionally indicate whether either device may be controlled and, if so, may include relevant control information. The control information may provide information sufficient to enable the handheld device 40 to control the standalone media player 68. For example, the control information may include a serial number identifying the standalone media player 68. The serial number may enable the handheld device 40 to search a database at the web service 104. Based on the serial number, the web service 104 may provide information identifying the type of device, an internet protocol (IP) address of the standalone media player 68, a location where a control software plug-in for controlling the standalone media player 68 may be obtained, and/or the control software plug-in. Alternatively, the control information may include an XML message, which may provide similar information, such as the serial number, the type of device, and/or a location where the control software plug-in may be obtained. As should be appreciated, the control information that may be exchanged in the device profiles may be employed at a later time to obtain an appropriate control software plug-in for controlling the standalone media player 68 with the handheld device 40.

Subsequently, the handheld device 40 and the standalone media player 68 may authenticate one another based at least in part on the information from the device profiles. The authentication procedures of blocks 190 and 192 of FIG. 13 may involve, for example, verifying that the owner of the handheld device 40 and the standalone media player 68 are the same. Authentication may rely on a private key known to both the standalone media player 68 and the handheld device 40, which may have been exchanged prior to communication or, additionally or alternatively, a combination of a public key and a private key. Under the latter scheme, the standalone media player 68 and the handheld device 40 may each exchange public keys associated with one another prior to or during the authentication procedure of blocks 190 and 192, or may obtain public keys from another source. The standalone media player 68 and the handheld device 40 may verify the public keys with a certificate authority over the Internet or via a web of trust. In certain variations, the web service 104 may represent the certificate authority. If there is any link broken in the chain of trust, the authentication procedure of blocks 190 and 192 may be terminated.

Following device authentication, the handheld device 40 and the standalone media player 68 may scan for available network communication channels 90 for the other to join for further communication, as indicated by blocks 194 and 196. After scanning for the available network communication channels 90, the handheld device 40 and the standalone media player 68 may exchange network configuration information, as shown by block 198. The network configuration information of block 198 may include, for example, XML messages denoting lists of network communication channels 90 accessible via the standalone media player 68 or the handheld device 40. Among other things, the network configuration information of block 198 may include known authorization keys and service set identifier (SSID). By way of example, the network configuration information may include PAN interface 28 configuration information, such as a Bluetooth serial number, MAC address, and an associated password, and/or LAN interface 30 configuration information, such as a WiFi IP address, a WiFi MAC address, and a WiFi SSID. The network configuration information may be stored for use at a later time to permit the handheld device 40 and the standalone media player 68 to establish a higher bandwidth connection.

A final block 200 of the communication diagram 176 of FIG. 13 may represent a prompt that may issue on the handheld device 40 or, alternatively, on the standalone media player 68. Based on the control information transmitted with the device profiles of block 188, the prompt may request the attainment and installation of an appropriate control software plug-in to enable the handheld device 40 to control the standalone media player 68. The prompt of the block 200 may represent step 138 of the flowchart 130 of FIG. 10.

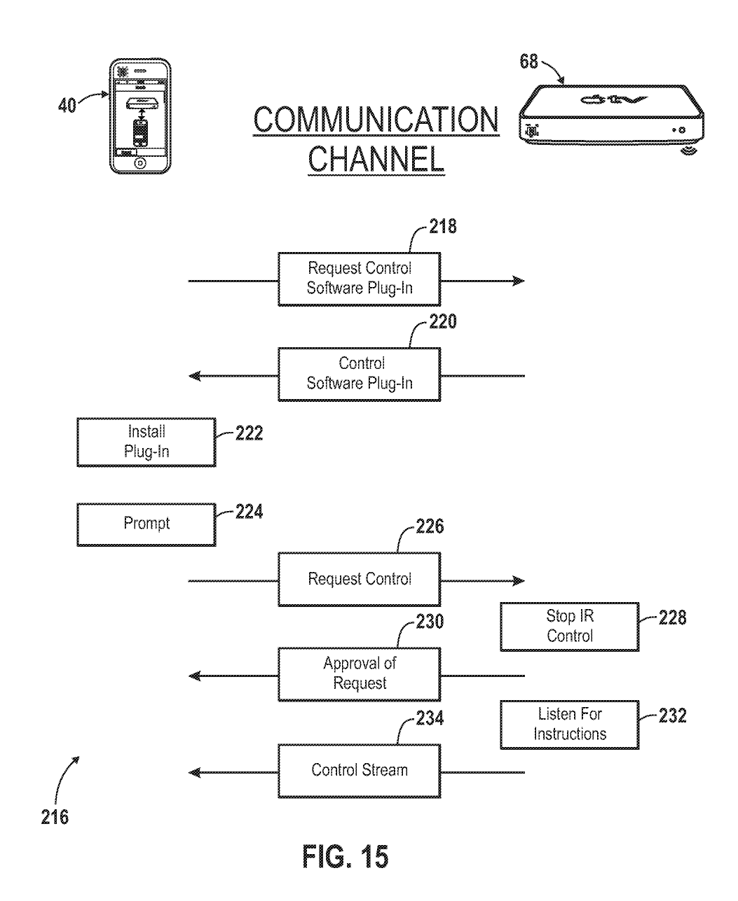

FIGS. 14A-E represent steps 138 and 140 of the flowchart 130 of FIG. 10. Turning first to FIG. 14A, a screen 202 may be displayed on the handheld device 40 as the prompt represented above in block 200 of FIG. 13. The screen 202 may represent step 138 of the flowchart 130, and may prompt the user to choose to add the standalone media player as a device that may be controlled by the handheld device 40 by obtaining and installing an appropriate control software plug-in. A button 204, labeled “Install Control Plug-In,” may enable the user to initiate a process of obtaining and installing the control software plug-in for controlling the standalone media player 68.

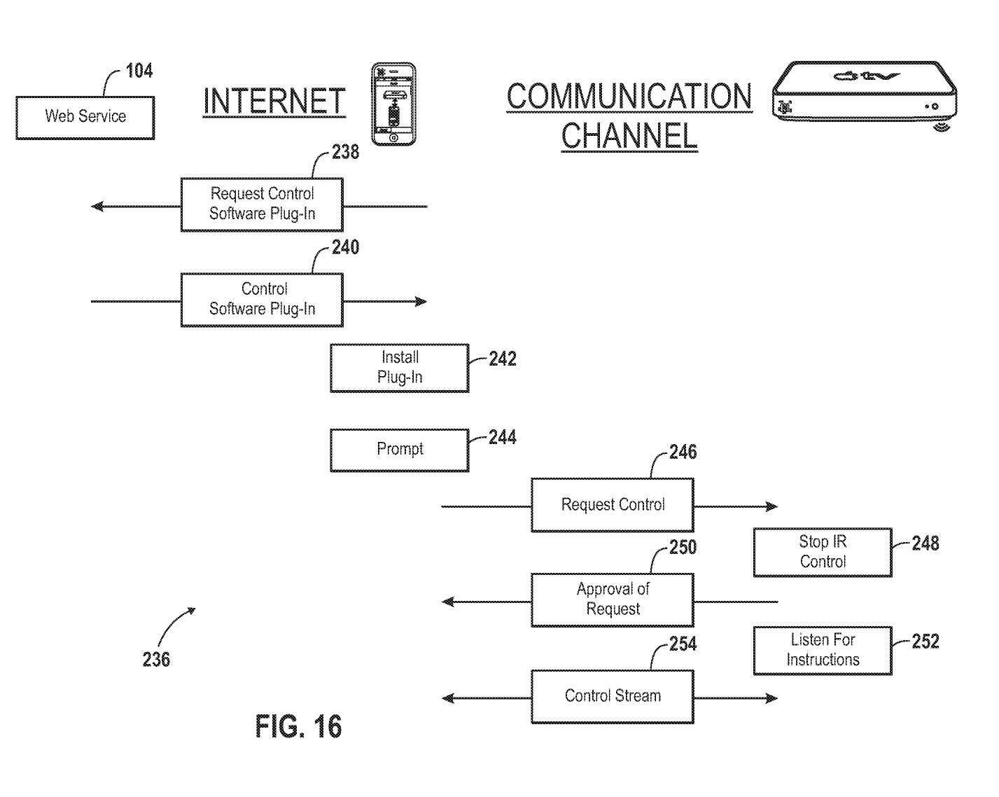

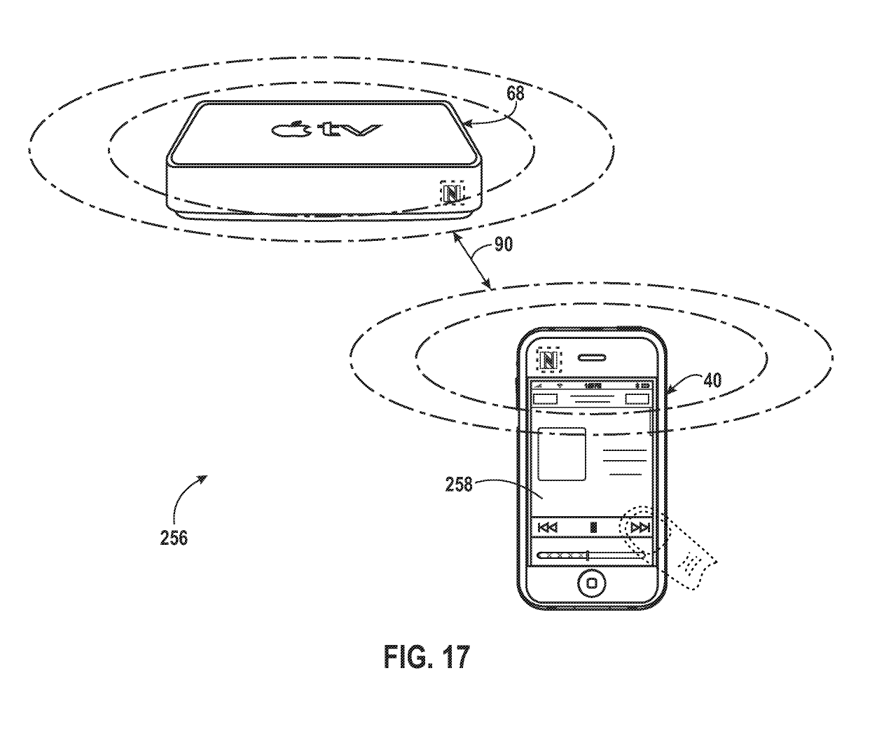

Turning to FIG. 14B, which may represent step 140 of the flowchart 130 of FIG. 10, a screen 204 may be displayed on the handheld device 40 when the button 204 of screen 202 is selected and the handheld device 40 may begin to obtain and install the control software plug-in. The screen 204 may indicate to the user that the control software plug-in is being located. As illustrated in FIGS. 15 and 16 below, the control software plug-in may be obtained from one of many possible locations.

Turning next to FIG. 14C, a screen 206 may be displayed on the handheld device 40 when the handheld device 40 begins to receive the control software plug-in needed to control the standalone media player 68. When the control software plug-in has been received and is being installed, a screen 208 may be displayed, as shown by FIG. 14D. Finally, as shown in FIG. 14E, when the control software plug-in has been installed, enabling the handheld device 40 to control the standalone media player 68, a screen 210 may be displayed on the handheld device 40. The screen 210 may indicate that the control software plug-in has been installed on the handheld device 40 for controlling the standalone media player 68, and may include a button 212, labeled “Control Apple TV,” and/or a button 214 labeled “Device List.” If the user selects the button 212, the user may launch the control software and may be able to control the standalone media player 68 from the handheld device 40. If the user selects the button 214, the user may return to a list of devices that may be controllable from the handheld device 40.

FIG. 15 depicts a communication diagram 216, which illustrates communication that may take place when the control software plug-in for controlling the standalone media player 68 from the handheld device 40 may is obtained and installed. The communication diagram 216 may represent communication corresponding to FIGS. 14A-E and steps 140-144 of the flowchart 130 of FIG. 10.

As indicated by the communication diagram 216, communication between the handheld device 40 and the standalone media player 68 may continue over a communication channel 90 other than the NFC communication channel 96. Based on the network configuration information exchanged in the block 198 of FIG. 13, the handheld device 40 and the standalone media player 68 may establish communication via another communication channel 90, as shown above with reference to FIG. 7. At the start of the communication diagram 216, the handheld device 40 may issue a request to the standalone media player 68 to obtain the control software plug-in for controlling the standalone media player 68, as shown in block 218. The handheld device 40 may contact the standalone media player 68 for such information based on information contained in the device profiles indicating that the standalone media player 68 has the control software plug-in available for transfer. After the request for the control software plug-in has been issued to the standalone media player 68, the standalone media player 68 may reply by sending the control software plug-in to the handheld device 40 over the communication channel 90, as illustrated in block 220. In a subsequent block 222, the handheld device 40 may install the control software plug-in and, as illustrated in block 224, the handheld device 40 may thereafter issue a prompt enabling the user to begin to control the standalone media player 68. The prompt of the block 224 may correspond with the prompt of the screen 210 of FIG. 14E.

When the user responds to the prompt of block 224 by selecting the button 212 of the screen 210, thereby electing to control the standalone media player 68, a control sequence may begin, as illustrated by blocks 226-234 of FIG. 15. In block 226, the handheld device 40 may transmit a message requesting control over the standalone media player 68. As illustrated by block 228, the standalone media player 68 may disable control through the traditional means of the standalone media player 68, which may be, for example, by way of an infrared connection to the remote control 74. In block 230, the standalone media player 68 may approve the request of block 226 by transmitting a message to the handheld device 40. The standalone media player 68 may listen for instructions over the communication channel 90 from the handheld device 40, as shown in block 232. The handheld device 40 may thereafter control the standalone media player 68 with a control stream of data, which is depicted generally by a block 234. As should be appreciated, the precise data exchanged in the control stream may be defined by the control software plug-in that is employed to control the standalone media player 68.

FIG. 16 represents another communication diagram 236, which may represent an alternative manner of obtaining the control software plug-in for controlling the standalone media player 68 from the handheld device 40. Thus, the communication diagram 236 may also represent communication corresponding to FIGS. 14A-E and steps 140-144 of the flowchart 130 of FIG. 10.

The communication diagram 236 may begin when the handheld device 40 may issue a request for the appropriate control software plug-in to control the standalone media player 68 over the Internet 102 to the web service 104, as illustrated in block 238. The request may be based on control information received in the exchange of device profiles of block 188 of FIG. 13, as described above. The web service 104 may respond by sending the appropriate control software plug-in to the handheld device 40.

In the same manner described above with reference to FIG. 15, the handheld device 40 may, in block 242, install the control software plug-in. Further, as illustrated in block 244, the handheld device 40 may issue a prompt enabling the user to begin to control the standalone media player 68. The prompt of the block 244 may correspond with the prompt of the screen 210 of FIG. 14E.

When the user responds to the prompt of block 244 by selecting the button 212 of the screen 210, thereby electing to control the standalone media player 68, a control sequence may begin, as illustrated by blocks 246-254 of FIG. 15. In block 246, the handheld device 40 may transmit a message requesting control over the standalone media player 68. As illustrated by block 248, the standalone media player 68 may disable control through the traditional means of the standalone media player 68, which may be, for example, by way of an infrared connection to the remote control 74. In block 250, the standalone media player 68 may approve the request of block 246 by transmitting a message to the handheld device 40. The standalone media player 68 may listen for instructions over the communication channel 90 from the handheld device 40, as shown in block 252. The handheld device 40 may thereafter control the standalone media player 68 with a control stream of data, which is depicted generally by a block 254. As should be appreciated, the precise data exchanged in the control stream may be defined by the control software plug-in that is employed to control the standalone media player 68.

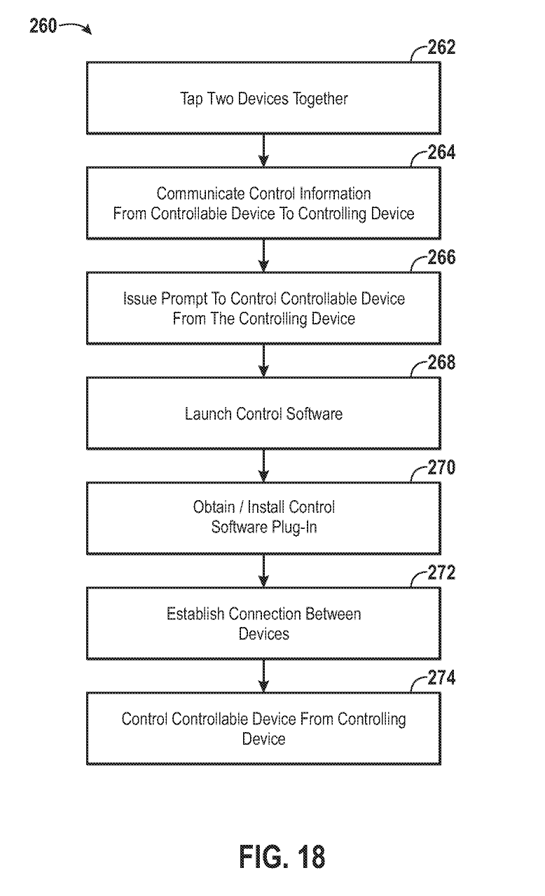

FIG. 17 depicts a device control operation 256, which may represent step 144 of the flowchart 130 of FIG. 10. The device control operation 256 illustrates a manner in which a user may control the standalone media player 68 from the handheld device 40. The control software plug-in of the control software may enable the display of a screen 258, which may represent a control screen by which the user may control the standalone media player 68 using the handheld device 40. Various control tasks that may be performed from the screen 258 may include, for example, selecting a library of music to pay on the standalone media player 68, fast forwarding or rewinding through the media that is selected, adjusting the volume, selecting various play lists, or performing other control tasks. As should be appreciated, the handheld device 40 may transmit the control stream to control the standalone media player 68 by way of a communication channel 90 to the standalone media player 68.

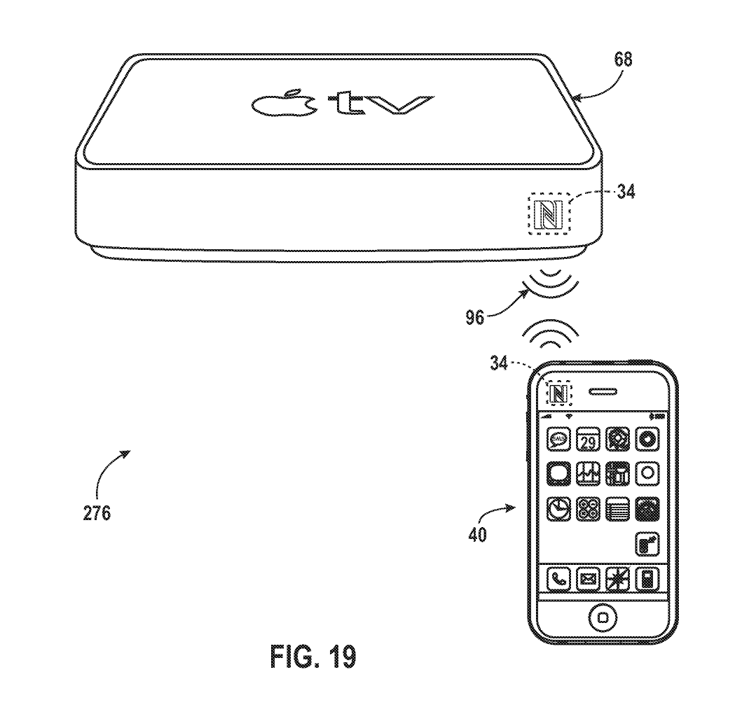

Turning to FIG. 18, a flowchart 260 describes another technique for controlling the controllable device 94 with the controlling device 92. Particularly, the technique described in the flowchart 260 may be employed when both the controlling device 92 and the controllable device 94 include NFC interfaces 34. In a first step 262, a user may tap the NFC interface 34 of the controlling device 92 to the NFC interface 34 of the controllable device 94, causing the two devices to establish the NFC communication channel 96. In step 264, control information may be communicated to the controlling device 94 over the NFC communication channel 96. The control information may provide information sufficient to enable the controlling device 92 to control the controllable device 94. By way of example, the control information may include a serial number and/or an XML message having information identifying the controllable device 94. The serial number may enable the controlling device 92 to search a database at the web service 104. Based on the serial number, the web service 104 may provide information identifying the type of device, an internet protocol (IP) address of the controllable device 94, a location where a control software plug-in for controlling the controllable device 94 may be obtained, and/or the control software plug-in. If the control information includes an XML message, the XML message may provide similar information, such as the serial number, the type of device, and/or a location where the control software plug-in may be obtained.

Turning to step 266, the controlling device 92 may issue a prompt to the user to launch the device control application on the controlling device 92. Upon election by the user, the controlling device 92 may launch the device control application in step 268. Thereafter, in step 270, the controlling device may obtain the control software plug-in from any number of possible sources in step 270. For example, the controlling device 92 may contact the web service 104 to obtain the appropriate control software plug-in for the controllable device 94 based on the control information, or the controlling device 92 may communicate directly with the controllable device 94 to obtain the control software plug-in. After obtaining the control software plug-in, the controlling device 92 may install the control software plug-in for use with the device control application. It should be appreciated that if the control software plug-in indicated by the control information already exists on the controlling device 92, step 270 may be omitted.

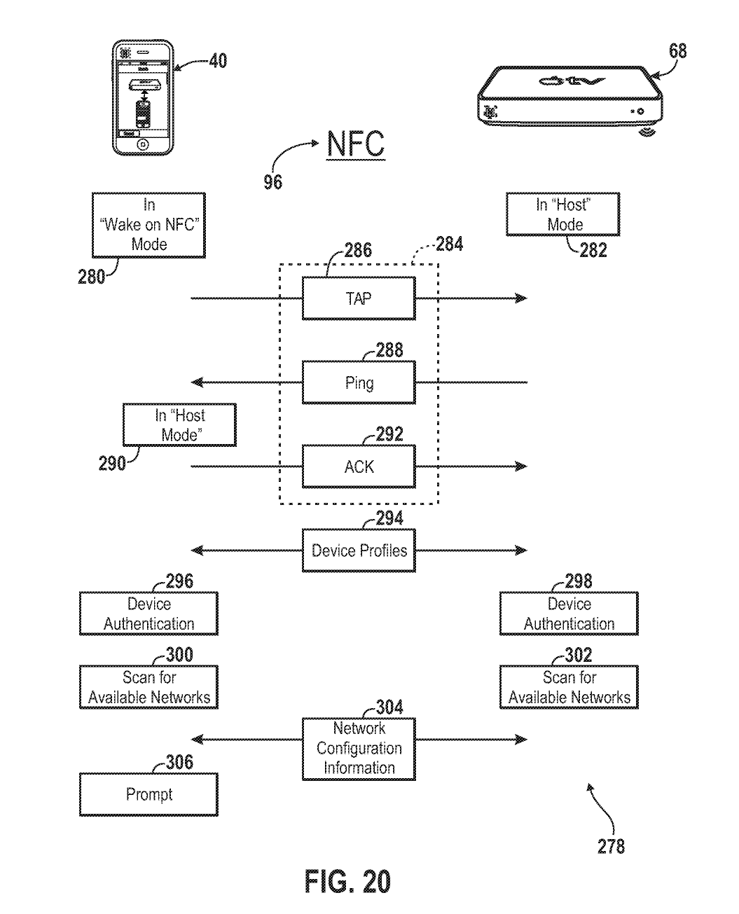

Having obtained and installed the control software plug-in, the user may choose to begin to control the controllable device 94 from the controlling device 92. Accordingly, in step 272, a connection may be established between the devices. The connection may take place over any of the communication channels 90, as illustrated in FIG. 7. In step 274, the controlling device 92 may control the controllable device 94 in a control stream of data between the devices, based on the control software plug-in obtained in step 270. FIGS. 19-21, which follow, may illustrate an embodiment of the technique described in the flowchart 130.

FIG. 19 illustrates a control initiation operation 276, which represents a manner of obtaining control over a controllable device 40 via the NFC communication channel 96. For exemplary purposes, the control initiation operation 276 depicts the handheld device 40 as the controlling device 92 and the standalone media player 68 as the controllable device 94. However, it should be understood that any other electronic devices 10 having NFC interfaces 34 may take the place of the handheld device 40 or the standalone media player 68 in the control initiation operation 276. The control initiation operation 276 may represent, among other things, step 262 of the flowchart 260.

As shown in FIG. 19, the NFC interface 34 of the handheld device 40 may be placed in close proximity to the NFC interface 34 of the standalone media player 68. It should be noted that the handheld device 40 may not currently be running the device control application, in contrast to the control initiation operation 174 of FIG. 12. As such, the NFC communication channel 96 may become established between the two devices if the NFC interface 34 of the standalone media player 68 is operating in a “host mode.” Having established the NFC communication channel 96, the handheld device 40 and the standalone media player 68 may communicate information relevant to the control of the standalone media player 68 over the NFC communication channel 96, as illustrated further below.

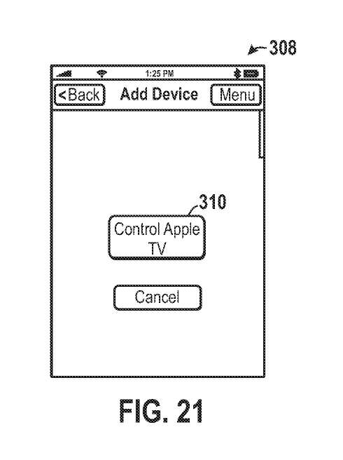

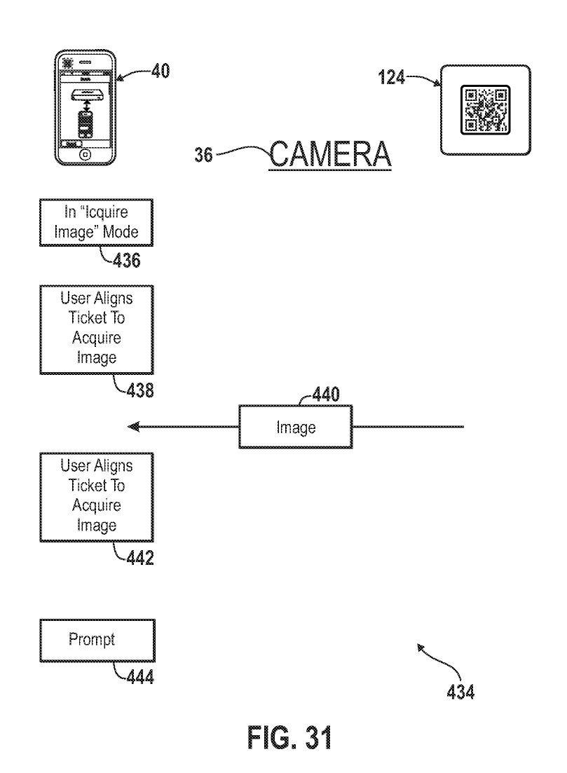

Turning to FIG. 20, a communication diagram 278 may illustrate communication that may take place during the control initiation operation 276 of FIG. 30. At the start of the communication diagram 278, the NFC interface 34 of the handheld device 40 may initially remain in a “wake on NFC” mode as indicated by block 280. The “wake on NFC” mode may be the default mode for the NFC interface 34. By contrast, the NFC interface 34 of the standalone media player 68 may operate in a “host mode,” as indicated by block 282.

Communication between the handheld device 40 and the standalone media player 68 may become established in an NFC handshake 284. To begin the NFC handshake 284, the user may tap the NFC interfaces 34 of the handheld device 40 and the standalone media player 68, as indicated by the block 286. Because the standalone media player 68, rather than the handheld device 40, may be operating in the “host mode,” the standalone media player 68 may emit periodic NFC pings. One of the NFC pings may be transmitted from the standalone media player 68 to the handheld device 40, as indicated by block 288. Receiving the NFC ping may cause the NFC interface 34 of the handheld device 40 to awaken, as noted by block 290, and the handheld device 40 may reply with an NFC acknowledgement packet, as noted by block 292, labeled “ACK.”

With NFC communication established between the devices, the handheld device 40 and the standalone media player 68 may exchange device profiles, as shown by block 294. As noted above, the device profiles may include a variety of information regarding the capabilities of the handheld device 40 and the standalone media player 68. For example, the device profiles may include messages of any form, including extensible markup language (XML), which may denote the device name, serial number, owner name, type of device, as well as other identifying information. The other identifying information may include, for example, a hash of the user's account for a web service, such as iTunes®, or a public or private encryption key. The device profiles may further denote capabilities of the handheld device 40 or the standalone media player 68 by indicating which applications, drivers, or services may be installed on each device.

The device profiles exchanged in block 294 may additionally indicate whether either device may be controlled and, if so, may include relevant control information. The control information may provide information sufficient to enable the handheld device 40 to control the standalone media player 68. For example, the control information may include a serial number identifying the standalone media player 68. The serial number may enable the handheld device 40 to search a database at the web service 104. Based on the serial number, the web service 104 may provide information identifying the type of device, an internet protocol (IP) address of the standalone media player 68, a location where a control software plug-in for controlling the standalone media player 68 may be obtained, and/or the control software plug-in. Alternatively, the control information may include an XML message, which may provide similar information, such as the serial number, the type of device, and/or a location where the control software plug-in may be obtained. As should be appreciated, the control information that may be exchanged in the device profiles may be employed at a later time to obtain an appropriate control software plug-in for controlling the standalone media player 68 with the handheld device 40.

Subsequently, the handheld device 40 and the standalone media player 68 may authenticate one another based at least in part on the information from the device profiles. The authentication procedures of blocks 296 and 298 of FIG. 20 may involve, as in the communication diagram 176 of FIG. 13, verifying that the owner of the handheld device 40 and the standalone media player 68 are the same. Authentication may rely on a private key known to both the standalone media player 68 and the handheld device 40, which may have been exchanged prior to communication or, additionally or alternatively, a combination of a public key and a private key. Under the latter scheme, the standalone media player 68 and the handheld device 40 may each exchange public keys associated with one another prior to or during the authentication procedure of blocks 296 and 298, or may obtain public keys from another source. The standalone media player 68 and the handheld device 40 may verify the public keys with a certificate authority over the Internet or via a web of trust. In certain variations, the web service 104 may represent the certificate authority. If there is any link broken in the chain of trust, the authentication procedure of blocks 296 and 298 may be terminated.

Following device authentication, the handheld device 40 and the standalone media player 68 may scan for available network communication channels 90 for the other to join for further communication, as indicated by blocks 300 and 302. After scanning for the available network communication channels 90, the handheld device 40 and the standalone media player 68 may exchange network configuration information, as shown by block 304. The network configuration information of block 304 may include, for example, XML messages denoting lists of network communication channels 90 accessible via the standalone media player 68 or the handheld device 40. Among other things, the network configuration information of block 304 may include known authorization keys and service set identifier (SSID). By way of example, the network configuration information may include PAN interface 28 configuration information, such as a Bluetooth serial number, MAC address, and an associated password, and/or LAN interface 30 configuration information, such as a WiFi IP address, a WiFi MAC address, and a WiFi SSID. The network configuration information may be stored for use at a later time to permit the handheld device 40 and the standalone media player 68 to establish a higher bandwidth connection.

A final block 306 of the communication diagram 278 of FIG. 20 may represent a prompt that may issue on the handheld device 40 or, alternatively, on the standalone media player 68. Based on information from the device profiles exchanged in block 294, the prompt of block 306 may request that a user choose a course of action regarding the standalone media player 68. For example, the handheld device 40 may recognize that the standalone media player 68 is a controllable device 94 based on the control information transmitted among the device profiles, and thus the prompt may include an option to launch the device control application. Accordingly, the prompt of the block 306 may represent step 266 of the flowchart 260 of FIG. 18.

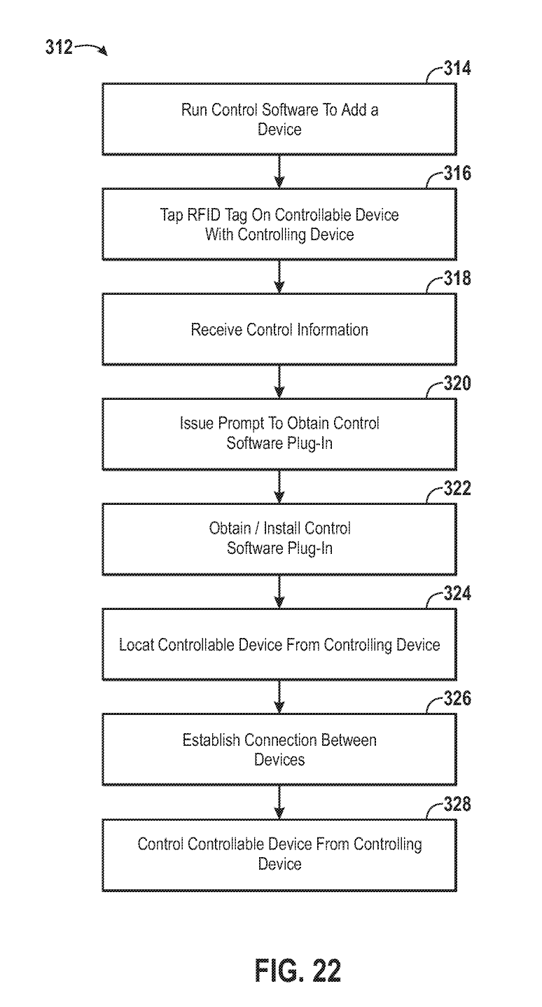

FIG. 21 illustrates a screen 308 that may represent the prompt of the block 306 described above, and thus may also represent step 266 of the flowchart 260 of FIG. 18. As noted above, the prompt represented by the screen 308 may be displayed after the handheld device 40 recognizes, based on information from the exchange of device profiles, that the standalone media player 68 may be controlled by the handheld device 40. As a result, among the options that the screen 308 may provide may include, for example, an option to control the standalone media player 68, as illustrated by a button 310, labeled “Control Apple TV.” Depending on other information from the device profiles, the screen 308 may additionally provide such options as to share resources, transfer media, etc. with the standalone media player 68.

When the button 310 is selected by a user, the handheld device 40 may launch the device control application. After the device control application begins to run, the handheld device 40 may undertake to obtain and install the appropriate control software plug-in, such as may be described by the control information obtained during the prior exchange of device profiles. As should be appreciated, the handheld device 40 may obtain and install the control software plug-in the manner described above with reference to FIGS. 14-16. Further, the handheld device 40 may thereafter be used to control the standalone media player 68 in the manner described above with reference to FIG. 17.

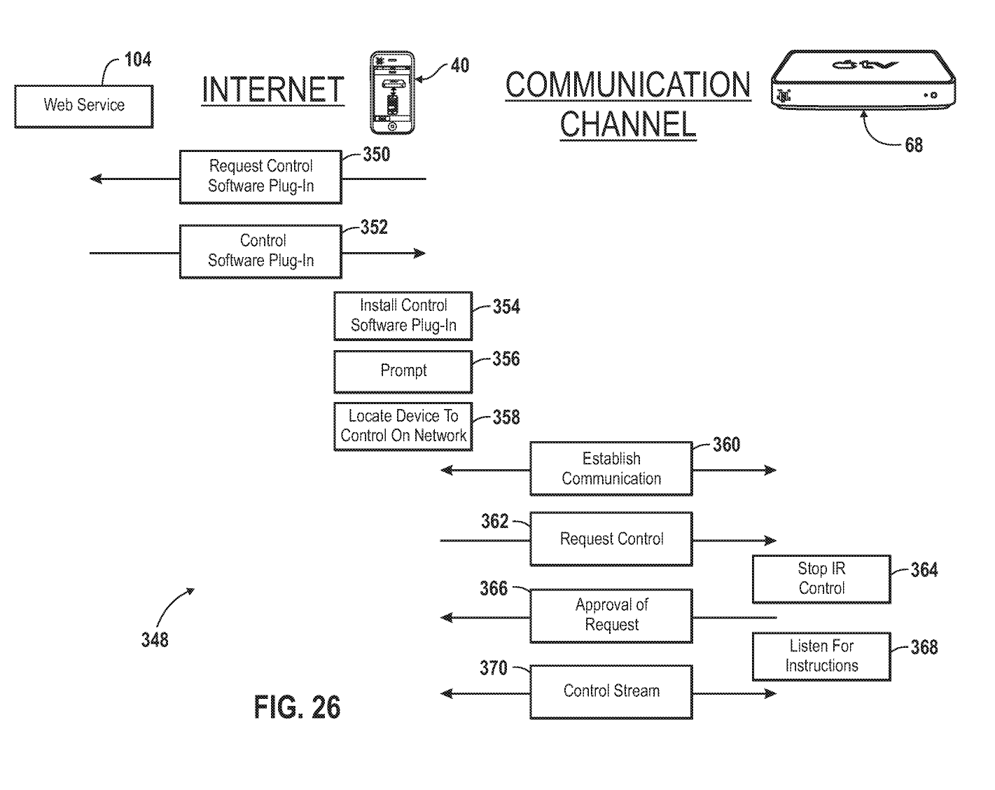

FIG. 22 is a flowchart 312 that may describe another manner of obtaining control software to control a controllable device 94 from a controlling device 92. Particularly, the technique described in the flowchart 312 may be employed when the controlling device 92 includes the NFC interface 34 and the controllable device 94 includes an RFID tag 118. To place the controlling device 92 in condition for extracting control information from the RFID tag 118, which may be located on or associated with the controllable device 94, a user may launch control software on the controlling device 92 in a first step 314. Such control software may be, for example, the device control application described above with reference to FIG. 2 above. The control software may prepare the controlling device 92 for controlling the controllable electronic device 94 by placing the NFC interface 34 of the controlling device 92 into a “host mode,” the significance of which is described below with reference to FIG. 25.

In step 316, the user may tap the NFC interface 34 of the controlling device 92 to the RFID tag 118 associated with the controllable device 94, causing the RFID tag 118 to become energized. Having become energized in step 316, the RFID tag 118 may communicate control information to the controlling device 92 via near field communication in step 318. The control information may provide information sufficient to enable the controlling device 92 to control the controllable device 94. By way of example, the control information may include a serial number and/or an XML message having information identifying the controllable device 94. The serial number may enable the controlling device 92 to search a database at the web service 104. Based on the serial number, the web service 104 may provide information identifying the type of device, an internet protocol (IP) address of the controllable device 94, a location where a control software plug-in for controlling the controllable device 94 may be obtained, and/or the control software plug-in. If the control information includes an XML message, the XML message may provide similar information, such as the serial number, the type of device, and/or a location where the control software plug-in may be obtained.

Turning to step 320, either the controlling device 92 or the controllable device 94 may issue a prompt to the user to obtain the control software plug-in described in the control information, which may be used by the controlling device 92 to control the controllable device 94. Once the user elects to obtain the control software plug-in, the controlling device 92 may obtain the control software plug-in from any number of possible sources in step 322. For example, the controlling device 92 may contact the web service 104 to obtain an appropriate control software plug-in for the controllable device 94 based on the control information, or the controlling device 92 may communicate directly with the controllable device 94 to obtain the control software plug-in. After obtaining the control software plug-in, the controlling device 92 may install the control software plug-in for use with the device control application. It should be appreciated that if the control software plug-in indicated by the control information already exists on the controlling device 92, step 322 may be omitted.

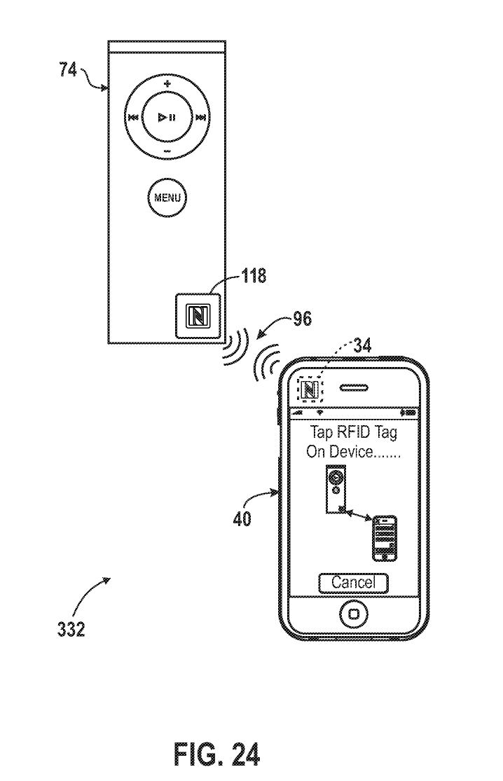

Having obtained and installed the control software plug-in in step 322, the user may choose to begin to control the controllable device 94 from the controlling device 92. Accordingly, in step 324, the controlling device 92 may locate the controllable device 94. The controlling device 92 may locate the controllable device 94 using the control information obtained from the RFID tag 118 directly or indirectly. For example, the control information may list a MAC address and/or password for the controllable device 94; the controlling device 92 may search local networks for the MAC address listed in the control information to locate the controllable device 94. Alternatively, the controlling device 92 may contact the web service 104 to obtain an IP address registered for the controllable device 94. After locating the controllable device 94, the controlling device 92 may establish a connection with the controllable device 94 in step 326. As should be appreciated, the connection may take place over any of the communication channels 90, as illustrated in FIG. 7. In step 328, the controlling device 92 may thereafter control the controllable device 94 in a control stream of data between the devices, based on the control software plug-in obtained in step 322. FIGS. 23-27 that follow may illustrate an embodiment of the technique described in the flowchart 312.

FIGS. 23A-B represent screens that may be displayed on the handheld device 40 for performing the alternative method described in the flowchart 312, and may particularly represent step 314 of the flowchart 312. Though the following examples employ the handheld device 40 as the controlling device 92 and the standalone media player 68 as the controllable device 94 for exemplary purposes, it should be understood that the controlling device 92 or the controllable device 94 may be any electronic device 10. Turning first to FIG. 23A, the button 166, labeled “Tap Tag,” may be selected from the screen 162 to enable a user to add a controllable device 94 by tapping an RFID tag 118 associated with the controllable device 94. When the button 166 is selected, the handheld device 40 may display a screen 330, as shown in FIG. 23B. The screen 330 may instruct the user to tap the RFID tag 118, and may simultaneously place the NFC interface 34 of the handheld device 40 into a “host mode.”

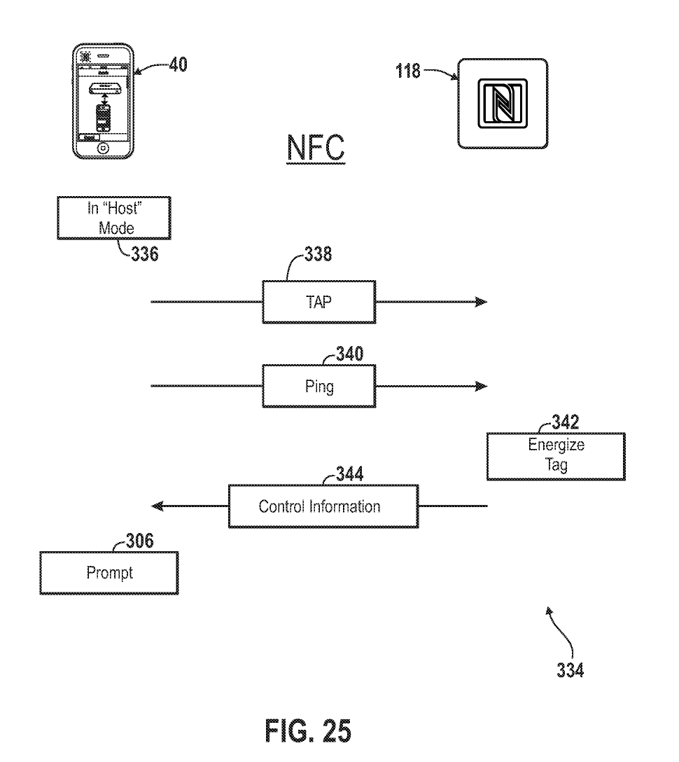

Turning to FIG. 24, a control initiation operation 332 represents a manner of obtaining control over a controllable device 40 having an RFID tag 118. The control initiation operation 332 depicts the handheld device 40 as the controlling device 92 and the standalone media player 68 as the controllable device 94 for exemplary purposes. However, it should be understood that any other electronic devices 10 having NFC interfaces 34 may take the place of the handheld device 40 or the standalone media player 68 in the control initiation operation 332. The control initiation operation 332 may represent, among other things, step 316 of the flowchart 312 of FIG. 22.

To perform the control initiation operation 332, the NFC interface 34 of the handheld device 40 may be placed in close proximity to the RFID tag 118 associated with the standalone media player 68. The RFID tag 118 may be located on the standalone media player 68 itself or, as shown in FIG. 24, may be located on an associated remote control 74. Alternatively, the RFID tag 118 may be located on any other materials that may be associated with the standalone media player 68, such as a product manual. When the NFC interface 34 of the handheld device 40 approaches the RFID tag 118, the RFID tag 118 may become energized. Thereafter, the RFID tag 118 may communicate information relevant to the control of the standalone media player 68 via near field communication to the handheld device 40, as illustrated further below.

Turning to FIG. 25, a communication diagram 334 may describe communication that may take place during the control initiation operation 332 above, and may further represent steps 316-322 of the flowchart 312 of FIG. 22. The communication diagram 334 may begin when the NFC interface 34 of the handheld device 40 is in a “host mode,” as shown in block 336. The NFC interface 34 of the handheld device 40 may enter the “host mode” of block 336 when the screen 330 is displayed on the handheld device 40, as discussed above with reference to FIG. 23B. Turning to block 338, as illustrated by the control initiation operation 332 of FIG. 24, the user may tap the handheld device 40 to the RFID tag 118. Because the NFC interface 34 of the handheld device 40 may be operating in a host mode, the NFC interface 34 of the handheld device 40 may periodically transmit NFC pings, as shown in block 340. The NFC ping of the block 340 may energize the RFID tag 118, as illustrated by block 342. The energized RFID tag 118 may thereafter transmit control information, as shown in block 344.

The control information may provide information sufficient to enable the handheld device 40 to control the standalone media player 68. For example, the control information may include a serial number identifying the standalone media player 68. The serial number may enable the handheld device 40 to search a database at the web service 104. Based on the serial number, the web service 104 may provide information identifying the type of device, an internet protocol (IP) address of the standalone media player 68, a location where a control software plug-in for controlling the standalone media player 68 may be obtained, and/or the control software plug-in. Alternatively, the control information may include an XML message, which may provide similar information, such as the serial number, the type of device, and/or a location where the control software plug-in may be obtained. As should be appreciated, the control information that may be exchanged in the device profiles may be employed at a later time to obtain an appropriate control software plug-in for controlling the standalone media player 68 with the handheld device 40.

When the handheld device 40 has received the control information of the block 344, the handheld device 40 may issue a prompt, as shown by block 346. The prompt may represent, for example, a screen displayed on the handheld device 40 prompting the user to decide whether to obtain and install a control software plug-in for the purpose of controlling the controllable device 94. Thus, the prompt of block 346 may be represented by the screen 202 of FIG. 14A above.

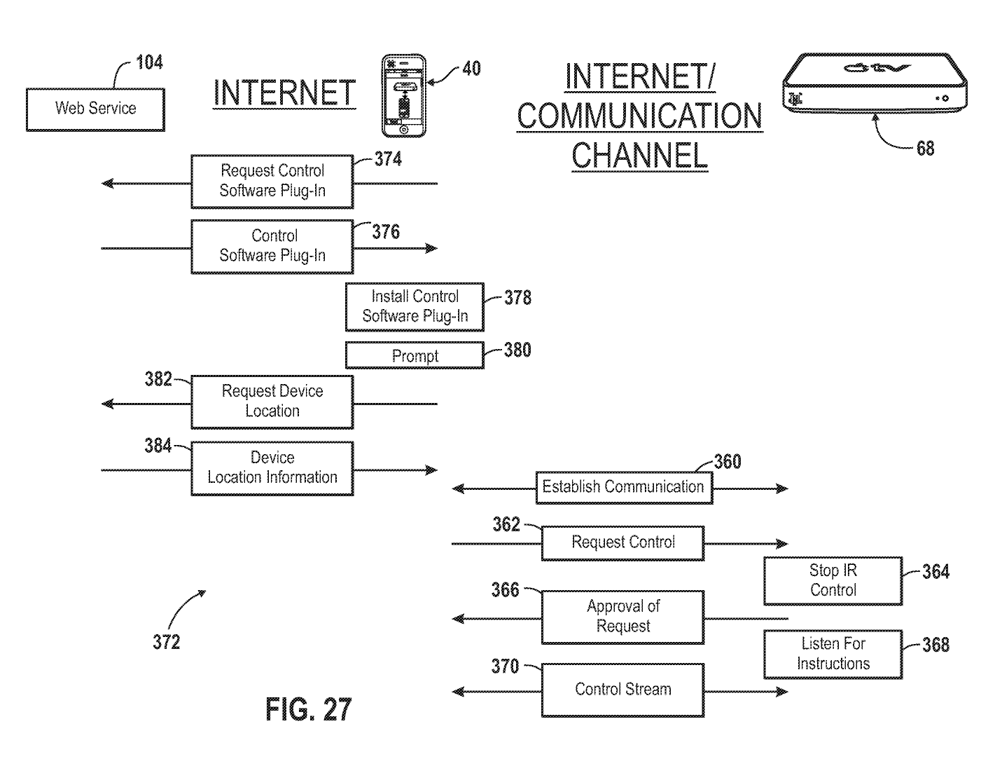

FIG. 26 represents another communication diagram 348, which may represent a manner of obtaining the control software plug-in for controlling the standalone media player 68 from the handheld device 40, and may represent communication corresponding to steps 322-328 of the flowchart 312 of FIG. 22. The communication diagram 348 may begin when the user responds to the prompt of the block 346 of FIG. 25 by choosing to obtain and install the control software plug-in.

At the start of the communication diagram 348, the handheld device 40 may issue a request for the appropriate control software plug-in to control the standalone media player 68 over the Internet 102 to the web service 104, as illustrated in block 350. The request may be based on the control information of block 344 of FIG. 25, as described above. The web service 104 may respond, as illustrated by block 352, by sending the appropriate control software plug-in to the handheld device 40.

In the same manner described above with reference to FIG. 15, the handheld device 40 may, in block 354, install the control software plug-in. Further, as illustrated in block 356, the handheld device 40 may issue a prompt enabling the user to begin to control the standalone media player 68. The prompt of the block 356 may correspond with the prompt of the screen 210 of FIG. 14E. When the user responds to the prompt of block 356 by selecting the button 212 of the screen 210, thereby electing to control the standalone media player 68, the handheld device 40 may attempt to locate the standalone media player 68. In the communication diagram 348, the handheld device 40 may search locally available networks for the standalone media player based on the control information of block 344 of FIG. 25, as shown by block 358. After locating the standalone media player 68, the handheld device 40 may establish communication with the standalone media player 68 over any communication channel 90 in block 360.

A control sequence, as illustrated by blocks 362-370, may begin. In block 362, the handheld device 40 may transmit a message requesting control over the standalone media player 68. As illustrated by block 364, the standalone media player 68 may disable control through the traditional means of the standalone media player 68, which may be, for example, by way of an infrared connection to the remote control 74. In block 366, the standalone media player 68 may approve the request of block 362 by transmitting a message to the handheld device 40. The standalone media player 68 may then listen for instructions over the communication channel 90 from the handheld device 40, as shown in block 368. The handheld device 40 may thereafter control the standalone media player 68 with a control stream of data, which is depicted generally by block 370. As should be appreciated, the precise data exchanged in the control stream may be defined by the control software plug-in that is employed to control the standalone media player 68.

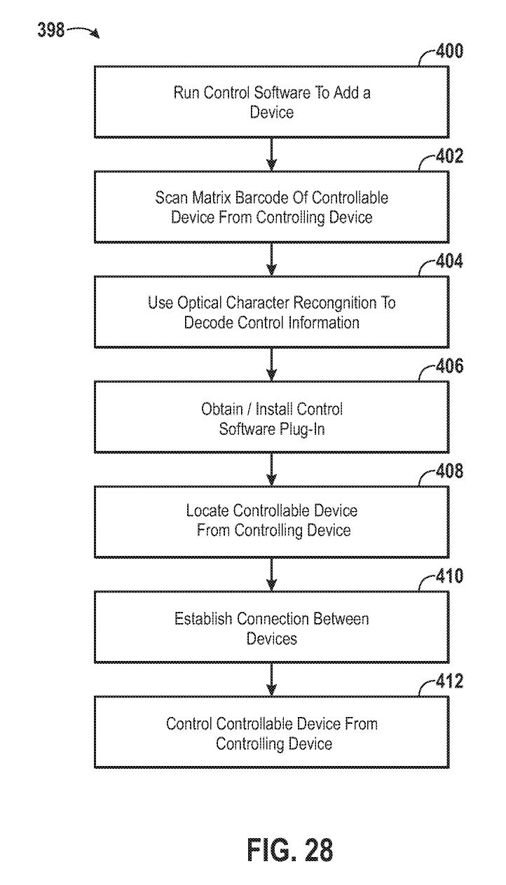

FIG. 27 is an alternative communication diagram 372, which may represent a manner of obtaining the control software plug-in for controlling the standalone media player 68 from the handheld device 40, and may also represent communication corresponding to steps 322-328 of the flowchart 312 of FIG. 22. The communication diagram 372 of FIG. 27 remains essentially unchanged from the communication diagram 348 of FIG. 26, with one exception. Specifically, blocks 374-380 and 386-396 of FIG. 27 correspond with blocks 350-356 and 360-370 of FIG. 26. However, as noted by blocks 382 and 384 of the communication diagram 372 of FIG. 27, the handheld device 40 may determine the location of the standalone media player 68 by requesting such information from the web service 104. The web service 104 may track the IP address and/or local network connection information of the standalone media player 68. After receiving the request for the location of the standalone media player 68 in block 382, the standalone media player 68 may reply with various location information, as shown in block 384. In block 386, the handheld device 40 may establish communication with the standalone media player 68 either by connecting to an IP address corresponding to the standalone media player 68 over the Internet, or using the techniques described above with reference to blocks 358 and 360 of FIG. 26.

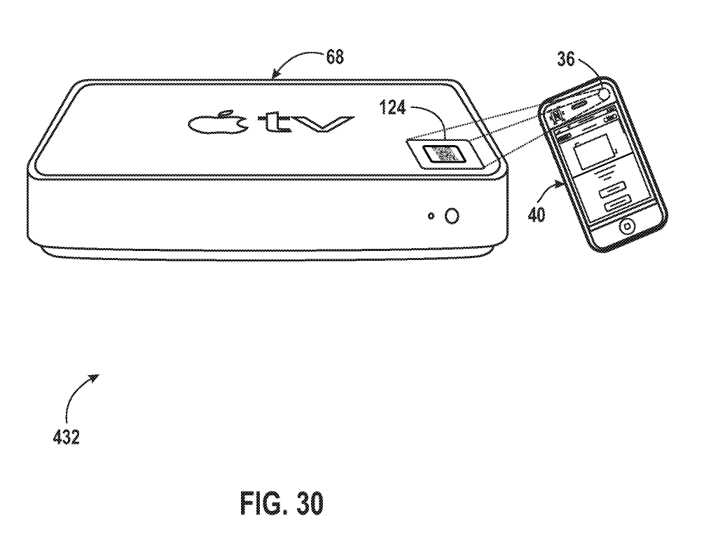

FIG. 28 is a flowchart 398 that may describe another manner of obtaining control software to control a controllable device 94 from a controlling device 92. Particularly, the technique described in the flowchart 398 may be employed when the controlling device 92 includes the camera 36 or another peripheral capable of reading a barcode or matrix barcode and the controllable device 94 includes a matrix barcode tag 124. To place the controlling device 92 in condition to extract control information from the matrix barcode tag 124, which may be located on or associated with the controllable device 94, a user may launch control software on the controlling device 92 in a first step 400. Such control software may be, for example, the device control application described above with reference to FIG. 2 above. The control software may prepare the controlling device 92 for controlling the controllable electronic device 94 by activating the camera 36 for scanning the matrix barcode tag 124, which is described below with reference to FIGS. 29-30.

In step 402, the user may scan the matrix barcode tag 124 associated with the controllable device 94 by acquiring an image of the matrix barcode tag 124. In a next step 404, the handheld device 40 may decode the matrix barcode tag 124 using matrix-barcode-reading software or optical character recognition software to obtain control information, which may provide information sufficient to enable the controlling device 92 to control the controllable device 94. By way of example, the control information may include a serial number and/or an XML message having information identifying the controllable device 94. The serial number may enable the controlling device 92 to search a database at the web service 104. Based on the serial number, the web service 104 may provide information identifying the type of device, an internet protocol (IP) address of the controllable device 94, a location where a control software plug-in for controlling the controllable device 94 may be obtained, and/or the control software plug-in. If the control information includes an XML message, the XML message may provide similar information, such as the serial number, the type of device, and/or a location where the control software plug-in may be obtained.

Once the user elects to obtain the control software plug-in, the controlling device 92 may obtain the control software plug-in from any number of possible sources in step 406. For example, the controlling device 92 may contact the web service 104 to obtain an appropriate control software plug-in for the controllable device 94 based on the control information, or the controlling device 92 may communicate directly with the controllable device 94 to obtain the control software plug-in. After obtaining the control software plug-in, the controlling device 92 may install the control software plug-in for use with the device control application. It should be appreciated that if the control software plug-in indicated by the control information already exists on the controlling device 92, step 406 may be omitted.

Having obtained and installed the control software plug-in in step 322, the user may choose to begin to control the controllable device 94 from the controlling device 92. Accordingly, in step 408, the controlling device 92 may locate the controllable device 94. The controlling device 92 may locate the controllable device 94 using the control information obtained from the matrix barcode tag 124 directly or indirectly. For example, the control information may list a MAC address and/or password for the controllable device 94; the controlling device 92 may search local networks for the MAC address listed in the control information to locate the controllable device 94. Alternatively, the controlling device 92 may contact the web service 104 to obtain an IP address registered for the controllable device 94. After locating the controllable device 94, the controlling device 92 may establish a connection with the controllable device 94 in step 410. As should be appreciated, the connection may take place over any of the communication channels 90, as illustrated in FIG. 7. In step 412, the controlling device 92 may thereafter control the controllable device 94 in a control stream of data between the devices, based on the control software plug-in obtained in step 406. FIGS. 29-31 that follow may illustrate an embodiment of the technique described in the flowchart 398.

FIGS. 29A-C represents steps 402 and 404 of the flowchart 398 of FIG. 28 above. Turning first to FIG. 29A, the screen 162 may present the user with the button 168 labeled “Scan Code.” Selecting the user selectable button 168 may cause the handheld device 40 to display a screen 414, as illustrated in FIG. 29B. The screen 246 may include a camera window 416 and a user selection prompt 418. The camera window 416 may present video images from the camera 36 of the handheld device 40. As noted in FIG. 29B, the user selection prompt 418 may instruct the user to align the matrix barcode tag 124 on the camera screen 416 to acquire an image. Image boundaries 420 may indicate the portion of the camera window 416 that may be saved as an image; selecting a user selectable button 422 labeled “Acquire” may cause the image of the matrix barcode tag 124 currently within the image boundaries 420 to be acquired.

A screen 424, shown in FIG. 29C, may be displayed when the button 422 is selected. A still image 426 may represent the image acquired by the camera 36. Two buttons 428 and 430 may be labeled “Process Image” and “Re-Acquire,” respectively. The button 428 may allow a user to proceed with the still image 426, while the button 430 may allow the user to acquire another image of the matrix barcode 124 by returning to the screen 414 of FIG. 29B.

FIG. 30 depicts a control initiation operation 432 that may take place in conjunction with the screens of FIGS. 29A-C, which may also represent steps 402 and 404 of the flowchart 398 of FIG. 28. As illustrated in FIGS. 29A-C above, a user may scan the matrix barcode tag 124 that may be located on the electronic device 10 to be controlled. In the example of FIG. 30, the camera 36 of the handheld device 40 may acquire an image of the matrix barcode tag 124 that may be located on the standalone media player 68. The handheld device 40, using optical character recognition and/or matrix-barcode-reading software, may obtain control information from the matrix barcode tag 124. As should be appreciated, the control information encoded in the matrix barcode tag 124 may be used by the handheld device 40 to acquire the appropriate control software plug-in to control the standalone media player 68.

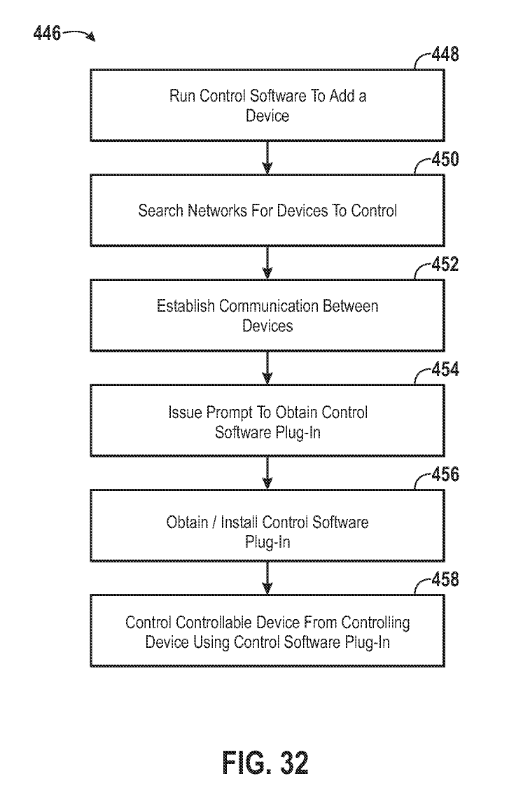

Turning to FIG. 31, a communication diagram 434 represents communication that may take place in the control initiation operation 432 of FIG. 30 and/or steps 402-404 of the flowchart 398 of FIG. 28. At the outset of the communication diagram 434, the handheld device 40 may enter an “acquire image” mode, as indicated by block 436. The “acquire image” mode of the handheld device 40 may be represented by the screen 414 shown in FIG. 29B. As noted by block 438, the user may next align the matrix barcode tag 124 in the camera to acquire an image of the matrix barcode 128.

As illustrated by block 440, the image 426 may be acquired. The image 426 may be represented on the screen 424 of FIG. 29C above. When the user selects the button 428 of the screen 424, the handheld device 40 may process the image 426 using optical character recognition or matrix-barcode-reading software to obtain control information encoded on the matrix barcode tag 124, as shown in block 442. After obtaining the control information, the handheld device 40 may issue a prompt, such as that of the screen 202 of FIG. 14A, which may prompt the user to obtain and/or install the appropriate control software plug-in. It should be understood that the control software plug-in may be obtained and installed using the techniques described above with reference to FIGS. 26-27, and that the handheld device 40 may thereafter control the standalone media player 68 in the manner described above with reference to FIG. 17.

FIG. 32 represents a flowchart 446 that may describe another manner of obtaining control software to control a controllable device 94 from a controlling device 92. Particularly, the technique described in the flowchart 312 may be employed when the controlling device 92 and the controllable device 94 include the PAN or LAN network interfaces 28 or 30. The flowchart 446 may begin when a user may launch control software on the controlling device 92 in a first step 314. Such control software may be, for example, the device control application described above with reference to FIG. 2 above. The control software may prepare the controlling device 92 by enabling the controlling device 94 to search available networks for controllable devices 94.

In step 450, the controlling device 92 may search available networks for controllable devices 94 that have not yet been added. To discover the controllable devices 94, the controlling device 92 may seek device identification broadcast protocol messages, such as Bonjour® messages, that may indicate which networked devices are controllable devices 94. After identifying at least one controllable device 94 from a device identification broadcast protocol message, the controlling device 92 may establish communication with a selected controllable device 94 in step 452. Establishing communication with the controllable device 94 may allow the controlling device 92 to obtain control information from the controllable device 94. Alternatively, in lieu of establishing communication with the controllable device 94 to obtain the control information in step 452, the controlling device 92 may instead obtain the control information from the device identification broadcast protocol message, if such control information is present in the message.

It should be appreciated that the control information may provide information sufficient to enable the controlling device 92 to control the controllable device 94. By way of example, the control information may include a serial number and/or an XML message having information identifying the controllable device 94. The serial number may enable the controlling device 92 to search a database at the web service 104. Based on the serial number, the web service 104 may provide information identifying the type of device, an internet protocol (IP) address of the controllable device 94, a location where a control software plug-in for controlling the controllable device 94 may be obtained, and/or the control software plug-in. If the control information includes an XML message, the XML message may provide similar information, such as the serial number, the type of device, and/or a location where the control software plug-in may be obtained.

Turning to step 454, either the controlling device 92 or the controllable device 94 may issue a prompt to the user to obtain the control software plug-in described in the control information, which may be used by the controlling device 92 to control the controllable device 94. Once the user elects to obtain the control software plug-in, the controlling device 92 may obtain the control software plug-in from any number of possible sources in step 456. For example, the controlling device 92 may contact the web service 104 to obtain an appropriate control software plug-in for the controllable device 94 based on the control information, or the controlling device 92 may communicate directly with the controllable device 94 to obtain the control software plug-in. After obtaining the control software plug-in, the controlling device 92 may install the control software plug-in for use with the device control application. It should be appreciated that if the control software plug-in indicated by the control information already exists on the controlling device 92, step 456 may be omitted.

Having obtained and installed the control software plug-in in step 456, the user may choose to begin to control the controllable device 94 from the controlling device 92. Accordingly, in step 458, the controlling device 92 may establish a connection with the controllable device 94. As should be appreciated, the connection may take place over any of the communication channels 90, as illustrated in FIG. 7. The controlling device 92 may thereafter control the controllable device 94 with a control stream of data between the devices, based on the control software plug-in obtained in step 456. FIG. 33 that follows may illustrate an embodiment of the technique described in the flowchart 446.

Turning to FIG. 33A, a user may select the button 170, labeled “Discover Wirelessly,” of the screen 162. Doing so may cause the handheld device 40 to display a screen 460, as illustrated in the block 33B. The screen 460 may indicate that the handheld device 40 is searching for new devices to control using its wireless capabilities. By way of example, the handheld device 40 may scan available networks in search of a broadcast identification protocol message, as may be provided by Bonjour® by Apple Inc.

After searching available networks for controllable devices 94, the handheld device 40 may display a screen 462, as illustrated in FIG. 33C. The screen 462 may display list items 464 having text and images related to any controllable devices 94 that may be located over available networks. For example, the list items 464 may include a device name and general location describing where the device may be located. The screen 462 may additionally include a button 466, labeled “Options,” which may vary the manner in which the list items 464 are displayed. By way of example, a user may vary the list items 464 such that the devices are listed by proximity, by most recently selected, by newly available, etc. A refresh button 468 may cause the handheld device 40 to search again for controllable devices 94 and display any newly discovered devices.

FIG. 33D illustrates a visually descriptive screen 470 displaying the list items 464 of available controllable devices 94. The screen 470 may be displayed when a user turns the handheld device 40 sideways, causing the accelerometers 38 to register a change in device orientation. The screen 470 may illustrate the list items 464 of available controllable devices 94 in a format such as the Cover Flow format by Apple Inc. The available controllable devices may be displayed visually with a series of descriptive images 472 and the name of a presently displayed device, as shown by text 474. By dragging a finger across the screen, a user may easily flip between devices. Turning the handheld device 40 upright may navigate the user back to the screen 462 of FIG. 33C.

Turning next to FIG. 32E, the handheld device 40 may display a screen 476 when the list item 464 labeled “Apple TV/Living Room” is selected. The screen 476 may prompt the user to add the standalone media player 68 to the list of devices that may be controlled by the handheld device 40 with a button 478, labeled “Install Control Plug-In.” As should be appreciated, selecting the button 478 may initiate the attainment and installation of the control software plug-in related to the standalone media player 68. The handheld device 40 may obtain and install the control software plug-in using the techniques described above.

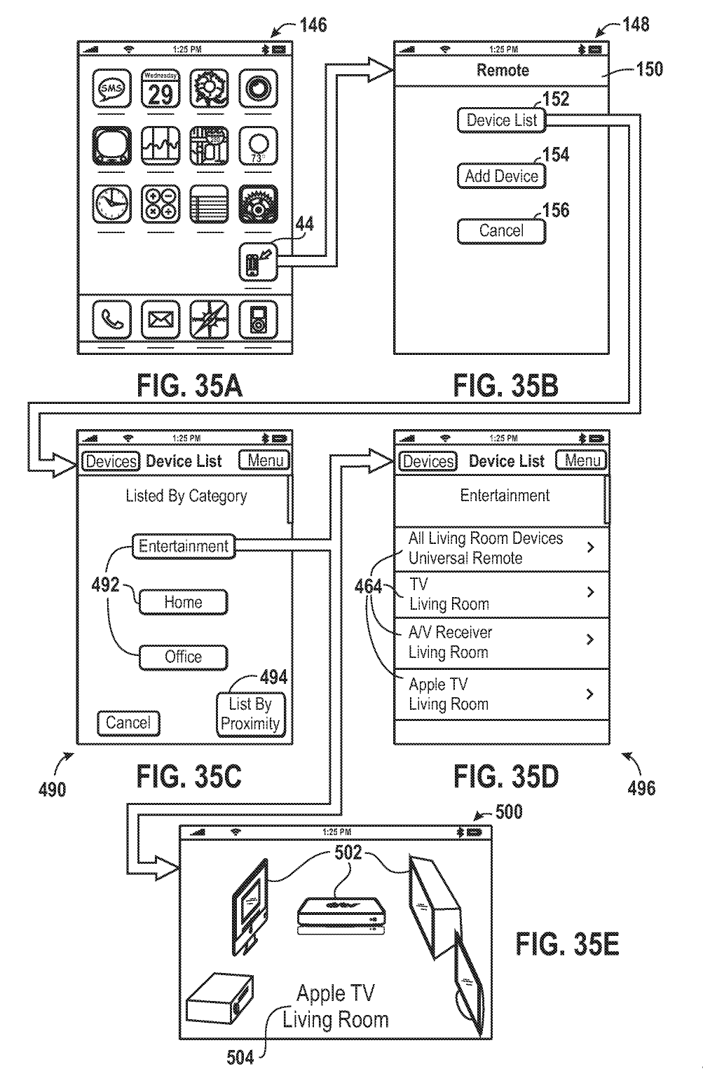

FIG. 34 represents a flowchart 480, which may describe a technique for controlling a controllable device 94 after an appropriate control software plug-in has previously been obtained and installed on the controlling device 92. In a first step 482, a user may begin to run control software running on the controlling device 92. Specifically, the user may select a particular controllable device 94 from among a list of available devices. In a subsequent step 484, the controlling device 92 may locate the controllable device 94 over a local network or over the Internet. In step 486, the controlling device may establish communication with the controllable device 94 over one of the communication channels 90, and in step 488, the controlling device 92 may begin to control the controllable device 94.

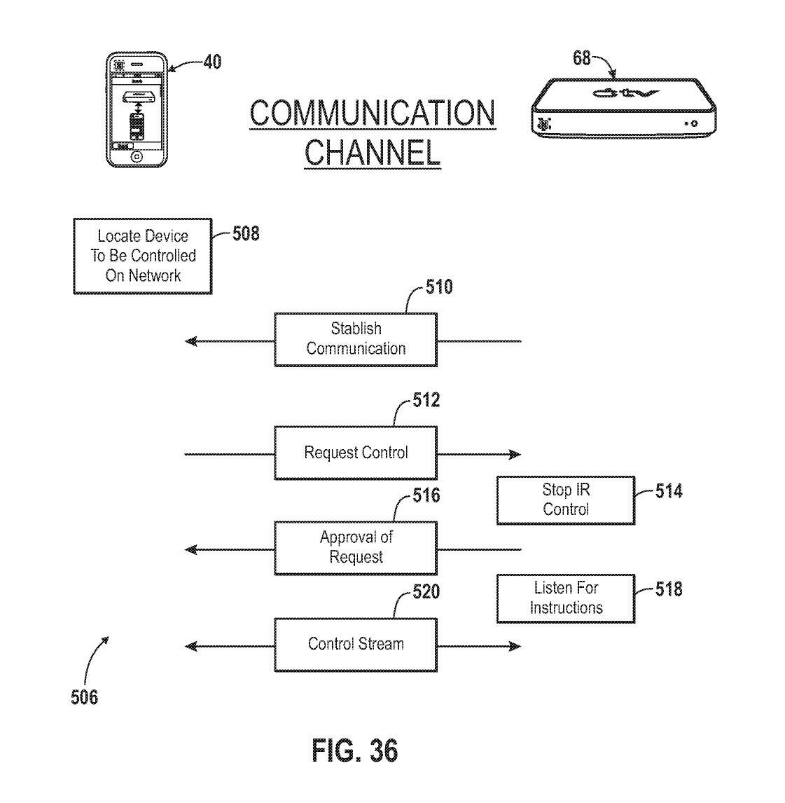

FIGS. 35A-35E represent screens that may be displayed on the handheld device 40 when the handheld device 40 acts as the controlling device 92 during step 482 of the flowchart 480 of FIG. 34. Turning first to FIG. 35A, a user may select the control software application icon 44 to launch the device control application. As illustrated in FIG. 35B, the screen 148 may be displayed as a main menu screen for the control software application. If a user chooses to select the button 152, labeled “Device List,” the user may view a list of stored devices that may be controlled from the handheld device 40.

Turning to FIG. 35C, a screen 490 may be displayed on the handheld device 40 when the button 152 is selected. The screen 490 may display various categories of devices that may be installed for control on the handheld device 40. A series of category buttons 492 may include, for example, “Entertainment,” “Home,” “Office,” and “Other.” Additionally, a user may choose to list the devices by proximity rather than category, as indicated by a button 494 labeled, “List by Proximity.” Selecting the button 494 may cause the handheld device 40 to list devices in terms of signal strength, proximity of GPS coordinates, or by the room in which the devices may be located.

By way of example, a user may select the button 492 labeled “Entertainment.” The handheld device 40 may thereafter display a screen 496, as illustrated in FIG. 35D. The screen 496 may list various controllable devices 94 associated with the category “Entertainment.” The controllable devices 94 may appear as list items 498, and may include various controllable devices 94 that may have previously been installed for control by the handheld device 40, in accordance with techniques described above. Alternatively, the handheld device 40 may have been preprogrammed to control certain devices without need to add the devices. For example, a manufacturer of a controllable device 94 may purchase the right to pre-install an appropriate control software plug-in on the handheld device 40, such that a user may be able to control the controllable device 94 without first installing the device using the techniques described above.

FIG. 35E illustrates a visually descriptive screen 500 displaying the list items 498 of available controllable devices 94. The screen 500 may be displayed when a user turns the handheld device 40 sideways, causing the accelerometers 38 to register a change in device orientation. The screen 500 may illustrate the list items 498 of available controllable devices 94 in a format such as the Cover Flow format by Apple Inc. The available controllable devices may be displayed visually with a series of descriptive images 502 and the name of a presently displayed device, as shown by text 504. By dragging a finger across the screen, a user may easily flip between devices. Turning the handheld device 40 upright may navigate the user back to the screen 462 of FIG. 35D.

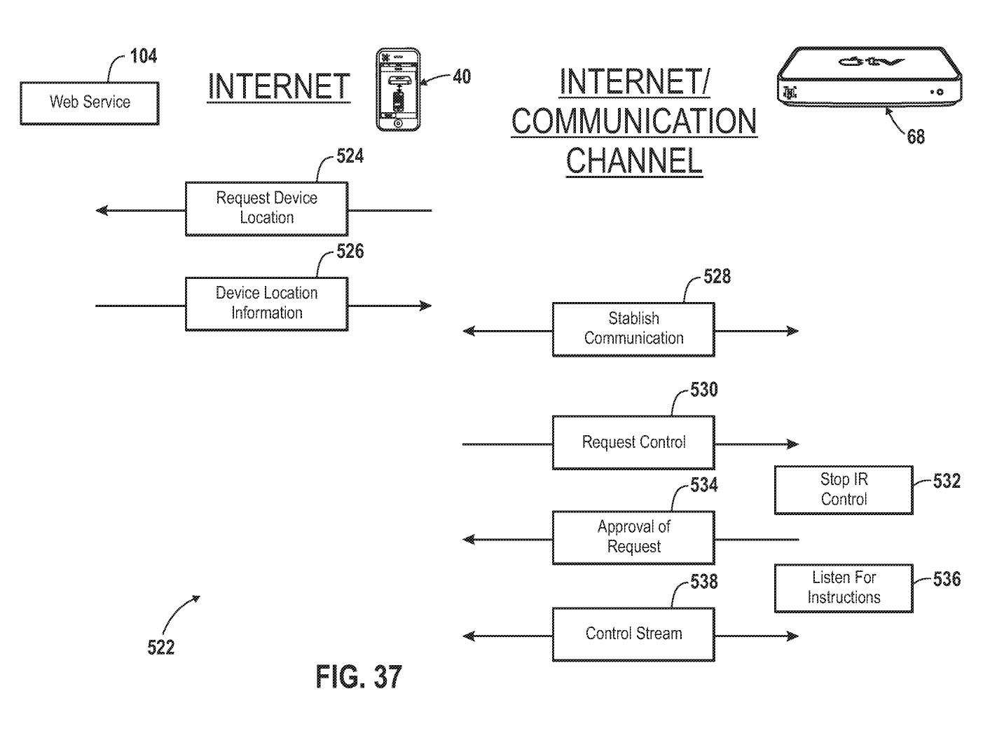

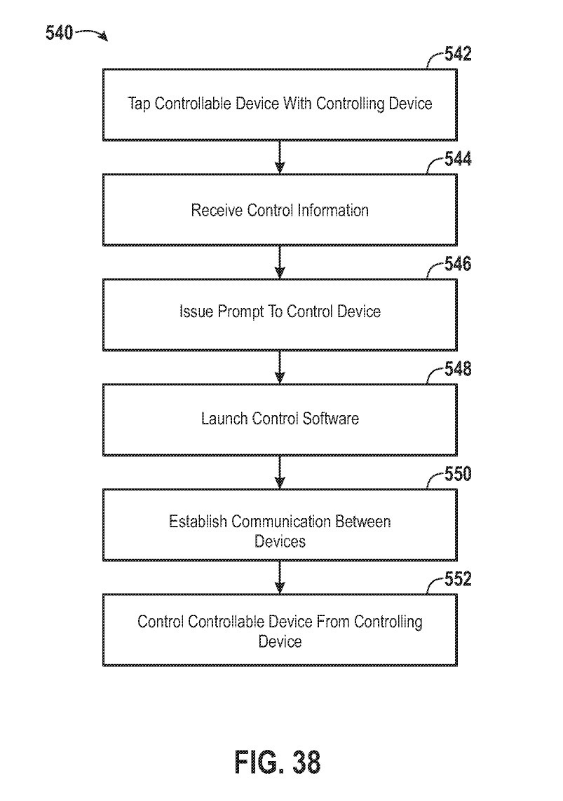

FIGS. 36-37 illustrate communication that may take place when the user selects the standalone media player 68 as the controllable device 94 from among the list items 498, and may represent steps 484-488 of the flowchart 480 of FIG. 34. Turning first to FIG. 36, a communication diagram 506 may describe communication between the handheld device 40 and the standalone media player 68, which may occur in the manner described above with reference FIG. 26 above. Particularly, blocks 508-520 of the communication diagram 506 of FIG. 36 may correspond with blocks 358-370 of the communication diagram 348 of FIG. 26. Similarly, turning to FIG. 37, a communication diagram 522 may describe communication between the handheld device 40 and the standalone media player 68 that may occur in the manner described with reference to FIG. 27 above. Particularly, blocks 524-538 of the communication diagram 522 of FIG. 37 may correspond with blocks 382-396 of the communication diagram 372 of FIG. 27.

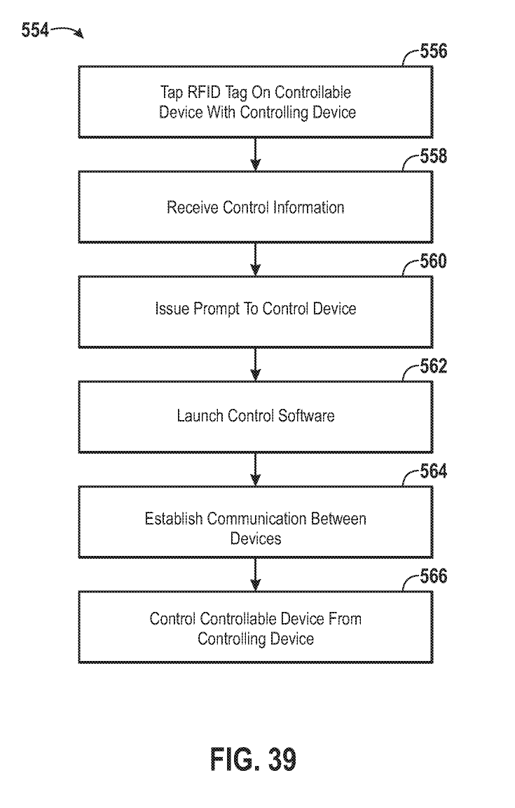

Turning to FIG. 38, a flowchart 540 represents another technique for controlling an electronic device 10. Particularly, the flowchart 540 of FIG. 38 may describe a technique for controlling the controllable device 94 after the control software plug-in associated with the controllable device 94 has been installed on the controlling device 92 using the techniques described above. In a first step 542, the NFC interface 34 of the controlling device 92 may be tapped to the NFC interface 34 of the controllable device 94.

In step 544, the controlling device 92 may receive control information from the NFC interface 34 of the controllable device 94, in the manner described above with reference to FIG. 20. The controlling device 92 may thereafter issue a prompt to control the controllable device 94, as shown in the step 546. The prompt of step 546 may be, for example, the screen 308 of FIG. 21. In step 548, the controlling device 92 may launch the device control application on the controlling device 92. The controlling device 92 may establish communication with the controllable device 94 in a step 550, and in step 552, the controlling device 92 may control the controllable device 94 by transmitting a control screen to the controllable device 94.

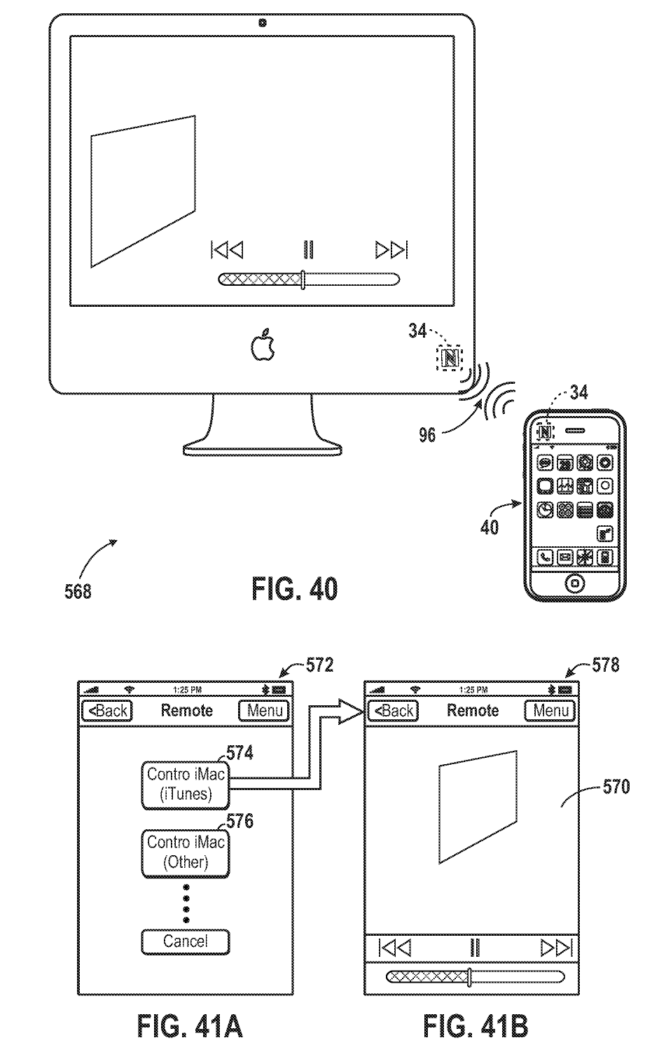

Turning to FIG. 39, a flowchart 554 represents an alternative manner of controlling an electronic device 10. Particularly, the flowchart 554 of FIG. 39 may describe a technique for controlling the controllable device 94 after the control software plug-in associated with the controllable device 94 has been installed on the controlling device 92 using the techniques described above. In a first step 556, the NFC interface 34 of the controlling device 92 may be tapped to the RFID tag 118 associated with the controllable device 94.

In step 558, the controlling device 92 may receive control information from the RFID tag 118, in the manner described above with reference to FIG. 25. The controlling device 92 may thereafter issue a prompt to control the controllable device 94, as shown in the step 560. The prompt of step 560 may be, for example, the screen 308 of FIG. 21. In step 562, the controlling device 92 may launch the device control application on the controlling device 92. The controlling device 92 may establish communication with the controllable device 94 in a step 564, and in step 566, the controlling device 92 may control the controllable device 94 by transmitting a control screen to the controllable device 94.

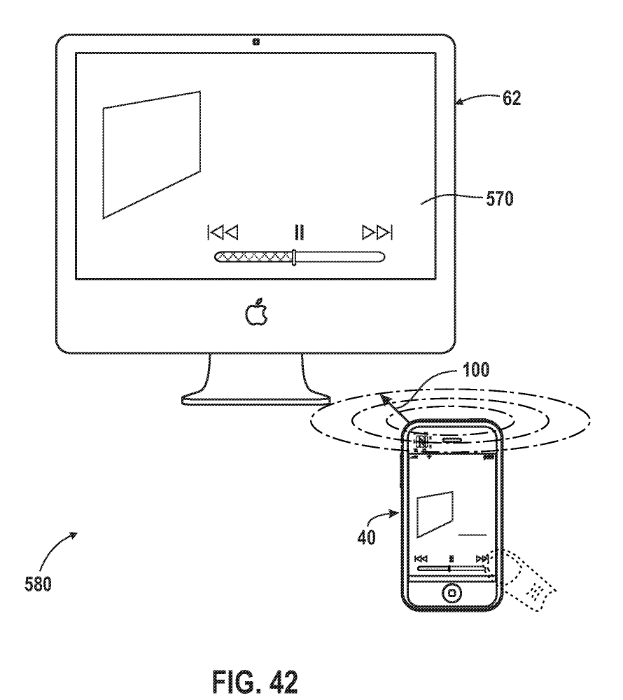

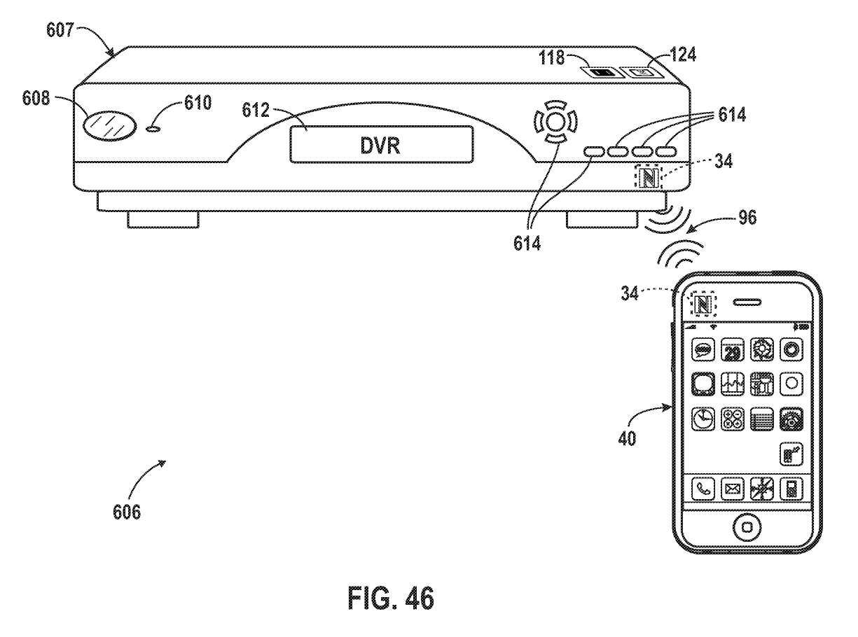

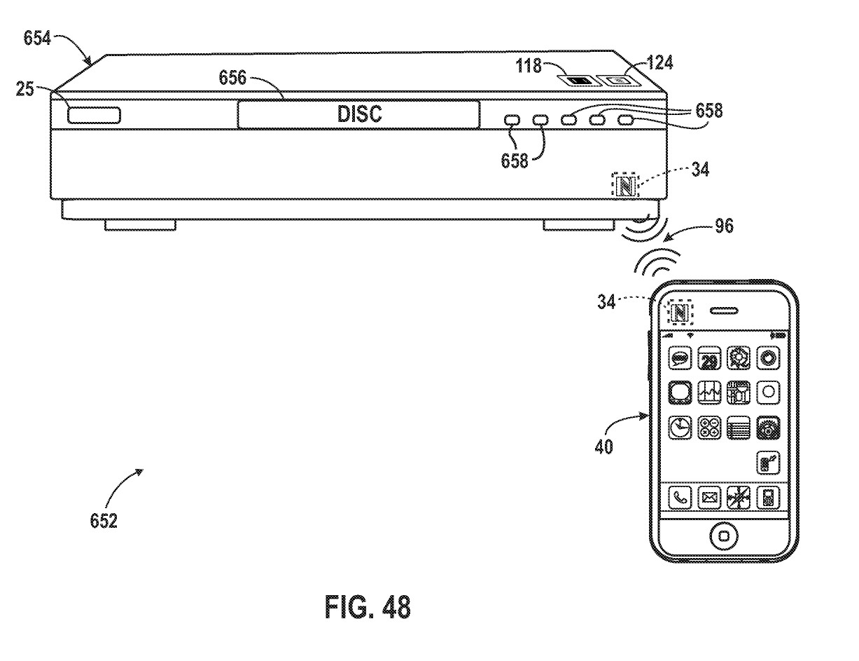

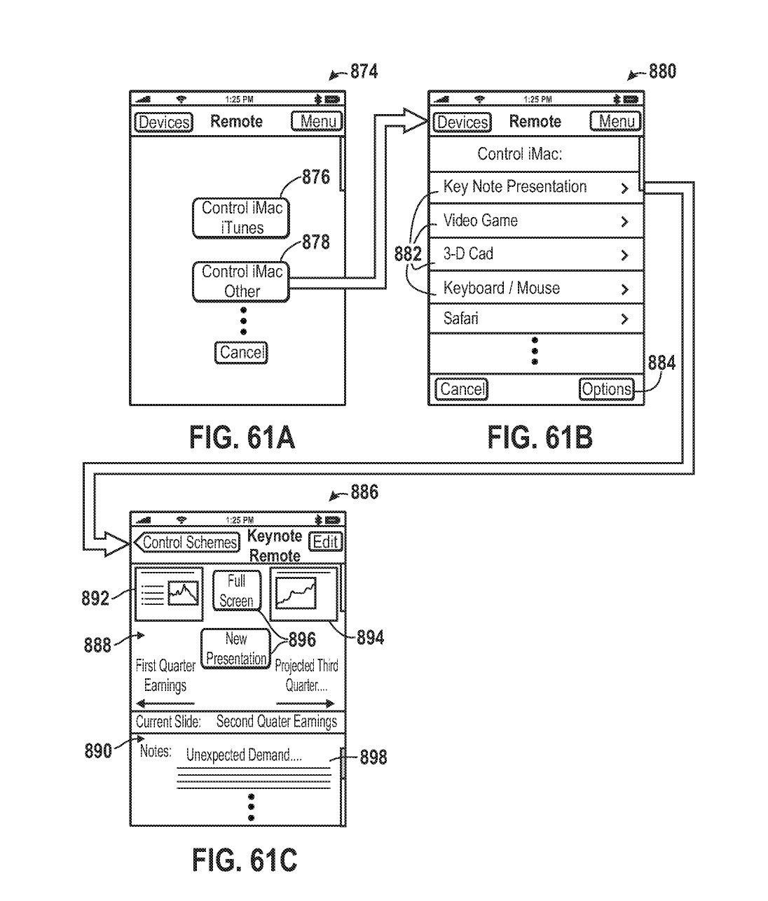

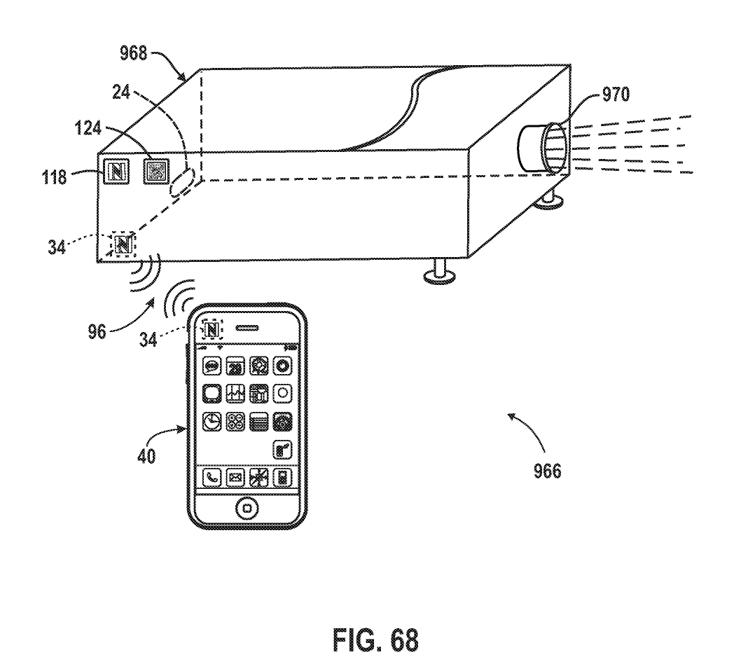

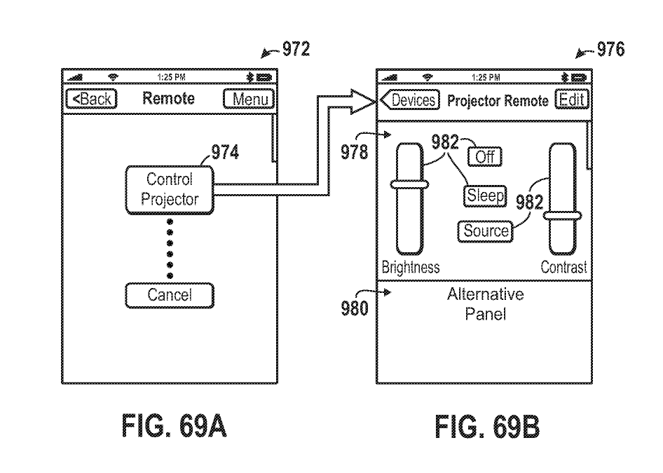

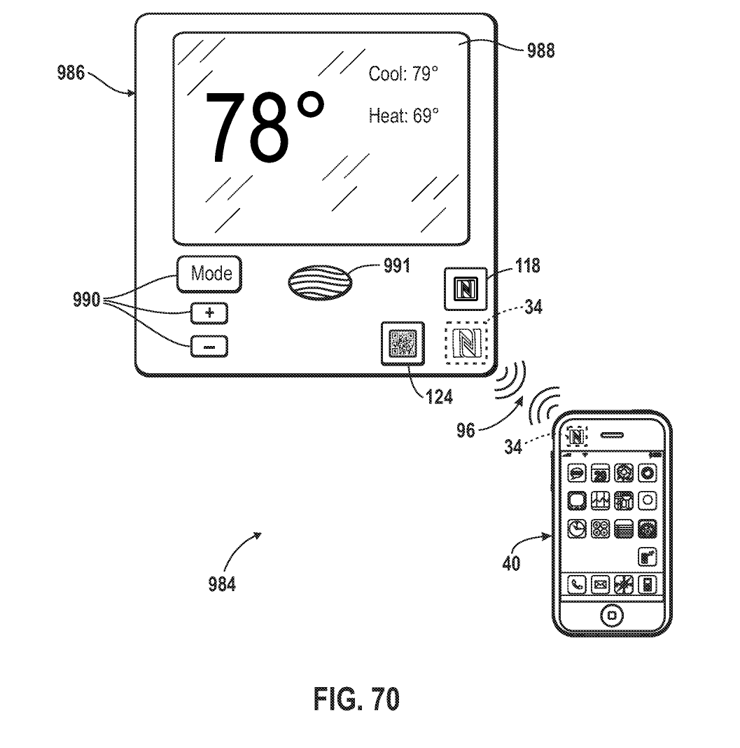

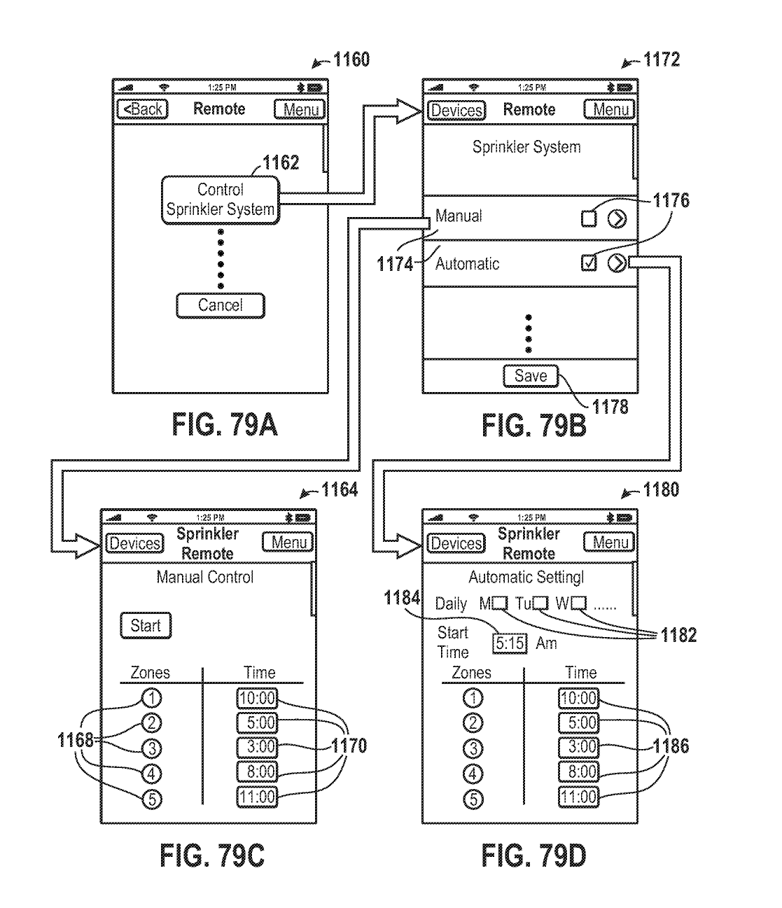

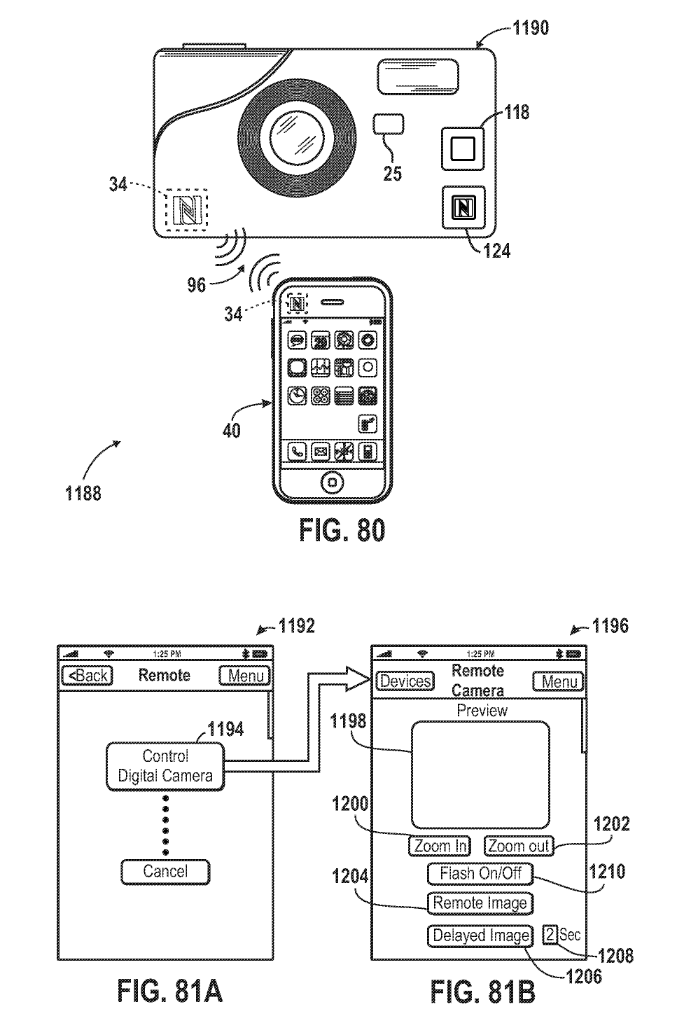

Using the techniques described above, a variety of different electronic devices 10 may be controlled. FIGS. 40-81 illustrate many such examples in greater detail below. Particularly, FIGS. 40-43 illustrate using the above-described techniques for controlling various media-playing devices; FIGS. 44-45 and 52-53 illustrate using the above-described techniques for controlling a video game system; FIGS. 46-51 and 54-59 illustrate using the above-described techniques for controlling various consumer electronic devices frequently found in home theater or entertainment systems; FIGS. 60-67 illustrate using the above-described techniques for controlling software on a computer system; FIGS. 68-69 illustrate using the above-described techniques for controlling a video projector; FIGS. 70-79 illustrate using the above-described techniques for controlling various home utility devices; and FIGS. 80-81 describe using the above-described techniques for controlling a digital camera.

As should be appreciated, specific control software plug-ins may be developed for each type of controllable device 94. The specific control software plug-ins may include one or more control schemes to enable a particular manner of control. By way of example, a control scheme for controlling a television may provide the same functionality found in a remote control associated with the television. Thus, a manufacturer of a controllable device 94 or another developer may develop a control scheme specific to the controllable device 94, and may include the control scheme as part of a control software plug-in associated therewith. In this way, the manufacturer or other developer may make the functionality of a remote control associated with the controllable device 94 available. Alternatively, the manufacturer or other developer may include a control scheme featuring additional functionality not traditionally available.

The manufacturer of a controllable device 94 or another developer may provide control schemes or control software plug-ins associated with the controllable device 94 to the manufacturer of a controlling device 92, such as the handheld device 40. The control schemes or control software plug-ins may be preinstalled on the controlling device 92 or may be located to the web service 104 for distribution at a later time. Due to the availability of the techniques described above, the manufacturer of the controllable device 94 may add marketable functionality to the controllable device 94.

As discussed above, FIGS. 40-43 illustrate using the above-described techniques for controlling various media-playing devices. FIG. 40 depicts a control initiation operation 568 between a handheld device 40, representing the controlling device 92, and a computer 62, representing the controllable device 94. The computer 62 may be playing media in a media management application such as iTunes® by Apple Inc. A user may tap the NFC interface 34 of the handheld device 40 to the NFC interface 34 of the computer 62, which may cause the NFC communication channel 96 to become established between the two devices. Through the NFC communication channel 96, control information may be exchanged, as described above. Accordingly, the handheld device 40 may determine that the computer 62 may be controlled and may issue a prompt for the user to control the computer 62.

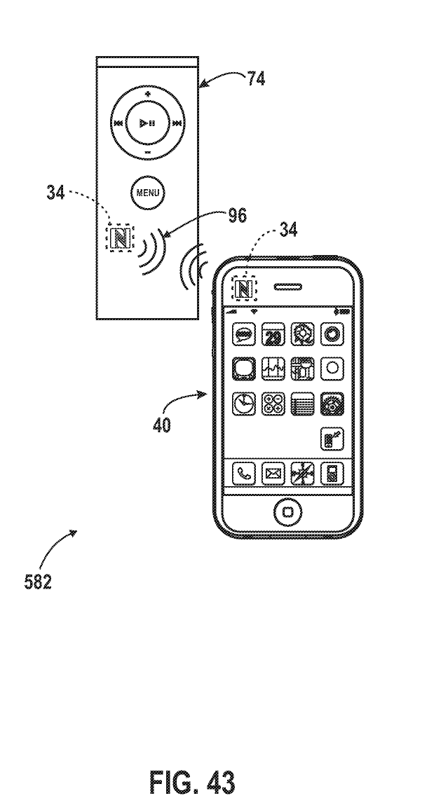

FIGS. 41A-B represent screens that may be displayed on the handheld device 40 in response to the operation 568 described above. Turning first to FIG. 41A, a screen 572 may represent a prompt that may be displayed when the handheld device 40 is tapped to the NFC interface 34 of the computer 62. The screen 572 may include user selectable buttons 574 and 576, labeled “Control iMac (iTunes),” and “Control iMac (Other),” respectively. The button 574 may appear first because the computer 62 may be currently playing media in a media management application, such as ITunes® by Apple Inc. If the user selects the button 574, a screen 578 may be displayed on the handheld device, as shown in FIG. 41B. The screen 578 may represent a remote control screen 570, whereby the user may control the media management application on the computer 62, using the techniques described above.

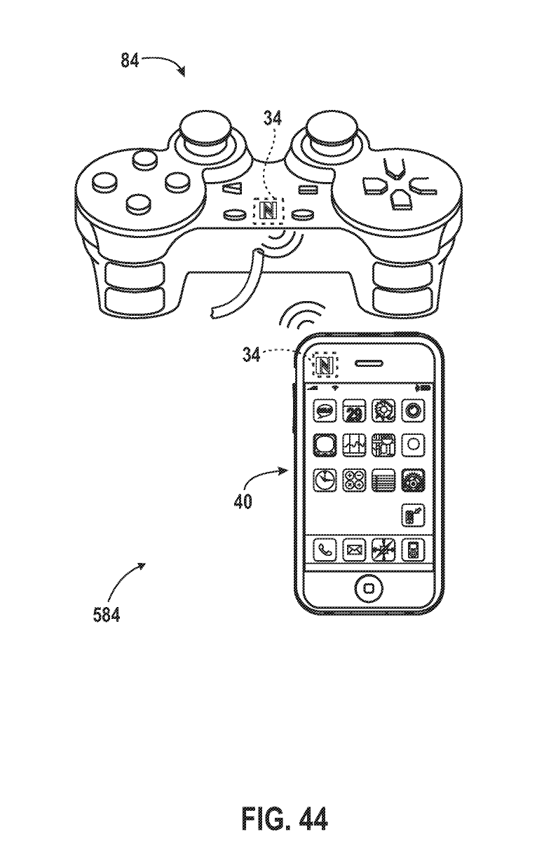

FIG. 42 depicts a remote control operation 580 between the handheld device 40 representing the controlling device 92, and the computer 62 representing the controllable device 94. A user may control the computer 62 by selecting buttons that appear on remote control screen 570. Such buttons may include, for example, media control buttons, media selection buttons, etc., which may allow the user to affect the playback of media playing on the computer 62.

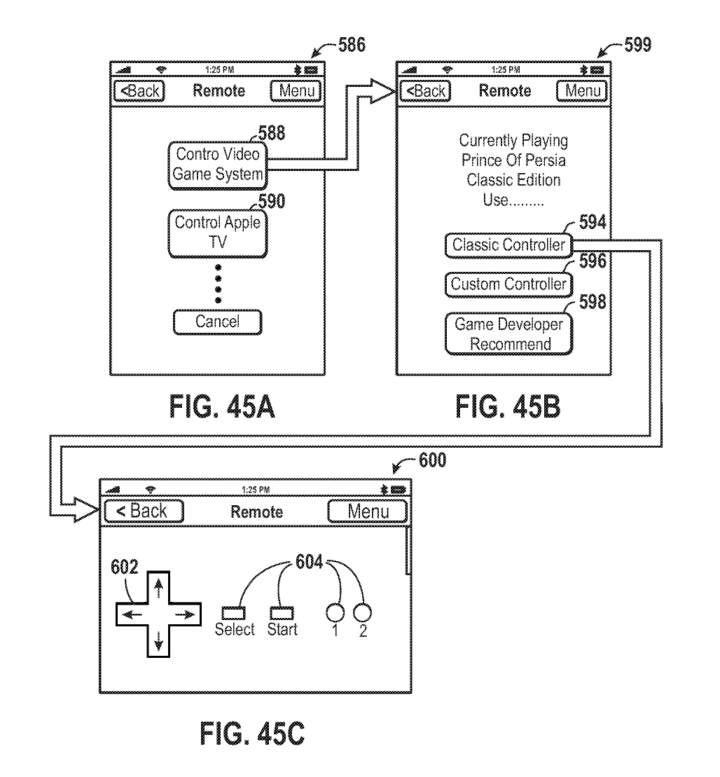

Turning to FIG. 43, an alternative manner of controlling the standalone media player 68 may be illustrated by a control initiation operation 582. In the example of FIG. 43, the handheld device 40 may represent the controlling device 92 and the standalone media player 68 may represent the controllable device 92. The control initiation operation 582 may begin when the handheld device 40 is placed in close proximity to the NFC interface 34 of the remote control 74 associated with the standalone media player, which may establish the NFC communication channel 96, over which control information may be exchanged, as described above. As should be appreciated, when the operation 582 is performed, the handheld device 40 may display a prompt to enable a user to control the standalone media player 68 according to the techniques described above.

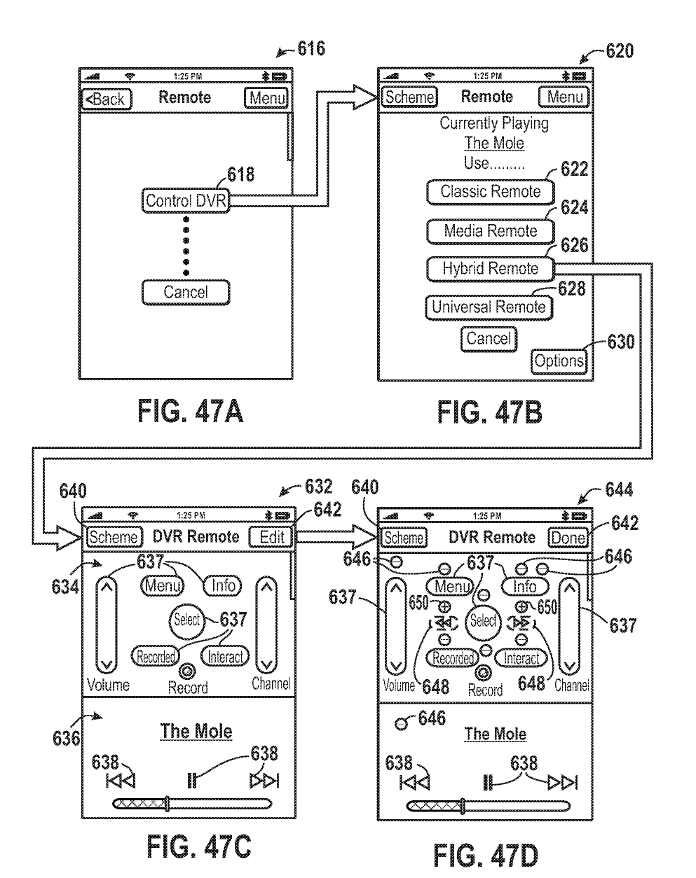

As noted above, FIGS. 44-45 illustrate using the above-described techniques for controlling a video game system. FIG. 44 depicts a control initiation operation 384 between a handheld device 40, representing the controlling device 92, and a game controller 84, representing a controller associated with the controllable device 94, which may be a video game system or the standalone media player 68. The video game system or the standalone media player 68 may be running a video game configured to interact with the handheld device 40. A user may tap the NFC interface 34 of the handheld device 40 to the NFC interface 34 of the game controller 84, which may cause the NFC communication channel 96 to become established between the two devices. Through the NFC communication channel 96, control information may be exchanged, as described above. Accordingly, the handheld device 40 may determine that the video game system or standalone media player 68 may be controlled and may issue a prompt for the user to initiate control.

FIGS. 45A-C represent screens that may be displayed on the handheld device 40 after the operation 584 of FIG. 44. Turning first to FIG. 45A, a screen 586 may be displayed on the handheld device 40, representing a prompt to control any devices to which the game controller 84 pertains. For example, a button 588, labeled “Control Video Game System,” may allow a user to control a video game system to which the video game controller 84 pertains. Alternatively, the video game controller 84 may also be used to control the standalone media player 68. Thus, a button 590, labeled “Control Apple TV” may allow a user to control the standalone media player 68 using the media management controls described above.

By selecting the button 588, a user may navigate to a screen 592, as illustrated in FIG. 45B. The screen 592 may generally indicate what game is being played on the video game system, and may provide various actions for using the handheld device 40 to control the game. For example, a button 594, labeled “Classic Controller,” may allow a user to control the game with a controller of the type that may have been available when the game was released. A button 596, labeled “Custom Controller,” may allow user to use a customized video game controller on the handheld device 40 to control the game. A button 598, labeled “Game Developer Recommends . . . ,” may allow a user to control the game using a video game controller on the handheld device 40 recommended by the developers of the video game, if the developers have recommended a controller.

By way of example, the user may select the button 594, labeled “Classic Controller.” During so may cause the handheld device 40 to display a screen 600, as shown in FIG. 45C. The screen 600 may represent a video game controller including, for example, a directional pad 602 and various other buttons 604 that may be configured to control the standalone media player 68 or another video game system. The display 18 of the handheld device 40 may include support for multi-touch display input technology, as available with the Apple IPhone® and IPod Touch®. The video game controller of the screen 600 may function in the same manner as a traditional video game controller or the video game controller 84.

FIG. 46 illustrates a control initiation operation 606 between a handheld device 40 and a digital video recorder (DVR) 607. The DVR 607 may represent an embodiment of the electronic device 10, which may output video information to an analog or digital television. By way of example, the DVR 607 may represent a DVR by Motorola or Scientific Atlanta configured to provide control information to and/or to be controlled by another electronic device 10, such as the handheld device 40. Internal components of the DVR 607, such as non-volatile storage 16, may store digital video recordings of television programs, which may be replayed on the analog or digital television. As should be appreciated, the DVR 607 may be capable of interfacing with another electronic device 10, such as the handheld device 40, through such means as the infrared interface 25 or the network interfaces 26.

As indicated in FIG. 46, a button 608 may represent an on/off switch, and an indicator light 610 may indicate whether the DVR 607 is on or off, or recording or not recording. A display screen 612 may represent, for example, an LCD screen to provide indications of time, channel, or other related information. Various input buttons 614 may enable a user to change the channel, record a television program, or navigate a menu, for example. The DVR 607 may or may include the NFC interface 34. As should be appreciated, the NFC interface 34 may provide control information to another electronic device 10 having an NFC interface 34. If the NFC interface 34 is not present, an RFID tag 118 or matrix barcode tag 124 may be located on the DVR 607 or associated with the DVR 607. Using the techniques described above, the RFID tag 118 or the matrix barcode tag 124 may enable a user of another electronic device 10, such as the handheld device 40, to obtain control information associated with the DVR 607.

With continued reference to FIG. 46, in the control initiation operation 606, a user may tap the handheld device 40 or another controlling device 92 against the NFC interface 34 of the DVR 607. Tapping the NFC interfaces 34 together may cause the NFC communication channel 96 to become established between the two devices. Through the NFC communication channel 96, control information may be exchanged in the manner described above. Accordingly, the handheld device 40 may determine that the DVR 607 may be controlled and may issue a prompt for the user to initiate control.

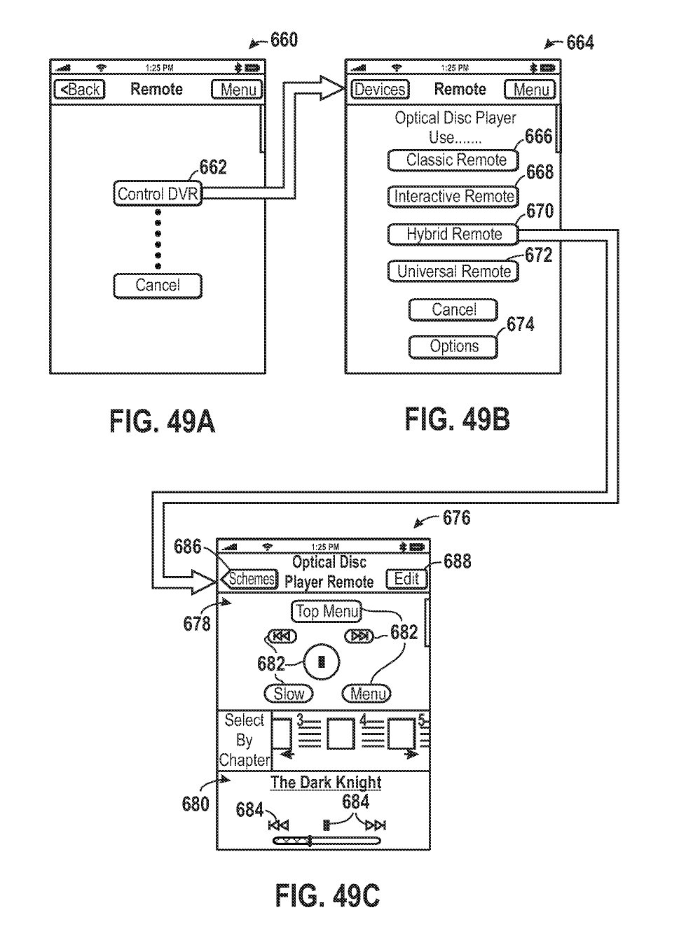

FIGS. 47A-D represent screens that may be displayed on the handheld device 40 following the operation 606 above. Turning first to FIG. 47A, a screen 616 may represent a prompt that may be displayed on the handheld device 40, providing a button 618 labeled, “Control DVR”. The screen 616 may thus prompt the user to launch the device control application for the purpose of controlling the DVR 607. It should be appreciated that the screens of FIGS. 47A-D presume that the DVR 607 has already been added as a device that may be controlled from the handheld device 40, according to the techniques described above.

Turning to FIG. 47B, a screen 620 may be displayed on the handheld device 40 when the button 618, labeled “Control DVR,” is selected by the user. The screen 620 may include a variety of user-selectable buttons, each of which may enable the user to control the DVR 607 using a specific remote control scheme. Particularly, a button 622, labeled “Classic Remote,” may allow a user to control the DVR 607 using a traditional remote control, as may be associated with the device from its manufacturer. By way of example, in the manner described above, the manufacturer of the DVR 607 may provide a software copy of the traditional remote control in the control software plug-in to enable the user to control the DVR 607 in the same manner on the handheld device 40 as with a physical traditional remote.

A button 624, labeled “Media Remote,” may allow a user to control the DVR 607 and may include additional information. The additional information may include, for example, a program title, information regarding the currently playing program, a channel that the DVR 607 may be recording, or other information traditionally not available on a remote control. A button 626, labeled “Hybrid Remote,” may enable a user to control the DVR 607 using a combination of elements from the classic remote accessible via the button 622 and the media remote available via the button 624. A button 628, labeled “Universal Remote,” may allow a user to control the DVR 607 using a customized universal remote, which may include the ability to control a variety of devices in addition to the DVR 607. A button 630, labeled “Options,” may allow a user to vary certain options, such as whether to display only remote control schemes provided by the manufacturer of the DVR 607 or by other developers, as well as whether to automatically update the control software plug-in. Among other options available via the button 630 may be a preferred remote which may be automatically loaded when the button 618 is selected or when the control initiation operation 606 is undertaken

FIG. 47C represents a screen 632 that may be displayed when a user selects, for example, the button 626, labeled “Hybrid Remote.” The screen 632 may thus include a classic remote pane 634 and a media remote pane 636. The classic remote pane 634 may include a variety of classic buttons 637. By way of example, the classic buttons 637 may be buttons that may be found on the traditional remote control associated with the DVR 607, such as volume up/down, menu, information, select, channel up/down, recorded programs, interactive TV, and record. The media remote pane 636 may include text describing the program currently being played by the DVR 607, and may additionally include media buttons 638. The media button 638 may provide, for example, fast forward, pause, play, rewind, etc. to manipulate the replay of the selected program.

A title bar across the top portion of the screen 632 may appear when a user presses a finger near the top of the screen. The title bar may include, for example, a button 640, labeled “Scheme.” Pressing or selecting the button 640 may allow the user to return to the screen 620 to select a different control scheme to control the DVR 607. A button 642, labeled “Edit,” may enable a user to add or remove the buttons that appear on the screen 632.

Turning to FIG. 47D, the handheld device 40 may display a screen 644 when the button 642, labeled “Edit,” is selected. The screen 644 may display the features of the screen 632, but may additionally include remove buttons 646, which may enable a user to delete existing remote control buttons 637 on the screen 644. By way of example, selecting one of the buttons 646 may cause the associated classic button 637 to be removed from the screen 632 above. Additionally, unused buttons 648, which may not be displayed on the remote control screen 632, may appear associated with an add button 650 on the screen 644. Selecting the add button 650 associated with the unused button 648 may cause the unused button 648 to appear on the screen 632 after a user selects the button 642, which may now be labeled “Done.”

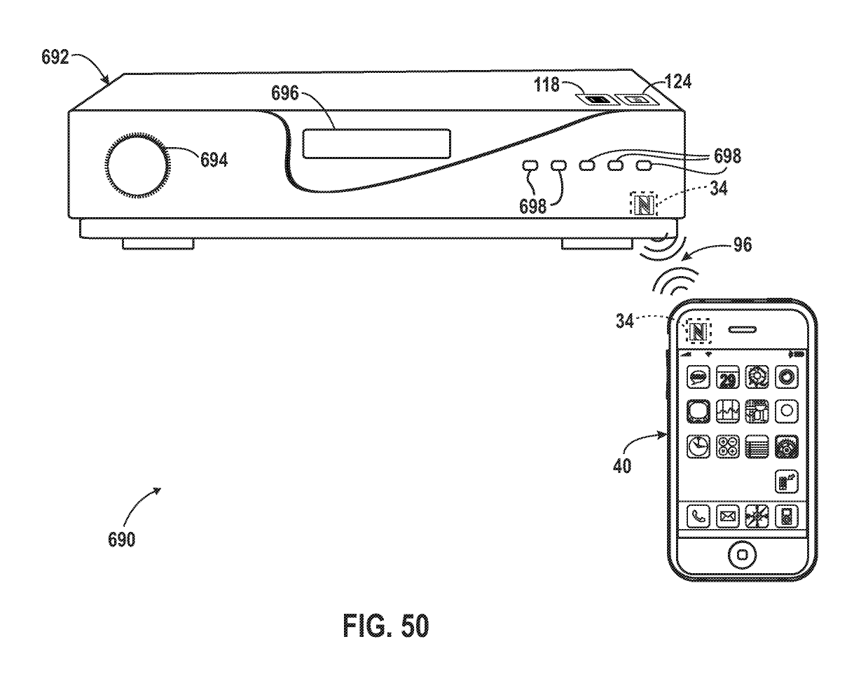

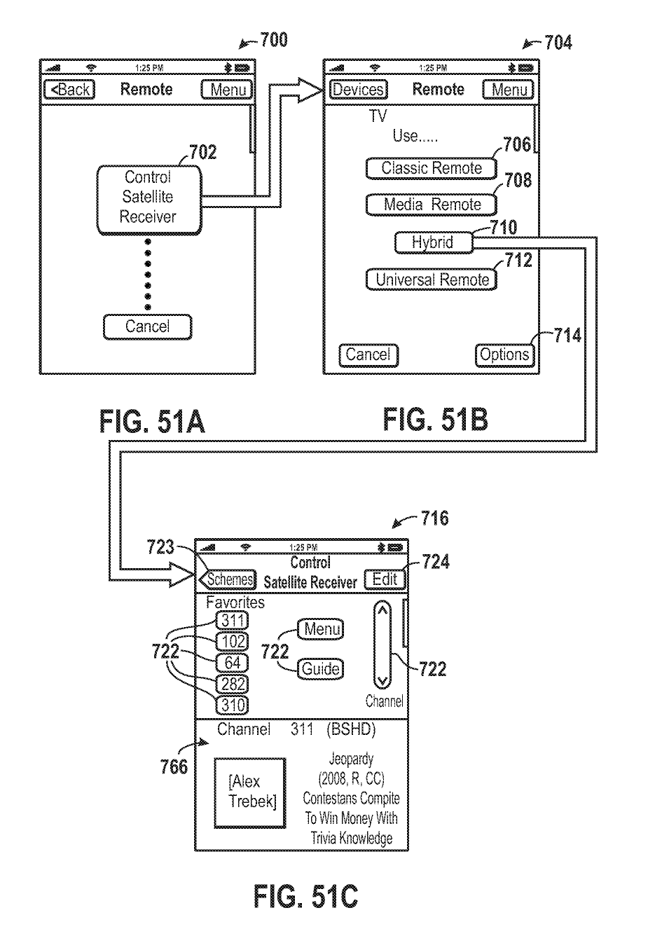

FIGS. 48-49 relate to controlling an optical disc player using another electronic device 10 such as the handheld device 40. Turning first to FIG. 48, a control initiation operation 652 may take place between the handheld device 40 and an optical disc player 654, which may represent an embodiment of the electronic device 10 of FIG. 1. The optical disc player 654 may include an optical disc drive 656, which may be configured to read optical discs such as digital video discs (DVD) or Blu-Ray® discs, and may output the video obtained from the optical disc drive 656 to an analog or digital television or other display. Status indicator lights 658 may appear on the face of the optical disc player 654 to indicate, for example, whether the device is on or off or responding to a control stream from a controlling device 92. As should be appreciated, the optical disc player 654 may be capable of interfacing with another electronic device 10, such as the handheld device 40, through such means as the infrared interface 25 or the network interfaces 26.

The optical disc player 654 may or may not include the NFC interface 34. If the NFC 34 is present, a user may tap the handheld device 40 to the NFC interface 34 of the optical disc player 654 to create an NFC communication channel 96. Various control information may be transferred across the NFC communication channel 96 according to the techniques described above. If the NFC interface 34 is not present, the optical disc player 654 may include an RFID tag 118 or a matrix barcode 124, either of which may be used by the handheld device 40 to initiate control using the techniques described above.

FIGS. 49A-C represent screens that may be displayed on the handheld device 40 following the operation 652 above. Turning first to FIG. 49A, a screen 660 may represent a prompt that may be displayed on the handheld device 40, providing a button 662 labeled, “Control Optical Disc Player.” The screen 660 may thus prompt the user to launch the device control application for the purpose of controlling the optical disc player 654. It should be appreciated that the screens of FIGS. 49A-C presume that the optical disc player 654 has already been added as a device that may be controlled from the handheld device 40, according to the techniques described above.

Turning to FIG. 49B, a screen 664 may be displayed on the handheld device 40 when the button 662, labeled “Control Optical Disc Player,” is selected by the user. The screen 664 may include a variety of user-selectable buttons, each of which may enable the user to control the optical disc player 654 using a specific remote control scheme. The variety of user-selectable buttons of the screen 664 may enable the user to control the optical disc player 654 in much the same manner as the DVR 607. Particularly, a button 666, labeled “Classic Remote,” may allow a user to control the optical disc player 654 using a traditional remote control, as may be associated with the device from its manufacturer. By way of example, in the manner described above, the manufacturer of the optical disc player 654 may provide a software copy of the traditional remote control in the control software plug-in to enable the user to control the optical disc player 654 in the same manner on the handheld device 40 as with a physical traditional remote.

A button 668, labeled “Interactive Remote,” may allow a user to control the optical disc player 654 and may include additional functionality. The additional functionality may include, for example, display of a program title, display of information regarding the currently playing disc, a capability to select a chapter of the disc, or other information traditionally not available on a remote control. A button 670, labeled “Hybrid Remote,” may enable a user to control the optical disc player 654 using a combination of elements from the classic remote accessible via the button 666 and the interactive remote available via the button 668. A button 672, labeled “Universal Remote,” may allow a user to control the optical disc player 654 using a customized universal remote, which may include the ability to control a variety of devices in addition to the optical disc player 654. A button 674, labeled “Options,” may allow a user to vary certain options, such as whether to display only remote control schemes provided by the manufacturer of the optical disc player 654 or by other developers, as well as whether to automatically update the control software plug-in. Among other options available via the button 674 may be a preferred remote which may be automatically loaded when the button 662 is selected or when the control initiation operation 652 is undertaken.

FIG. 49C represents a screen 676 that may be displayed when a user selects, for example, the button 670, labeled “Hybrid Remote.” The screen 676 may thus include a classic remote pane 678 and an interactive remote pane 680. The classic remote pane 678 may include a variety of classic buttons 682. By way of example, the classic buttons 682 may be buttons that may be found on the traditional remote control associated with the optical disc player 654, such as menu, top menu, chapter forward, chapter backward, play/pause, and/or slow. The interactive remote pane 680 may include text describing the disc currently being played by the optical disc player 654 and/or an ability to select a chapter of the disc. Additionally, the interactive remote pane 680 may include interactive buttons 684. The interactive buttons 684 may provide, for example, fast forward, pause, play, rewind, etc. to manipulate the replay of the disc in the optical disc player 654.

A title bar across the top portion of the screen 676 may appear when a user presses a finger near the top of the screen. The title bar may include, for example, a button 686, labeled “Scheme.” Pressing or selecting the button 686 may allow the user to return to the screen 664 to select a different control scheme for control of the optical disc player 654. A button 688, labeled “Edit,” may enable a user to add or remove the buttons that appear on the screen 632. The editing procedure enabled by selecting the button 688 may be generally described above with reference to FIG. 47D.

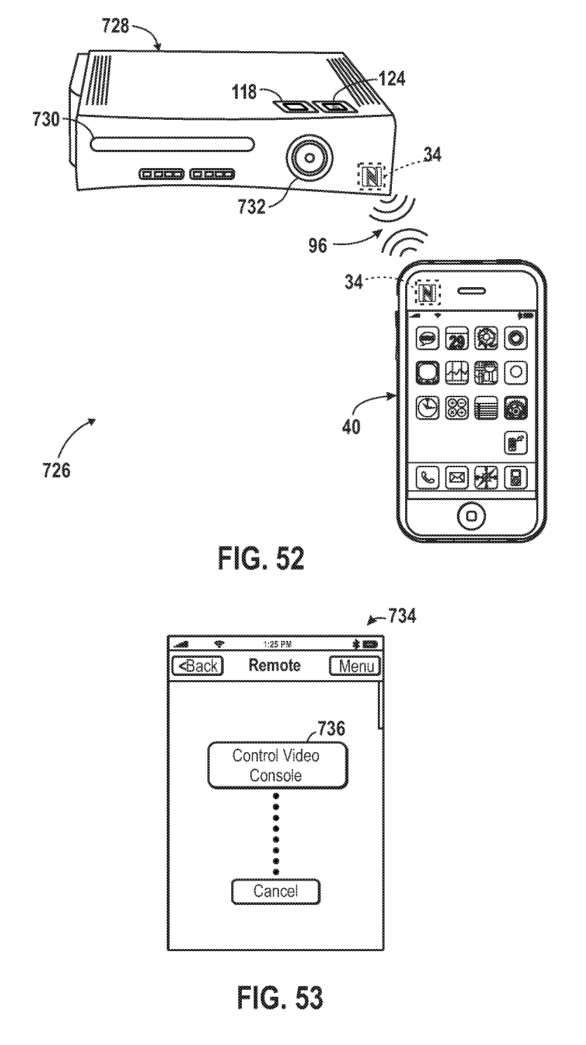

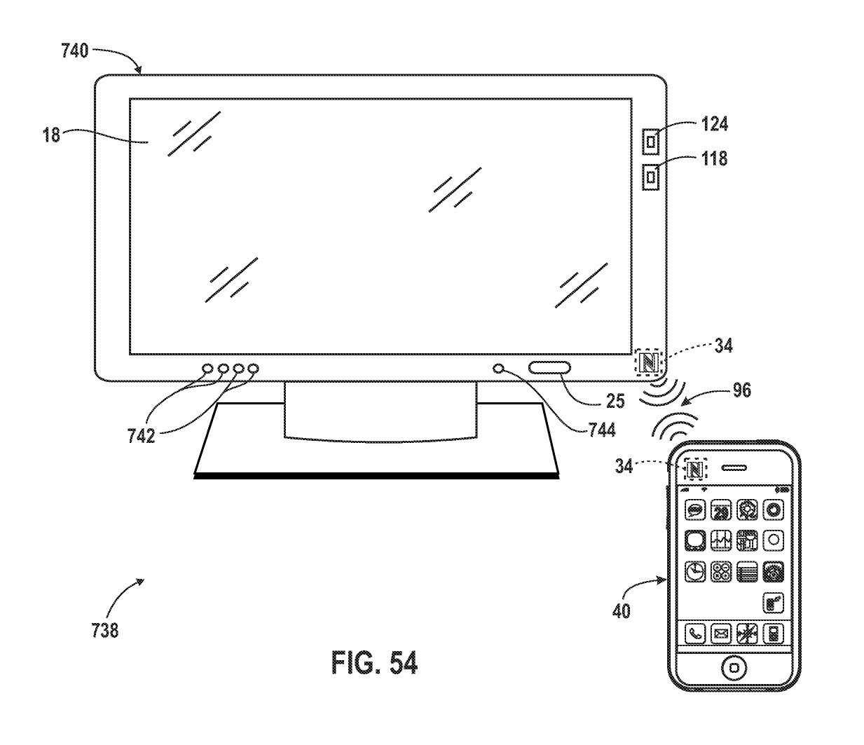

FIGS. 50-51 relate to controlling a cable or satellite TV receiver using another electronic device 10, such as the handheld device 40. Turning first to FIG. 50, a control initiation operation 690 may take place between the handheld device 40 and a cable or satellite TV receiver 692, which may represent an embodiment of the electronic device 10 of FIG. 1. The cable or satellite TV receiver 692 may include internal circuitry configured to decode a cable or satellite TV signal, and may output the audiovisual data obtained from the decoded signal to an analog or digital television or other display. A digital dial 694, display screen 696, and/or user-selectable buttons 698 may appear on the face of the cable or satellite TV receiver 692 to indicate, for example, whether the device is on or off or responding to a control stream from a controlling device 92 and to enable the user to select a channel, volume, menu, or other capabilities of the cable or satellite TV receiver 692. As should be appreciated, the cable or satellite TV receiver 692 may be capable of interfacing with another electronic device 10, such as the handheld device 40, through such means as the infrared interface 25 or the network interfaces 26.

The cable or satellite TV receiver 692 may or may not include the NFC interface 34. If the NFC 34 is present, a user may tap the handheld device 40 to the NFC interface 34 of the cable or satellite TV receiver 692 to create an NFC communication channel 96. Various control information may be transferred across the NFC communication channel 96 according to the techniques described above. If the NFC interface 34 is not present, the cable or satellite TV receiver 692 may include an RFID tag 118 or a matrix barcode tag 124, either of which may be used by the handheld device 40 to initiate control using the techniques described above.

FIGS. 51A-C represent screens that may be displayed on the handheld device 40 following the operation 690 above. Turning first to FIG. 51A, a screen 700 may represent a prompt that may be displayed on the handheld device 40, providing a button 702 labeled, “Control Satellite Receiver.” The screen 700 may thus prompt the user to launch the device control application for the purpose of controlling the cable or satellite TV receiver 692. It should be appreciated that the screens of FIGS. 51A-C presume that the cable or satellite TV receiver 692 has already been added as a device that may be controlled from the handheld device 40, according to the techniques described above.

Turning to FIG. 51B, a screen 704 may be displayed on the handheld device 40 when the button 702, labeled “Control Satellite Receiver,” is selected by the user. The screen 704 may include a variety of user-selectable buttons, each of which may enable the user to control the cable or satellite TV receiver 692 using a specific remote control scheme. The variety of user-selectable buttons of the screen 704 may enable the user to control the cable or satellite TV receiver 692 in much the same manner as the DVR 607. Particularly, a button 706, labeled “Classic Remote,” may allow a user to control the cable or satellite TV receiver 692 using a traditional remote control, as may be associated with the device from its manufacturer. By way of example, in the manner described above, the manufacturer of the cable or satellite TV receiver 692 may provide a software copy of the traditional remote control in the control software plug-in to enable the user to control the cable or satellite TV receiver 692 in the same manner on the handheld device 40 as with a physical traditional remote.

A button 708, labeled “Media Remote,” may allow a user to control the cable or satellite TV receiver 692 with additional functionality. The additional functionality may include, for example, display of a channel number and/or affiliated network and/or display of information regarding a currently playing television program, as well as other information traditionally not available on a remote control. A button 710, labeled “Hybrid,” may enable a user to control the cable or satellite TV receiver 692 using a combination of elements from the classic remote accessible via the button 706 and the media remote available via the button 708. A button 712, labeled “Universal Remote,” may allow a user to control the cable or satellite TV receiver 692 using a customized universal remote, which may include the ability to control a variety of devices in addition to the cable or satellite TV receiver 692. A button 714, labeled “Options,” may allow a user to vary certain options, such as whether to display only remote control schemes provided by the manufacturer of the cable or satellite TV receiver 692 or by other developers, as well as whether to automatically update the control software plug-in. Among other options available via the button 674 may be a preferred remote which may be automatically loaded when the button 702 is selected or when the control initiation operation 690 is undertaken.

FIG. 51C represents a screen 716 that may be displayed when a user selects, for example, the button 710, labeled “Hybrid Remote.” The screen 716 may thus include a classic remote pane 718 and a media remote pane 720. The classic remote pane 718 may include a variety of classic buttons 722. By way of example, the classic buttons 722 may be buttons that may be found on the traditional remote control associated with the cable or satellite TV receiver 692, such as channel up/down, menu, guide, and/or a series of favorite channels. The media remote pane 720 may include text describing the channel currently being displayed by the cable or satellite TV receiver 692 and/or information regarding a currently playing program.

A title bar across the top portion of the screen 716 may appear when a user presses a finger near the top of the screen. The title bar may include, for example, a button 723, labeled “Scheme.” Pressing or selecting the button 723 may allow the user to return to the screen 704 to select a different control scheme for control of the cable or satellite TV receiver 692. A button 724, labeled “Edit,” may enable a user to add or remove the buttons that appear on the screen 716. The editing procedure enabled by selecting the button 724 may be generally described above with reference to FIG. 47D.

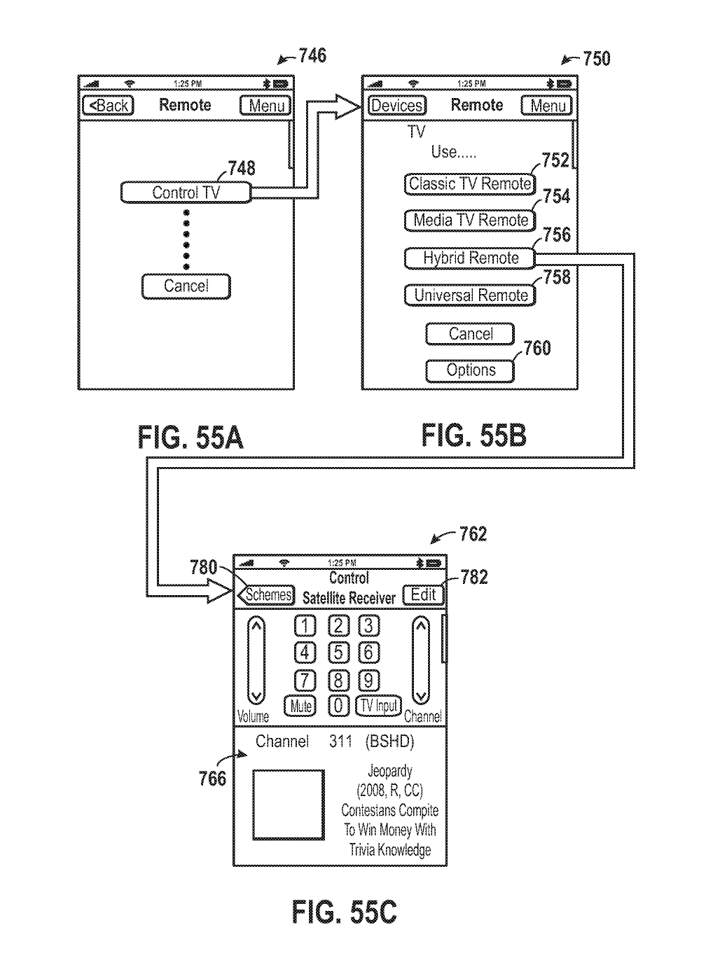

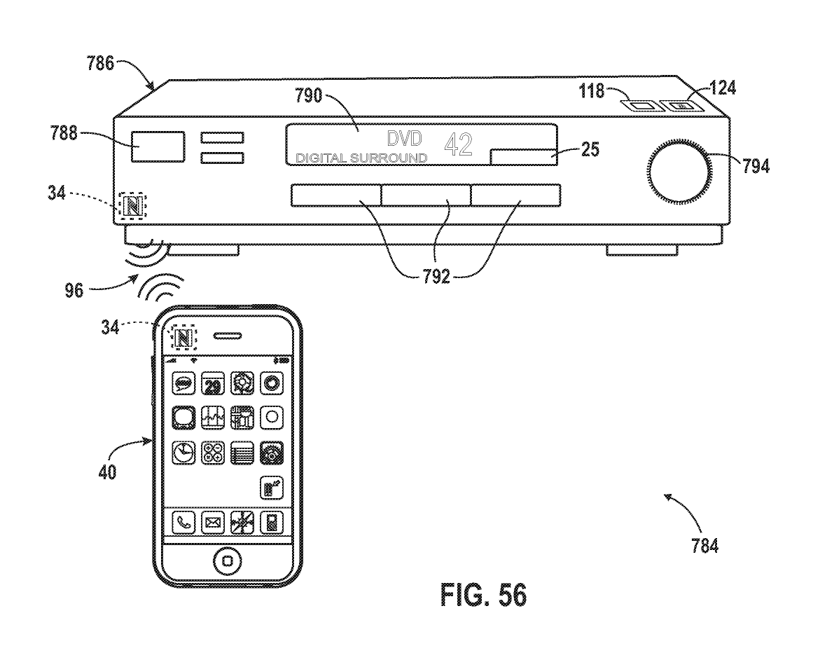

FIGS. 52-53 relate to controlling a video game system using another electronic device 10, such as the handheld device 40. Turning first to FIG. 52, a control initiation operation 726 may take place between the handheld device 40 and a video game system 728, which may represent an embodiment of the electronic device 10 of FIG. 1. By way of example, the video game system 728 may be a PlayStation 3 by Sony or an Xbox360 by Microsoft configured to provide control information to and/or to be controlled by another electronic device 10 according to the techniques described herein. The video game system 728 may include an optical disc drive 730, which may be configured to read optical discs such as digital video discs (DVD) or Blu-ray® discs storing video game software, and may process and output the data obtained from the optical disc drive 656 to an analog or digital television or other display. Status indicator lights 732 may appear on the face of the video game system 728 to indicate, for example, whether the device is on or off or responding to a control stream from a controlling device 92. As should be appreciated, the video game system 728 may be capable of interfacing with another electronic device 10, such as the handheld device 40, through such means as the infrared interface 25 or the network interfaces 26.

The video game system 728 may or may not include the NFC interface 34. If the NFC interface 34 is present, a user may tap the handheld device 40 to the NFC interface 34 of the video game system 728 to create an NFC communication channel 96. Various control information may be transferred across the NFC communication channel 96 according to the techniques described above. If the NFC interface 34 is not present, the video game system 728 may include an RFID tag 118 or a matrix barcode tag 124, either of which may be used by the handheld device 40 to initiate control using the techniques described above.

FIG. 53 represents a screen 734 that may be displayed on the handheld device 40 following the operation 726 above. The screen 734 may represent a prompt that may be displayed on the handheld device 40, providing a button 736 labeled, “Control Videogame Console.” The screen 734 may thus prompt the user to launch the device control application for the purpose of controlling the video game system 728. Accordingly, it should be understood that the control schemes described above with reference to FIGS. 45A-C may be employed following the selection of the button 736.

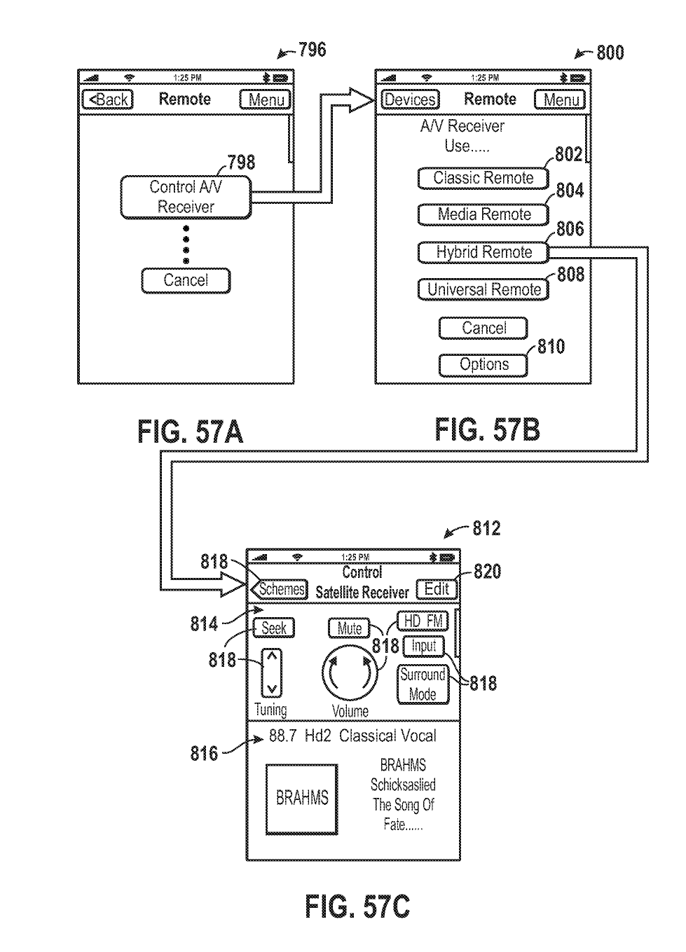

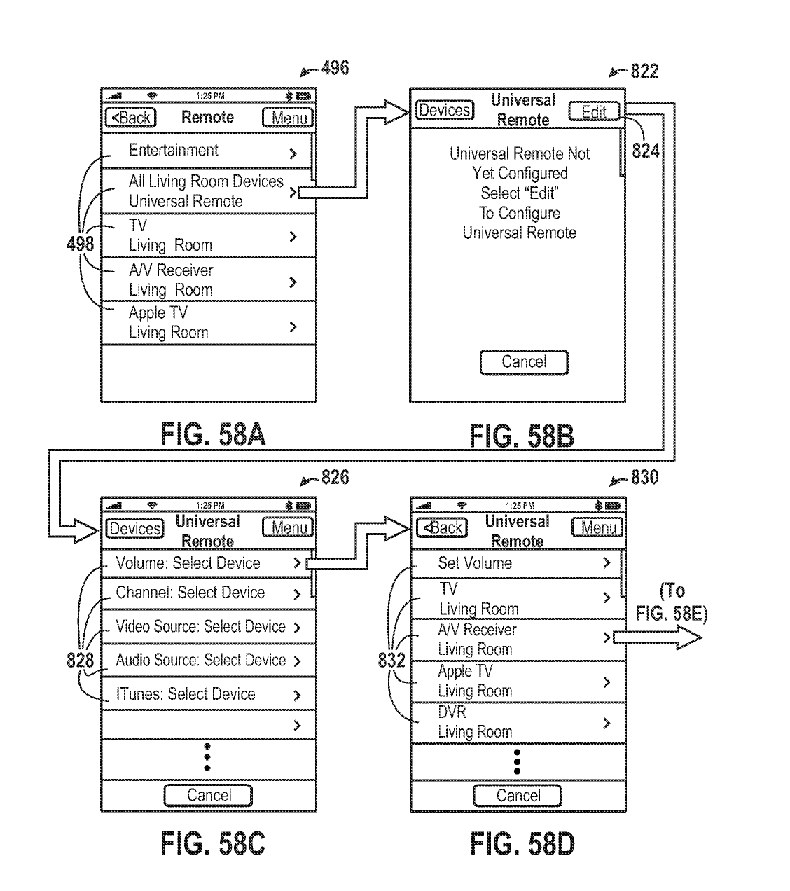

FIGS. 54-55 relate to controlling a digital or analog television using another electronic device 10, such as the handheld device 40. Turning first to FIG. 54, a control initiation operation 738 may take place between the handheld device 40 and a digital or analog television 740, which may represent an embodiment of the electronic device 10 of FIG. 1. The digital or analog television 740 may include internal circuitry configured to decode a cable or satellite TV signal or a digital broadcast signal, and may output the audiovisual data obtained from the decoded signal to a display 18. A series of user-selectable buttons 742 and/or an indicator light 744 may appear on the face of the digital or analog television 740 to indicate, for example, whether the device is on or off or responding to a control stream from a controlling device 92, as well as to enable the user to select a channel, volume, menu, or other capabilities of the digital or analog television 740. As should be appreciated, the digital or analog television 740 may be capable of interfacing with another electronic device 10, such as the handheld device 40, through such means as the infrared interface 25 or the network interfaces 26.

The digital or analog television 740 may or may not include the NFC interface 34. If the NFC 34 is present, a user may tap the handheld device 40 to the NFC interface 34 of the digital or analog television 740 to create an NFC communication channel 96. Various control information may be transferred across the NFC communication channel 96 according to the techniques described above. If the NFC interface 34 is not present, the digital or analog television 740 may include an RFID tag 118 or a matrix barcode tag 124, either of which may be used by the handheld device 40 to initiate control using the techniques described above.

FIGS. 55A-C represent screens that may be displayed on the handheld device 40 following the operation 738 above. Turning first to FIG. 51A, a screen 746 may represent a prompt that may be displayed on the handheld device 40, providing a button 748 labeled, “Control TV.” The screen 746 may thus prompt the user to launch the device control application for the purpose of controlling the digital or analog television 740. It should be appreciated that the screens of FIGS. 55A-C presume that the digital or analog television 740 has already been added as a device that may be controlled from the handheld device 40, in accordance with techniques described above.

Turning to FIG. 55B, a screen 750 may be displayed on the handheld device 40 when the button 748, labeled “Control TV,” is selected by the user. The screen 750 may include a variety of user-selectable buttons, each of which may enable the user to control the digital or analog television 740 using a specific remote control scheme. The variety of user-selectable buttons of the screen 750 may enable the user to control the digital or analog television 740 in much the same manner as the DVR 607. Particularly, a button 752, labeled “Classic Remote,” may allow a user to control the digital or analog television 740 using a traditional remote control, as may be associated with the device from its manufacturer. By way of example, in the manner described above, the manufacturer of the digital or analog television 740 may provide a software copy of the traditional remote control in the control software plug-in to enable the user to control the digital or analog television 740 in the same manner on the handheld device 40 as with a physical traditional remote.

A button 754, labeled “Media Remote,” may allow a user to control the digital or analog television 740 with additional functionality. The additional functionality may include, for example, display of a channel number and/or affiliated network and/or display of information regarding a currently playing television program, as well as other information traditionally not available on a remote control. A button 756, labeled “Hybrid,” may enable a user to control the digital or analog television 740 using a combination of elements from the classic remote accessible via the button 752 and the media remote available via the button 754. A button 758, labeled “Universal Remote,” may allow a user to control the digital or analog television 740 using a customized universal remote, which may include the ability to control a variety of devices in addition to the digital or analog television 740. A button 760, labeled “Options,” may allow a user to vary certain options, such as whether to display only remote control schemes provided by the manufacturer of the digital or analog television 740 or by other developers, as well as whether to automatically update the control software plug-in. Among other options available via the button 760 may be a preferred remote which may be automatically loaded when the button 748 is selected or when the control initiation operation 738 is undertaken.

FIG. 55C represents a screen 762 that may be displayed when a user selects, for example, the button 756, labeled “Hybrid Remote.” The screen 762 may thus include a classic remote pane 764 and a media remote pane 766. The classic remote pane 764 may include a variety of classic buttons 722. By way of example, the classic buttons 722 may be buttons that may be found on the traditional remote control associated with the digital or analog television 740, such as channel up/down, volume up/down, mute, TV input, and/or a numerical keypad to manually select a channel by number. The media remote pane 766 may include text describing the channel currently being displayed by the digital or analog television 740 and/or information regarding a currently playing program.

A title bar across the top portion of the screen 762 may appear when a user presses a finger near the top of the screen. The title bar may include, for example, a button 780, labeled “Scheme.” Pressing or selecting the button 780 may allow the user to return to the screen 750 to select a different control scheme for control of the digital or analog television 740. A button 782, labeled “Edit,” may enable a user to add or remove the buttons that appear on the screen 762. The editing procedure enabled by selecting the button 782 may be generally described above with reference to FIG. 47D.

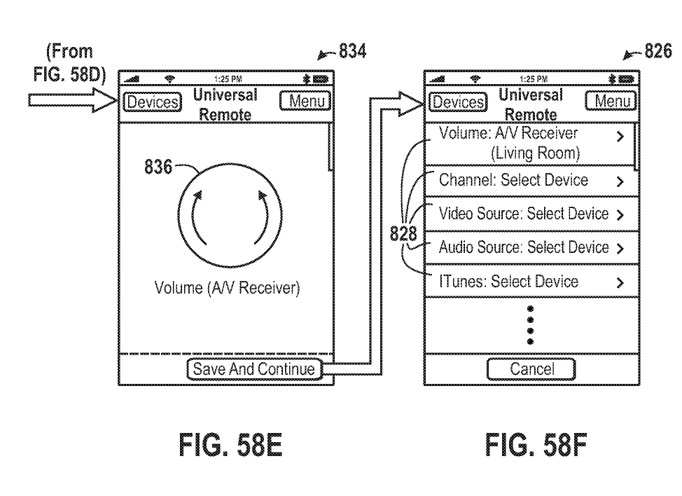

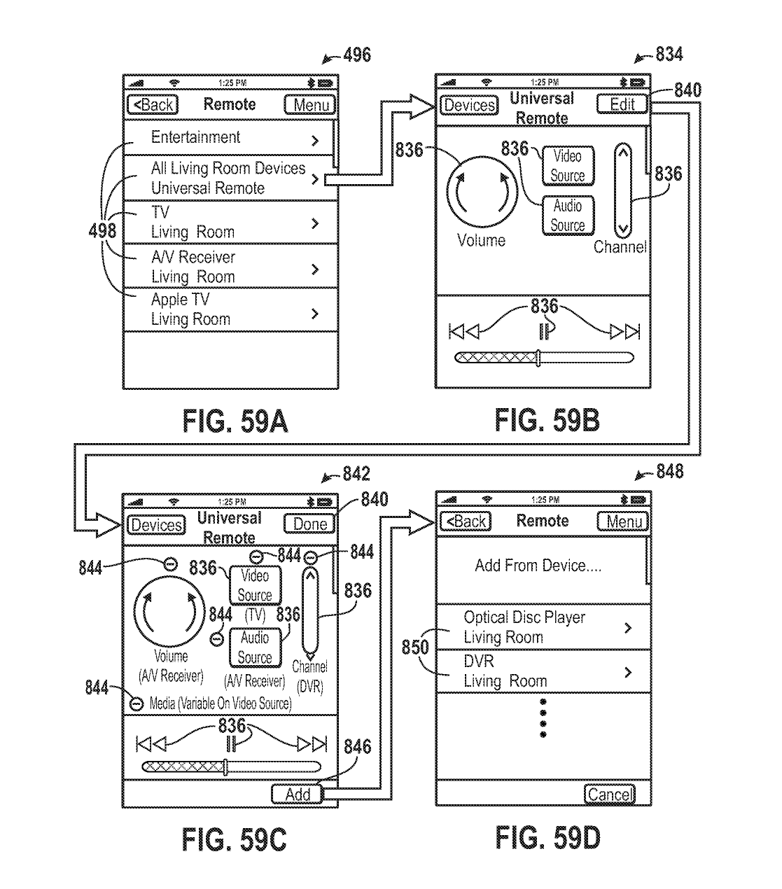

FIGS. 56-57 relate to controlling a home theater receiver using another electronic device 10, such as the handheld device 40. Turning first to FIG. 56, a control initiation operation 784 may take place between the handheld device 40 and home theater receiver 786, which may represent an embodiment of the electronic device 10 of FIG. 1. The home theater receiver 786 may include internal circuitry configured to receive audiovisual signals from home theater devices, such as the DVR 607, the optical disc player 654, the cable or satellite TV receiver 692, the video game system 728, or the digital or analog television 740. The audiovisual signals may be subsequently processed and output to speakers and/or a display device, such as the digital or analog television 740. A hardware power button 788 may enable the home theater receiver 786 to be switched on or off in hardware, and a display screen 790 may indicate, for example, whether the device is on or off or responding to a control stream from a controlling device 92. User selectable buttons 792 may enable the user to select a device from which to receive an audiovisual signal as well as various audiovisual processing options, while a dial 794 may enable the user to adjust the volume. As should be appreciated, the home theater receiver 786 may be capable of interfacing with another electronic device 10, such as the handheld device 40, through such means as the infrared interface 25 or the network interfaces 26.

The home theater receiver 786 may or may not include the NFC interface 34. If the NFC 34 is present, a user may tap the handheld device 40 to the NFC interface 34 of the home theater receiver 786 to create an NFC communication channel 96. Various control information may be transferred across the NFC communication channel 96 according to the techniques described above. If the NFC interface 34 is not present, the home theater receiver 786 may include an RFID tag 118 or a matrix barcode tag 124, either of which may be used by the handheld device 40 to initiate control using the techniques described above.

FIGS. 57A-C represent screens that may be displayed on the handheld device 40 following the operation 784 above. Turning first to FIG. 57A, a screen 796 may represent a prompt that may be displayed on the handheld device 40, providing a button 798 labeled, “Control A/V Receiver.” The screen 796 may thus prompt the user to launch the device control application for the purpose of controlling the home theater receiver 786. It should be appreciated that the screens of FIGS. 57A-C presume that the home theater receiver 786 has already been added as a device that may be controlled from the handheld device 40, in accordance with techniques described above.

Turning to FIG. 57B, a screen 800 may be displayed on the handheld device 40 when the button 798, labeled “Control A/V Receiver,” is selected by the user. The screen 800 may include a variety of user-selectable buttons, each of which may enable the user to control the home theater receiver 786 using a specific remote control scheme. The variety of user-selectable buttons of the screen 800 may enable the user to control the home theater receiver 786 in much the same manner as the DVR 607. Particularly, a button 802, labeled “Classic Remote,” may allow a user to control the home theater receiver 786 using a traditional remote control, as may be associated with the device from its manufacturer. By way of example, in the manner described above, the manufacturer of the home theater receiver 786 may provide a software copy of the traditional remote control in the control software plug-in to enable the user to control the home theater receiver 786 in the same manner on the handheld device 40 as with a physical traditional remote.

A button 804, labeled “Media Remote,” may allow a user to control the home theater receiver 786 with additional functionality. The additional functionality may include, for example, display of a channel number and/or affiliated network, information regarding a currently playing program, and/or other information traditionally not available on a remote control. A button 806, labeled “Hybrid Remote,” may enable a user to control the home theater receiver 786 using a combination of elements from the classic remote accessible via the button 802 and the media remote available via the button 804. A button 808, labeled “Universal Remote,” may allow a user to control the home theater receiver 786 using a customized universal remote, which may include the ability to control a variety of devices in addition to the home theater receiver 786. A button 810, labeled “Options,” may allow a user to vary certain options, such as whether to display only remote control schemes provided by the manufacturer of the home theater receiver 786 or by other developers, as well as whether to automatically update the control software plug-in. Among other options available via the button 810 may be a preferred remote which may be automatically loaded when the button 798 is selected or when the control initiation operation 784 is undertaken.

FIG. 57C represents a screen 812 that may be displayed when a user selects, for example, the button 806, labeled “Hybrid Remote.” The screen 812 may thus include a classic remote pane 814 and a media remote pane 816. The classic remote pane 814 may include a variety of classic buttons 818. By way of example, the classic buttons 818 may be buttons that may be found on the traditional remote control associated with the home theater receiver 786, such as radio tuning up/down, seek, volume up/down, mute, AM/FM, A/V input, and/or a surround sound processing mode. The media remote pane 816 may include text describing a radio channel currently being displayed by the home theater receiver 786 and/or information regarding currently playing audio.

A title bar across the top portion of the screen 812 may appear when a user presses a finger near the top of the screen. The title bar may include, for example, a button 819, labeled “Scheme.” Pressing or selecting the button 819 may allow the user to return to the screen 800 to select a different control scheme for control of the home theater receiver 786. A button 820, labeled “Edit,” may enable a user to add or remove the buttons that appear on the screen 812. The editing procedure enabled by selecting the button 820 may be generally described above with reference to FIG. 47D.

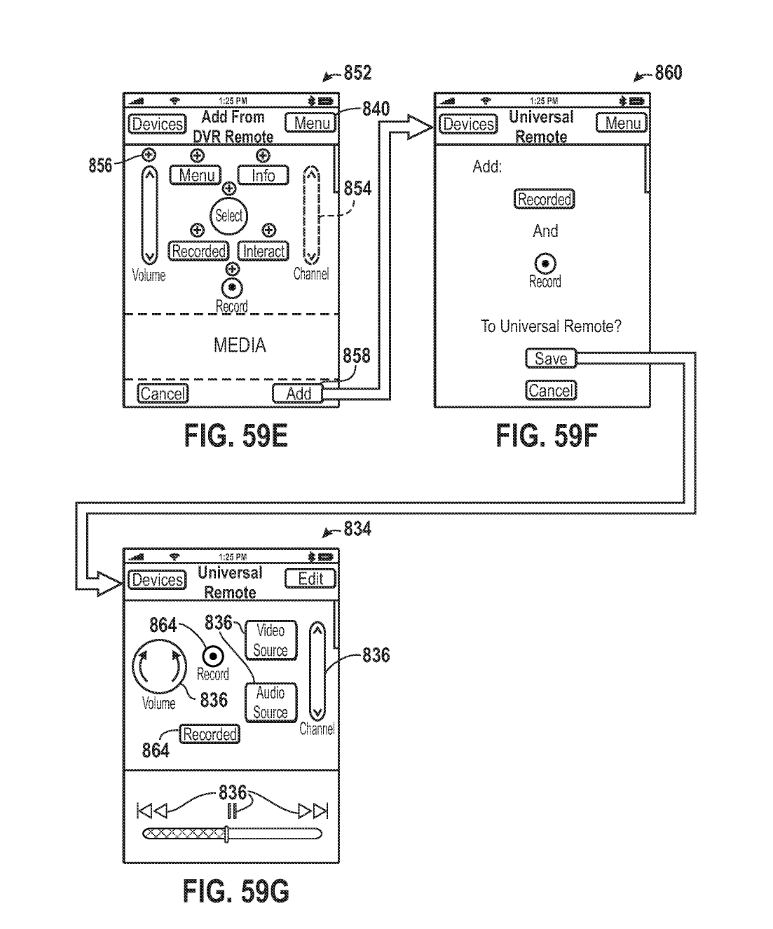

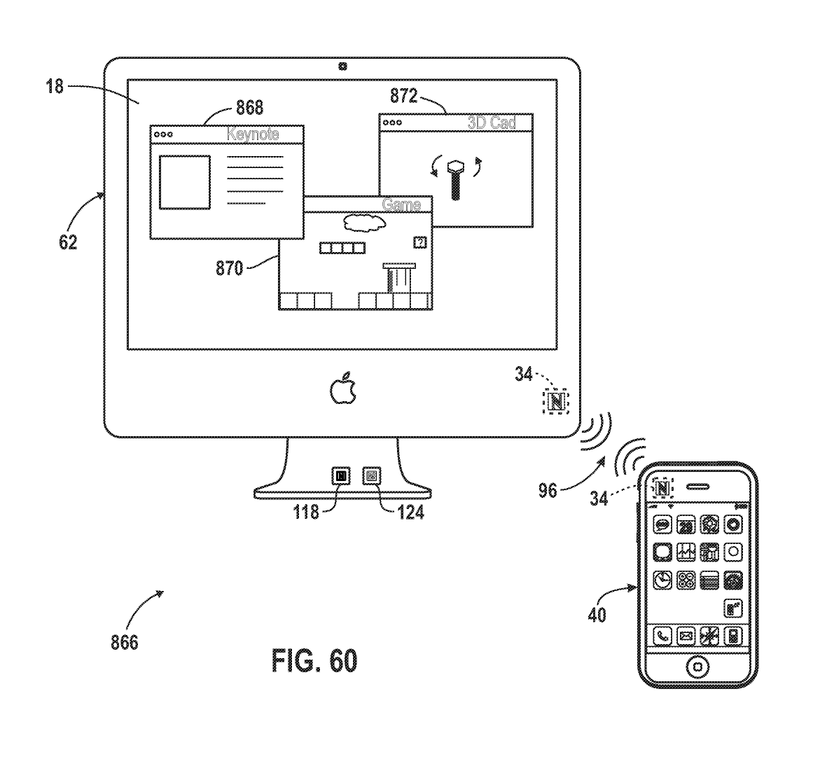

FIGS. 58-59 illustrate the use of the handheld device 40 as a universal remote control based on the techniques described above. As described below, a controlling device 92, such as the handheld device 40, may serve to control more than one device at once by operating in a universal remote control capacity. Particularly, by combining elements of remote control schemes pertaining to different devices, many different devices may be controlled from the same remote control screen.

Turning first to FIG. 58A, a user may select the list item 498, labeled “Universal Remote,” from the screen 496. Alternatively, the user may select the buttons 628, 672, 712, 758, or 808, labeled “Universal Remote” from the screens 620, 664, 704, 750, or 800, respectively. When the universal remote control capabilities have not been configured, the handheld device 40 may display a screen 822, as illustrated by FIG. 58B. The screen 822 may indicate that the universal remote control capabilities have not been configured, and may instruct the user to select a button 824, labeled “Edit,” to configure the universal remote.

Turning the FIG. 58C, a screen 826 may be displayed on the handheld device 40 when the user selects the button 824. The screen 826 may enable the user to configure the universal remote by selecting from a variety of list items 828, which may represent elements of the universal remote control that may be selected from among elements of control schemes for individual devices. Such elements of the universal remote control may include, for example, volume, channel, video source, audio source, media sources, etc., which may be selected from among the other installed devices.

By way of example, a user may elect to configure the volume element of the universal remote control by selecting the first list item 828, labeled “Volume.” The handheld device 40 may accordingly display a screen 830, as illustrated in FIG. 58D. The screen 830 may display a variety of list items 832, which may represent control schemes for installed devices which control volume. A user may select one of the list items 832 to select a control scheme associated with one of the installed devices. For example, if the user controls the volume of a home theater system by changing the volume of the home theater receiver 786, a user may select the list item 832 labeled “A/V Receiver.”

When the list item 832 is selected, the handheld device 40 may display a screen 834, as illustrated in FIG. 58E. The screen 834 may represent the universal remote control, which may now include a button 838 derived from a control scheme associated with the home theater receiver 786. A button 839, labeled “Save and Continue,” may enable the user to save the current settings and continue with the universal remote control configuration procedure. Subsequently, as illustrated by FIG. 58F, when the list item 828 of the screen 826 labeled “Volume” has been configured in the manner described above, the list item 828 may thereafter indicate that the volume of the universal remote is associated with the “A/V Receiver.”

FIGS. 59A-G depict screens that may be displayed on the handheld device 40 when universal remote control capabilities are activated. After the universal remote control has been configured in the manner described above, selecting the list item 498 labeled “Universal Remote,” of the screen 496 may enable a user to access the universal remote from the handheld device 40, as illustrated in FIG. 59A. Turning to FIG. 59B, the screen 834, representing the universal remote control, may include a variety of universal remote control buttons 836, which may include, for example, volume, video source, audio source, channel, and a media pane. A button 840, labeled “Edit,” may enable the user to add or remove buttons 836 from the universal remote control of the screen 834.

Turning to FIG. 59C, when the button 840 is selected, a screen 842 may be displayed on the handheld device 40. The screen 842 may include, for example, remove buttons 844 associated with each of the universal remote control buttons 836. If a user selects one of the remove buttons 844, the button 836 associated with the remove button 844 may be removed from the universal remote control of the screen 834. A button 846 of the screen 842, labeled “Add,” may allow a user to add buttons that may be found from other control schemes that may be stored on the handheld device 40.

FIG. 59D displays a screen 848 that may appear on the handheld device 40 when the button 846 of FIG. 59C is selected. The screen 848 may enable the user to obtain additional remote control buttons from other devices, as indicated by a series of list items 850. If a user selects, for example, the list item 850 labeled “DVR,” the handheld device 40 may display a screen 852, as shown in FIG. 59E. The screen 852 may allow a user to add buttons that are found on a control scheme associated with the DVR 607. As shown in FIG. 59E, a hatched button 854 may represent a button 836 configured for use on the universal remote screen 834. Add buttons 856 may allow the user to select additional buttons from one of the DVR 607 control schemes, such as the hybrid remote of the screen 632. For example, a user may select the add buttons 856 associated with a button labeled “Recorded” and a record button. After selecting buttons to add, a user may select a button 858, labeled “Add,” to add the selected buttons to the universal remote control of the screen 834. Turning to FIG. 59F, a screen 860 may be displayed on the handheld device 40 when the user selects the button 858, labeled “Add.” The screen 860 may prompt the user to save the additional buttons onto the universal remote by way of a button 862, labeled “Save.”

Selecting the button 862, labeled “Save,” may cause the handheld device to display the screen 834 with new buttons 864, in addition to previously existing universal remote buttons 836, as shown in FIG. 59G. The new buttons 864 may thereafter be used to control the DVR 607 from the universal remote control of the screen 834. Thus, in the manner described above, the universal remote control of the screen 834 may be customized by the user to include controls from any control scheme associated with a device that may be controlled from the handheld device 40.

As noted above, FIGS. 60-67 illustrate using the above-described techniques for controlling software on a computer system. FIG. 60 represents a control initiation operation 866 between a handheld device 40 and a computer 62. As shown in FIG. 60, at the outset of the control initiation operation 866, the computer 62 may be running a variety of applications, such as a presentation application 868, such as Keynote® by Apple Inc., a video game program 870, or a 3-D computer aided design (CAD) application 872.

The computer 62 may include the NFC interface 34. If the NFC interface 34 is present, a user may tap the handheld device 40 to the NFC interface 34 of the computer 62 to create an NFC communication channel 96. Various control information may be transferred across the NFC communication channel 96 according to the techniques described above. If the NFC interface 34 is not present, the computer 62 may include an RFID tag 118 or a matrix barcode tag 124, either of which may be used by the handheld device 40 to initiate control using the techniques described above.

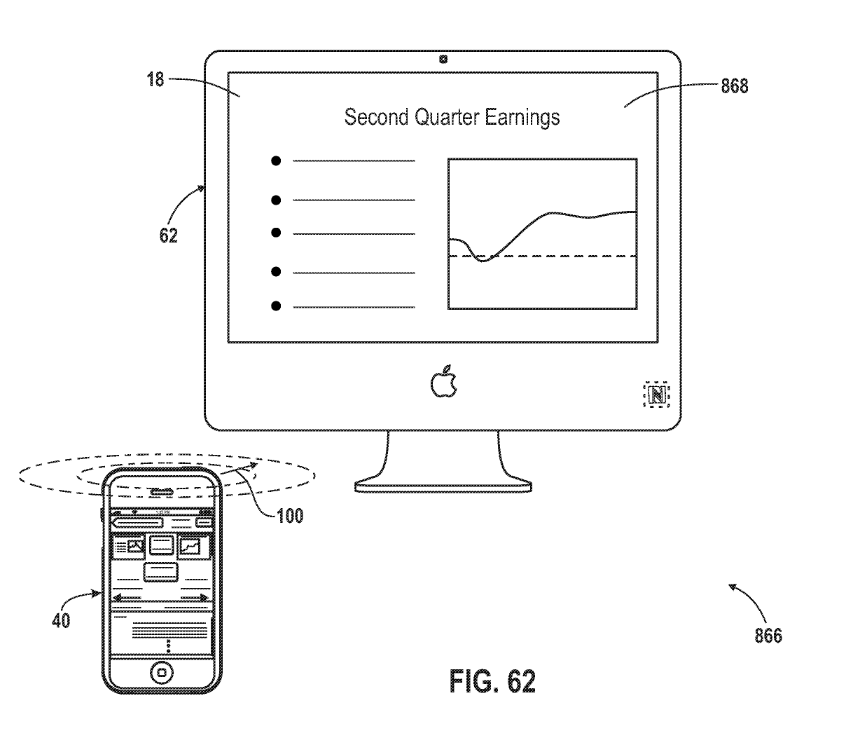

FIGS. 61A-B depict screens that may be displayed on the handheld device 40 for controlling applications on the computer 62; FIG. 61C depicts a screen that may be displayed on the handheld device for controlling applications such as the presentation application 868. Turning first to FIG. 61A, a screen 874 may represent a prompt that may be displayed on the handheld device 40, providing a button 876, labeled “Control iMac (iTunes),” and a button 878, labeled “Control iMac (Other).” The screen 874 may thus prompt the user to launch the device control application for the purpose of controlling the computer 62 to control media via the button 876 or to control other applications via the button 878. It should be appreciated that the screens of FIGS. 61A-C presume that the computer 62 has already been added as a device that may be controlled from the handheld device 40, in accordance with techniques described above.

Turning next to FIG. 61B, a screen 880 may be displayed on the handheld device 40 when the user selects the button 878 of FIG. 61A. The screen 880 may include several list items 882, which may represent features of the computer 62 that may be controlled from the handheld device 40. As illustrated in FIG. 61B, such controllable features may include, for example, the presentation application 868, the video game application 870, the 3-D CAD application 372, a keyboard, mouse, or other peripherals, and/or a web browser such as Safari® by Apple Inc. A button 884, labeled “Options,” may enable the user to vary such options as whether to select a particular feature by default upon selection of the button 878 or upon undertaking the control initiation operation 866, or whether to display the list items 882 in a particular order (e.g., by most used, manual preferences, alphabetical order, etc.).

FIG. 61C illustrates using the handheld device 40 to control the presentation application 868 on the computer 62. A screen 886 may be displayed on the handheld device 40 when the user selects the list item 882 labeled “Keynote Presentation.” The screen 886 may represent a control scheme for controlling the presentation application 868 with such elements as a control pane 888 and a notes pane 890. The control pane 888 may include a button 892 to return to a prior slide of a given presentation displayed by the presentation application 868, a button 894 to advance to a subsequent slide, and/or preference buttons 896 to cause the presentation to be displayed on a full screen or to select a new presentation without disrupting the presentation currently being displayed. The notes pane 890 may display notes 898 associated with each slide from the presentation application 868 on the computer 62. In this way, the user may choose to advance through a presentation and, using notes displayed on the handheld device 40 but not on the computer 62, may discuss each slide of the presentation.

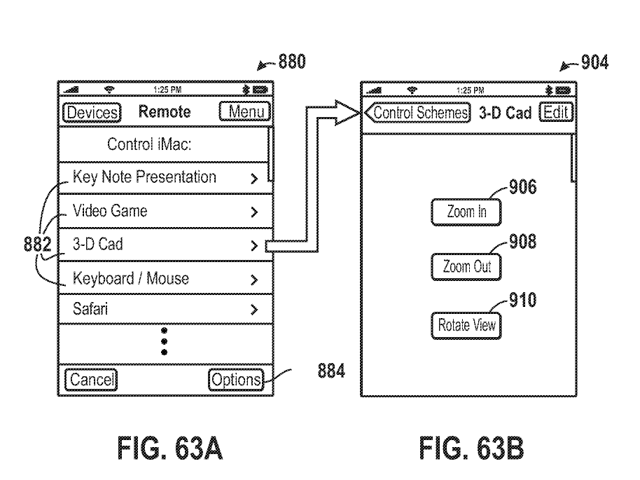

FIG. 62 represents a control operation 902 for controlling the presentation application 868 that may be running on the computer 62 in accordance with the techniques described above. As illustrated, the handheld device 40 may display the screen 886 of FIG. 61C. A user may control the computer 62 by communicating a control stream between the computer 62 and the handheld device 40 via one of the communication channels 90, such as the LAN communication channel 100. The handheld device 40 may switch between slides of the presentation application 868 displayed on the screen 18 of the computer 62. As should be appreciated, the computer 62 may alternatively output the video of the presentation to another display screen 18, such as a television or a video projector.

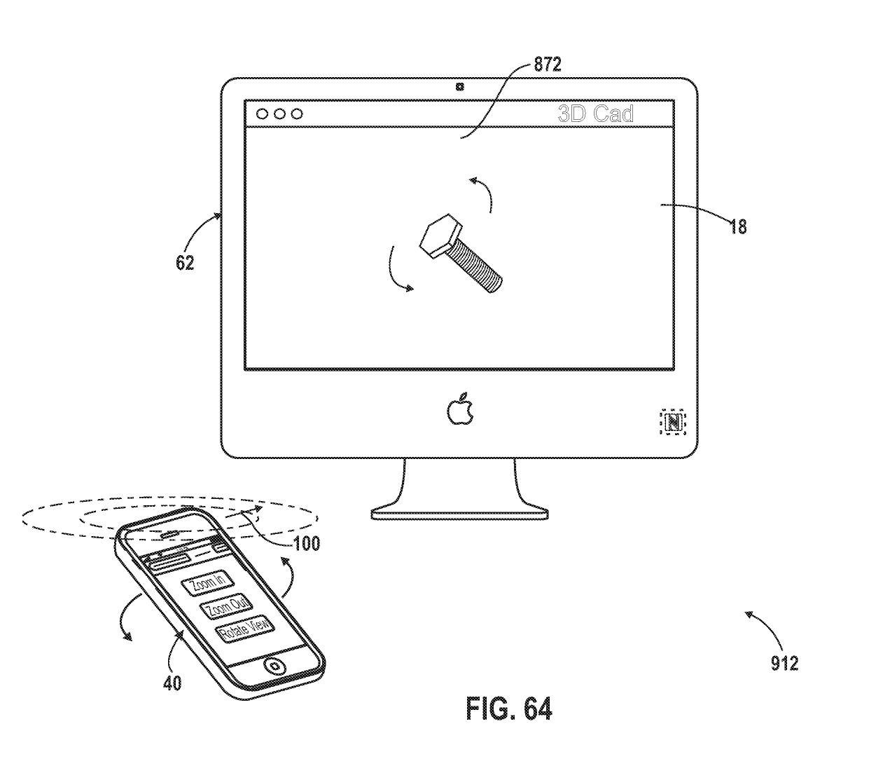

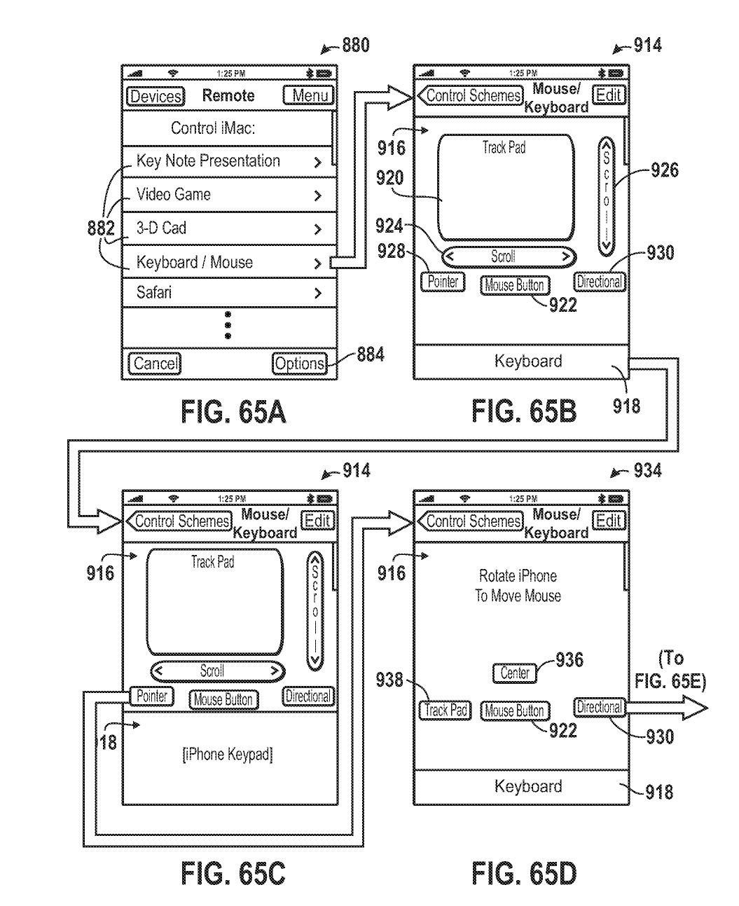

FIGS. 63 and 64 illustrate the use of the handheld device 40 to control the 3-D CAD application 872 that may be running on the computer 62. Turning first to FIG. 63A, selecting the list item 882 of the screen 880 labeled “3-D CAD” may cause the handheld device 40 to display a screen 904, which may be illustrated by FIG. 63B. The screen 904 may represent a control screen for controlling the 3-D CAD application 872 from the handheld device 40. The control screen 904 may include a button 906, labeled “Zoom In,” and a button 908, labeled “Zoom Out.” Selecting the buttons 906 or 908 may cause a three-dimensional image displayed in the 3-D CAD application 872 to be zoomed-in or zoomed-out, respectively. A button 910, labeled “Rotate View,” may allow the user to rotate the view of the image displayed in the 3-D CAD application 872 by rotating the handheld device 40.

As illustrated in FIG. 64, a 3-D CAD control operation 912 may enable a user to control the 3-D CAD application 872 from the handheld device 40. In the operation 912, the handheld device 40 may display the screen 904 of FIG. 63B. Selecting the buttons 906 or 908 may cause a three-dimensional image displayed in the 3-D CAD application 872 to be zoomed-in or zoomed-out, respectively. To rotate the three-dimensional image, the user may select the button 910, labeled “Rotate View.” Next, the user may physically rotate the handheld device 40. The accelerometers 38 of the handheld device 40 may indicate how the handheld device 40 is being rotated and, with such information, the handheld device 40 may cause the 3-D CAD application 872 to rotate the three-dimensional image accordingly. As should be appreciated, the control stream between the handheld device 40 and the computer 62 may take place over any number of communication channels 90, such as the LAN communication channel 100.

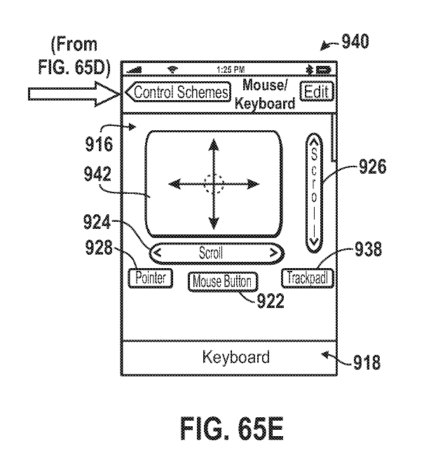

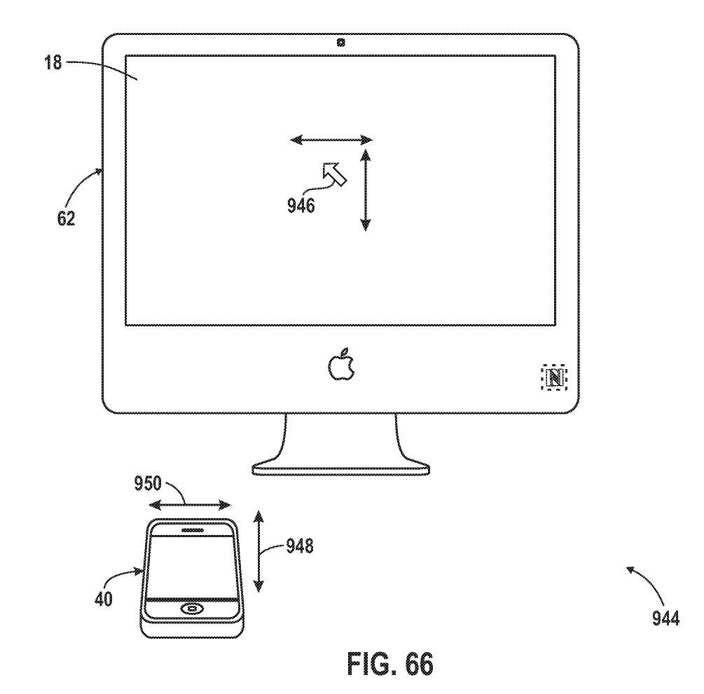

FIGS. 65 and 66 illustrate using the handheld device 40 to control a mouse pointer and/or keyboard on the computer 62. Turning first to FIG. 65A, a user may select the list item 882 labeled “Mouse/Keyboard.” In response, the handheld device 40 may display a screen 914, as shown in FIG. 65B. The screen 914 may include a mouse pane 916 and a keyboard pane 918. The mouse pane 916 may include a variety of elements for controlling a pointer on the computer 62. Such elements may include, for example, a track pad 920, with which a user may drag a finger to change the direction of the mouse or to guide the pointer on the computer 62, and one or more mouse buttons 922 with which may perform in the same manner as a mouse button on an ordinary mouse. Scroll buttons 924 and 926 may allow the user to scroll right and left. Alternative manners of controlling the pointer on the computer 62 may become available by selecting buttons 928 or 930, labeled “Pointer” and “Directional,” respectively.

Turning to FIG. 65C, when a user selects the keyboard pane 918, the screen 914 may display a keypad 932. With the keypad 932, a user may input information onto the computer 62 in the same manner as typing on a peripheral keyboard. If a user selects the button 928, labeled “Pointer,” of the screen 914, the handheld device 40 may display a screen 934, as shown in FIG. 65D. The screen 934 may represent a control scheme that employs rotational capabilities of the handheld device 40 to control the mouse pointer of the computer 62. To start the pointer at the center of the screen, a user may select a button 936, labeled “Center.” As should be appreciated, the button 922, labeled “Mouse Button,” and the button 930, labeled “Direction,” may remain. A new button 938, labeled “Track Pad,” may allow the user to return to the screen 914 of FIG. 65B to use the handheld device 40 as a track pad. As indicated on the screen 934, a user may rotate the handheld device 40 to control the pointer on the computer 62, as described further below.

FIG. 65E represents a screen 940 that may be displayed on the handheld device 40 when the button 930, labeled “Direction,” is selected. The screen 940 represents a directional approach to controlling the pointer, which may function in a manner similar to a track point on a notebook computer. A directional pad 942 may allow a user to move the pointer on the computer 62 in any direction by moving a finger in that direction from the center position of the directional pad 942. As should be appreciated, contact with the directional pad 942 further from the center may cause the pointer to move more rapidly in the direction that is selected. In the manner described above, the screen 940 may further include the scroll buttons 924 and 926 and the mouse button 922. The buttons 928 and 938 may enable a user to control the pointer on the computer 62 using the alternative means described above.

FIG. 66 illustrates a mouse pointer control operation 944. In the control operation 944, the handheld device 40 may be used to control a mouse pointer 946 located on the screen 18 of the computer 62. If the user has selected the button 928, labeled “Pointer,” such that the screen 934 is displayed on the handheld device 40, the user may calibrate the pointer control by pointing the handheld device 40 at the center of the display 18 and pressing the button 936, labeled “Center.” Subsequently, the user may move the handheld device up and down, as generally indicated by the numeral 948, or left and right, as indicated generally by the numeral 950, to cause the pointer 946 to move accordingly.

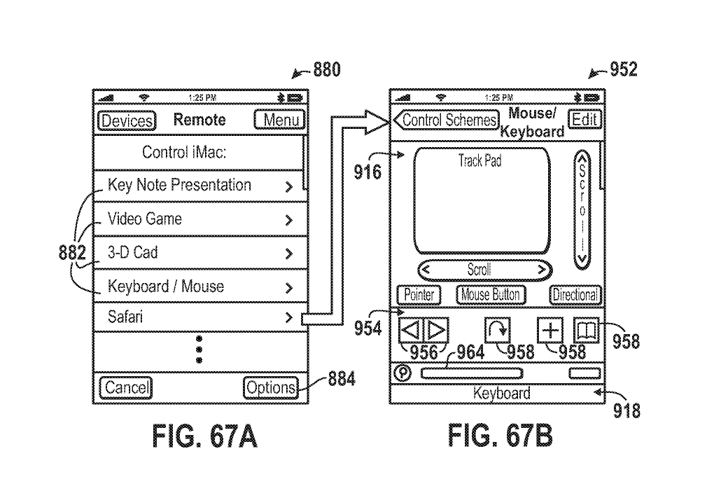

FIGS. 67A-B illustrate using the handheld device 40 to control a web browser, such as Safari® by Apple Inc., that may be running on the computer 62. Turning first to FIG. 67A, a user may select the list item 882, labeled “Safari,” from the screen 880. In response, the handheld device 40 may display a screen 952, as illustrated in FIG. 67B. The screen 952 may represent a control scheme for controlling the web browser that may be running on the computer 62, and may include the pointer panel 916 and the keyboard panel 918 generally associated with control over the mouse pointer. Further, the screen 952 may include a browser panel 954, which may include a variety of buttons specific to controlling a web browser. Such buttons may include front/back buttons 956, a refresh button 958, an add bookmark button 952, and a load bookmark button 960. A URL bar 964 may appear on the screen 952 as well, which may indicate the web page that the web browser is currently displaying.

FIGS. 68-69 illustrate using the handheld device 40 to control a digital projector using the techniques described above. FIG. 68 depicts a control initiation operation 966 for controlling a projector 968 from the handheld device 40. The projector 968 may represent an embodiment of the electronic device 10 having a capability to display video data, which may be received via the I/O interface 24 or other means from a computer 62 or other electronic device 10. The projector 968 may include an optical element 970 for projecting the video data and may be capable of establishing a connection using one of the communication channels 90 as described above with reference to FIG. 7.

The projector 968 may or may not include the NFC interface 34. If the NFC 34 is present, a user may tap the handheld device 40 to the NFC interface 34 of the projector 968 to create an NFC communication channel 96. Various control information may be transferred across the NFC communication channel 96 according to the techniques described above. If the NFC interface 34 is not present, the projector 968 may include an RFID tag 118 or a matrix barcode tag 124, either of which may be used by the handheld device 40 to initiate control using the techniques described above.

FIGS. 69A-B depict screens that may be displayed on the handheld device 40 following the control initiation operation 966. FIG. 69A illustrates a screen 972, which may be displayed on the handheld device 40 as a prompt to a user to control the projector 968. The screen 972 may include a variety of buttons 974, including, for example, a button 974, labeled “Control Projector.” Selecting the button 974 may launch the device control application that may run on the handheld device 40, and a screen 976, as illustrated in FIG. 69B, may be displayed. The screen 976 may include a projector pane 978 and an alternative pane 980. The projector pane 978 may include a variety of buttons 982 for controlling the projector. Such buttons 892 may include, for example, brightness on/off, sleep, source, and/or contrast. The alternative panel 980 may include various elements from other remote controls that may be stored on the handheld device 40. The alternative panel 980 may include, for example, the mouse/keyboard remote control screen 914 of FIG. 65B or the presentation control screen 886 of FIG. 61C.

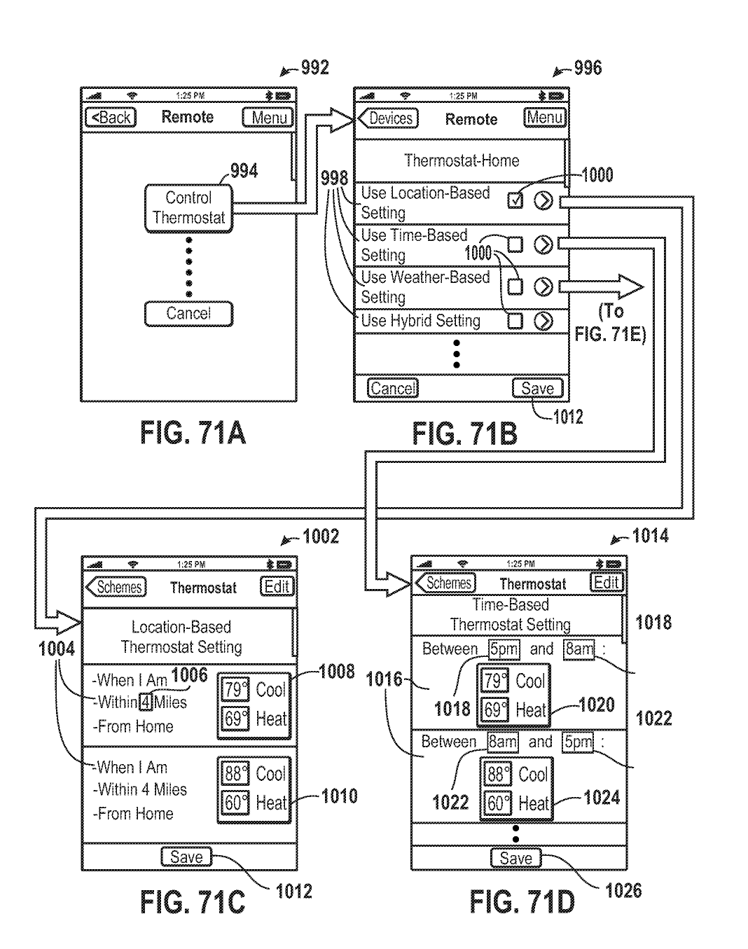

FIGS. 70-79 illustrate using the handheld device 40 for controlling various home utility devices. FIGS. 70-71 illustrate controlling a thermostat for a home heating or cooling system. Turning first to FIG. 70, a control initiation operation 984 illustrates using the handheld device 40 to control a networkable thermostat 986. As illustrated in FIG. 70, the thermostat 986 may represent an embodiment of the electronic device 10, and may include a display screen 988 listing an ambient temperature, a temperature at which the thermostat may initiate a cooling operation, and a temperature at which the thermostat may initiate a heating operation. Buttons 990 may enable manual control over the thermostat 986, and a temperature sensor 991 may sense the ambient temperature.

The thermostat 986 may or may not include the NFC interface 34. If the NFC 34 is present, a user may tap the handheld device 40 to the NFC interface 34 of the thermostat 986 to create an NFC communication channel 96. Various control information may be transferred across the NFC communication channel 96 according to the techniques described above. If the NFC interface 34 is not present, the thermostat 986 may include an RFID tag 118 or a matrix barcode tag 124, either of which may be used by the handheld device 40 to initiate control using the techniques described above.

FIGS. 71A-E represent screens that may be displayed on the handheld device 40 following the operation 984 of the FIG. 70. Turning first to FIG. 71A, a screen 992 may represent a prompt having a button 994, labeled “Control Thermostat.” Selecting the button 994 may cause the handheld device 40 to begin to run the device control application and, more specifically, may cause the handheld device 40 to load a control software plug-in for controlling the thermostat 986 of FIG. 70.

Turning next to FIG. 71B, a screen 996 may be displayed when the button 994, labeled “Control Thermostat,” is selected. The screen 996 may display a list of control schemes for controlling the thermostat 986 and may include, for example, a series of list items 998 representing the various control schemes. Each of the list items 998 may include a corresponding check box 1000, which may enable a user to determine the basis for controlling the thermostat 986. By way of example, as illustrated in FIG. 71B, a user may control the thermostat 986 based on the user's location, based on time, based on weather, as available to the handheld device 40 via a weather application or via the internet, or based on a combination of the above. The settings may be saved using a button 1001, labeled “Save.”

FIG. 71C displays a screen 1002, which may be displayed on the handheld device 40 when the first of the list items 998, labeled “Use Location-Based Settings,” is selected. The screen 1002 may include list items 1004, which may represent settings for controlling the thermostat 986 based on the location of the handheld device 40, as determined by the location-sensing circuitry 22. A distance setting 1006 may allow a user to set a number of miles away from home that a user may be located for a corresponding temperature setting 1008. On the other hand, a temperature setting 1010 may be applied outside of the distance setting 1006. For example, when the handheld device 40 is located within a certain distance of the location of the thermostat 986, as determined by the location sensing circuitry 22, the thermostat 986 may select the temperature settings 1008; otherwise, the thermostat 986 may select the temperature settings 1010. The settings may be saved when a user selects a button 1012, labeled “Save.”

Turning to FIG. 71D, a screen 1014 may be displayed on the handheld device 40 when the second of the list items 998, labeled “Use Time Based Settings,” is selected. The screen 1014 may include list items 1016 for controlling the thermostat 986 based on the time of day. By way of example, the list items 1016 may allow a user to set for a certain bracket of time 1018 a corresponding temperature setting 1020, and for another bracket of time 1022 a corresponding temperature setting 1024. Button 1026, labeled “Save,” may enable a user to save the settings of the screen 1014.

FIG. 71E illustrates a screen 1028, which may be displayed on the handheld device 40 when the third of the list items 998, labeled “Use Weather/Based Settings,” is selected. The screen 1028 may include items 1030 and 1032 for controlling the thermostat 968 based on the weather, as may be determined from an Internet location with the current weather. The list items 1030 and 1032 may enable a user to change the settings of the thermostat 986 based on the weather as reported and the ambient outdoor temperature. For example, as shown by the list item 1030, if the weather report indicates rain and that the outdoor temperature falls within a range of temperatures 1034, the thermostat 986 may follow a temperature setting 1036. In contrast, as indicated by the list item 1032, if the weather report indicates sunny weather with an outdoor temperature within a temperature range 1038, the thermostat 986 may follow a temperature setting 1040 instead. A button 1042, labeled “Save,” enable a user to save the settings of the screen 1028.

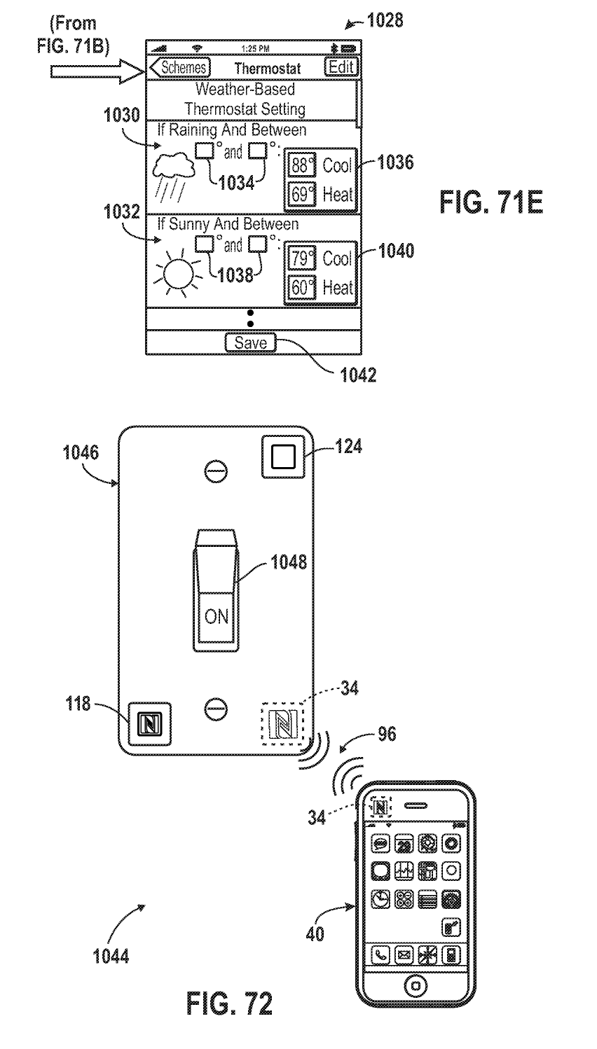

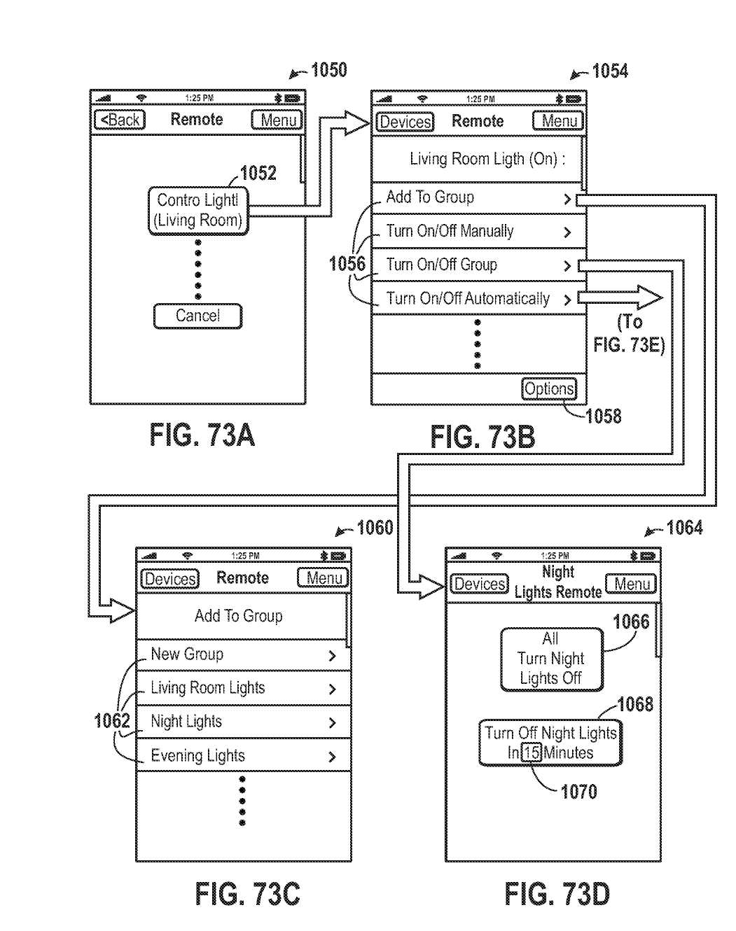

FIGS. 72-73 illustrate using the techniques described above to control a networkable light switch. Turning first to FIG. 72, a control initiation operation 1044 may enable a handheld device 40 to control a networked light switch 1046. The networked light switch 1046 may represent an embodiment of the electronic device 10, and may include a manual switch 1048 that may be controllable via the Internet or a local network.

The networkable light switch 1046 may or may not include the NFC interface 34. If the NFC 34 is present, a user may tap the handheld device 40 to the NFC interface 34 of the networkable light switch 1046 to create an NFC communication channel 96. Various control information may be transferred across the NFC communication channel 96 according to the techniques described above. If the NFC interface 34 is not present, the networkable light switch 1046 may include an RFID tag 118 or a matrix barcode tag 124, either of which may be used by the handheld device 40 to initiate control using the techniques described above.

FIGS. 73A-E illustrate screens that may be displayed on the handheld device following the control initiation operation 1044. Turning first to FIG. 73A, a screen 1050 may represent a prompt displaying a button 1052, labeled “Control Light (Living Room).” If a user selects the button 1052, a screen 1054 may be displayed on the handheld device, as illustrated in FIG. 73B. The screen 1054 may include a variety of list items 1056 which may enable a user to add the recently tapped light switch 1046 to a group of other light switches 1046, to turn the light switch 1046 on or off manually from the handheld device 40, to turn on or off a group associated with the light switch 1046 manually from the handheld device 40, or to turn the light switch 1046 on or off automatically from the handheld device 40. A button 1058, labeled “Options,” may enable a user to set, for example, which control scheme may be automatically activated when the button 1052 is selected or when the control initiation operation 1044 is undertaken.

Turning to FIG. 73C, a screen 1060 may display a series of list items 1062 when a user selects the first of the list items 1056 of FIG. 73B. As displayed on the screen 1060, the recently tapped light switch 1046 may be added to a new group or an existing group that may be preset on the handheld device 40. For example, the light switch 1046 may be added to a group entitled “Living Room Lights,” which may be turned on or off en masse from the handheld device 40; the light switch 1046 may alternatively be added to a group entitled “Night Lights,” which may be turned on at night when the user goes to sleep; and/or the light switch 1046 may be added to a group entitled “Evening Lights,” which may be turned on when the user is at home in the evening.

Turning to FIG. 73D, a screen 1064 may be displayed when a user elects to turn on or off a particular group manually from the handheld device 40. By way of example, the screen 1064 may represent a manual remote control scheme for controlling all lights associated with the “Night Lights” group. The screen 1064 may include a button 1066, labeled “Turn All Night Lights Off,” which may enable a user to turn all of the lights associated with such group from the handheld device 40. Similarly, a button 1068, labeled “Turn Off Night Lights in ______ Minutes,” may allow a user to turn off the lights associated with the group “Night Lights” in a user-specified number of minutes 1070.

A screen 1072, as shown in FIG. 73E, may be displayed when a user elects to turn on or off lights automatically. The screen 1072 may provide a number of user-adjustable settings 1074 to enable a user to set when certain lights 1046 turn on or off. Because the handheld device 40 may have access to information regarding when sunrise and sunset will occur on a given day, in addition to setting a time, such as 6:00 a.m., a user may specify a time of day, such as sunrise or sunset. A button 1076, labeled “Save,” may allow a user to save the settings 1074.

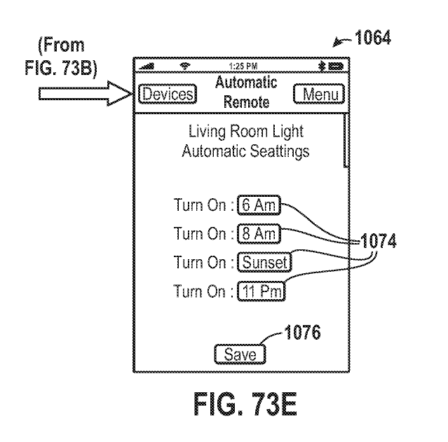

FIG. 74 illustrates a control initiation operation 1078 for controlling a home security system 1080 using a handheld device 40. The home security system 1080 may be any network security system capable of being controlled over a network or over the Internet, and may represent an embodiment of the electronic device 10. The home security system 1080 may include various buttons 1082 for automatically dialing phone numbers, such as fire or police, and a series of indicator lights 1084 for indicating the status of various entry ways into the home. A keypad 1086 may be found beneath a hinged door make of plastic.

The security system 1080 may or may not include the NFC interface 34. If the NFC 34 is present, a user may tap the handheld device 40 to the NFC interface 34 of the security system 1080 to create an NFC communication channel 96. Various control information may be transferred across the NFC communication channel 96 according to the techniques described above. If the NFC interface 34 is not present, the security system 1080 may include an RFID tag 118 or a matrix barcode tag 124, either of which may be used by the handheld device 40 to initiate control using the techniques described above.

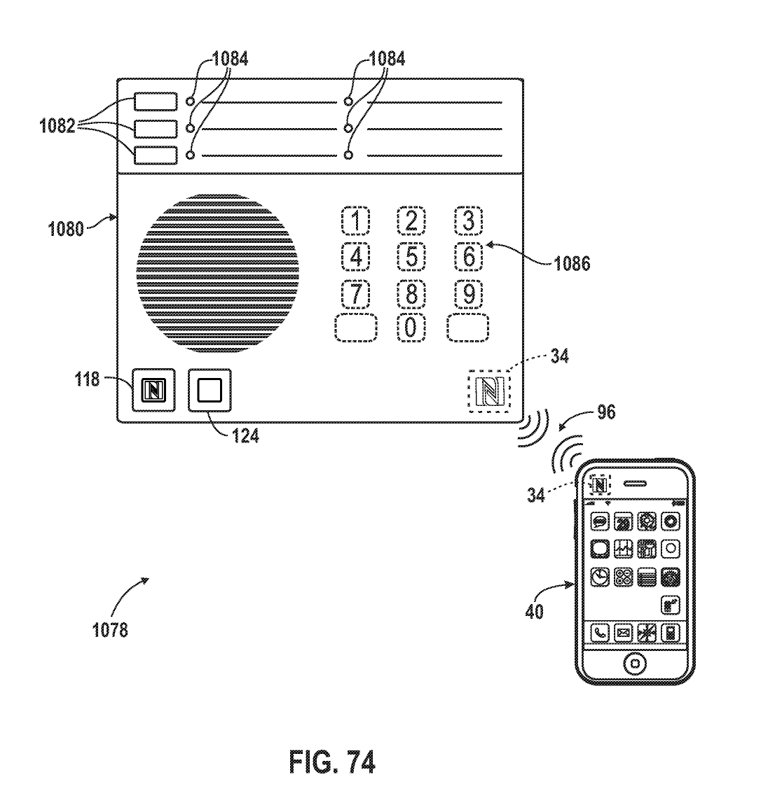

FIG. 75A depicts a screen 1088, which may represent a prompt to control the security system 1080 following the control initiation operation 1078 of FIG. 74. The screen 1088 may include a button 1090, labeled “Control Security System.” Selecting the button 1090 may cause the handheld device 40 to launch the device control application and to display a screen 1092, as illustrated in FIG. 75B. The screen 1092 may represent a control scheme associated with controlling the security system 1080, and may include a keypad 1094. The screen 1092 may further instruct the user to input a security code associated with the home security system 1080 on the keypad 1094. When the security code has been entered, the user may press a button 1096, labeled “Enter,” to provide authentication to the security system 1080 that the user has authorization to change settings associated with the security system 1080. A button 1098, labeled “Reset,” may enable a user to clear any buttons that may have been pressed, and the security code may be input as if no buttons had been pressed.

After the security code has been entered and the button 1096 has been pressed, the handheld device may display a screen 1100, as shown in FIG. 75C. The screen 1100 may include a button 1102, labeled “Arm,” and a button 1104, labeled “Disarm.” When the security system 1080 is armed, the button 1102 may or may not be present as indicated in FIG. 75C. The button 1104 may be selected to disarm the currently armed home security system 1080. A button 1106, labeled “Optional Settings,” may enable a user to automatically arm or disarm the security system 1080 based on the location of the user as determined by the location sensing circuitry 22 of the handheld device 40.

Turning to FIG. 75D, a screen 1108 may be displayed on the handheld device 40 when the button 1106, labeled “Optional Settings,” is selected. The screen 1108 may include a series of list items 1110, which may enable a user to determine, for example, when the security system 1080 may be automatically disarmed based on a distance 1112 and an associated check box 1114. Similarly the security system 1080 may be automatically armed when the user is a certain preset distance 1116 from home and an associated check box 1118 is selected. The optional settings may be saved by selecting a button 1120, labeled “Save.”

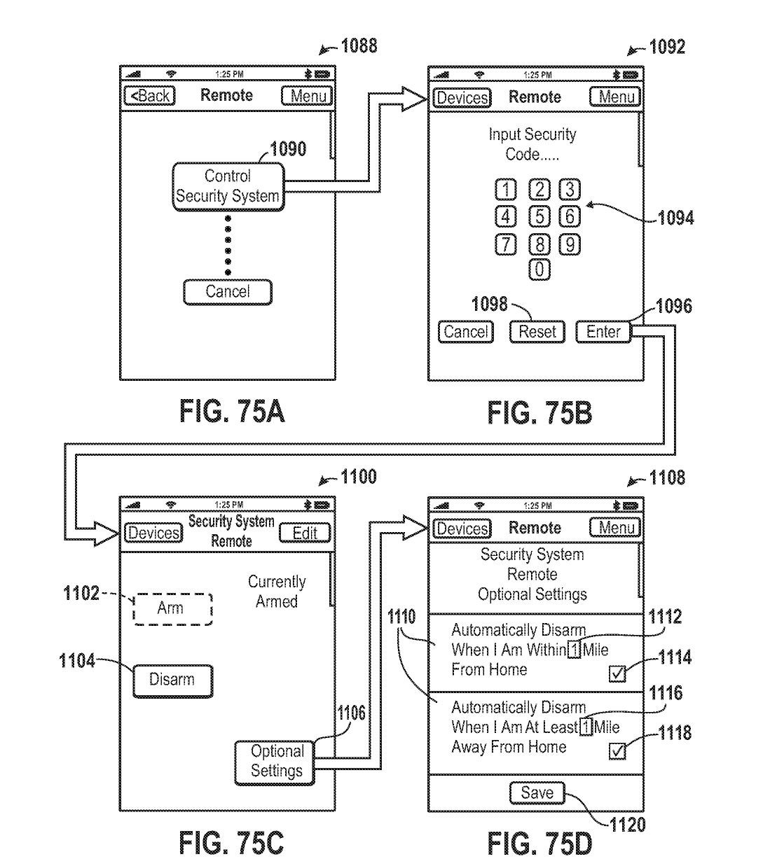

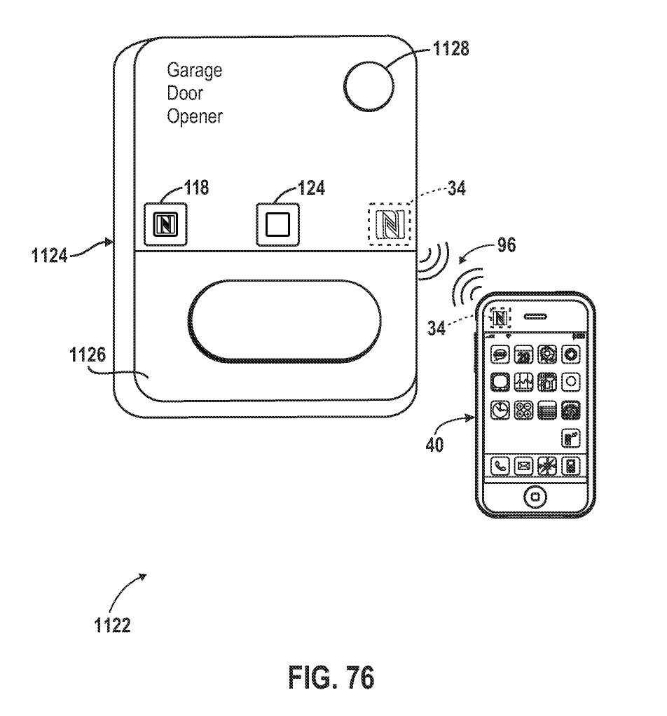

FIGS. 76-77 illustrate controlling a garage door opener using the handheld device 40 using the techniques described above. FIG. 76 depicts a control initiation operation 1122 for controlling a garage door opener 1124 using a handheld device 40. The garage door opener 1124 may be any garage door opener capable of being controlled over a network or over the Internet, and may represent an embodiment of the electronic device 10. The garage door opener 1124 may include various buttons 1126 and 1128 for automatically opening a garage door or turning on a garage light, respectively.

The garage door opener 1124 may or may not include the NFC interface 34. If the NFC 34 is present, a user may tap the handheld device 40 to the NFC interface 34 of the garage door opener 1124 to create an NFC communication channel 96. Various control information may be transferred across the NFC communication channel 96 according to the techniques described above. If the NFC interface 34 is not present, the garage door opener 1124 may include an RFID tag 118 or a matrix barcode tag 124, either of which may be used by the handheld device 40 to initiate control using the techniques described above.

FIGS. 77A-D represent screens that may be displayed on the handheld device 40 following the control initiation operation 1122. FIG. 75A depicts a screen 1130, which may represent a prompt to control the garage door opener 1124 following the control initiation operation 1122 of FIG. 76. The screen 1130 may include a button 1132, labeled “Control Security System.” Selecting the button 1132 may cause the handheld device 40 to launch the device control application and to display a screen 1134, as illustrated in FIG. 75B. The screen 1134 may represent a control scheme associated with controlling the garage door opener 1124, and may include a series of list items 1136. The list items 1136 may enable the user to control the garage door 1124 manually or based on the location of the handheld device 40, as determined by the location sensing circuitry 22. Associated check boxes 1138 may enable a user to impose a default setting. A button 1140, labeled “Save,” may enable a user to save the settings of the screen 1134.

Turning to FIG. 77C, a screen 1142 may be displayed when a user elects to use location-based settings by selecting the first list item 1136 of the screen 1134. The screen 1142 may include, for example, an option to automatically open the garage door when the user approaches within a specified distance 1144 of the house, as determined by the location sensing circuitry 22 of the handheld device 40. To save the settings of the screen 1142, a user may select a button 1146, labeled “Save.”

Turning to FIG. 77D, a screen 1148 may be displayed when a user elects to control the garage door opener 1124 manually. The screen 1148 may represent a remote control on the handheld device 40. The screen 1148 may include a button 1150, labeled “Open Door,” and button 1152, labeled “Light On.” Selecting the button 1150 may cause the garage door to be opened and selecting the button 1152 may allow an associated garage door light to be turned on.

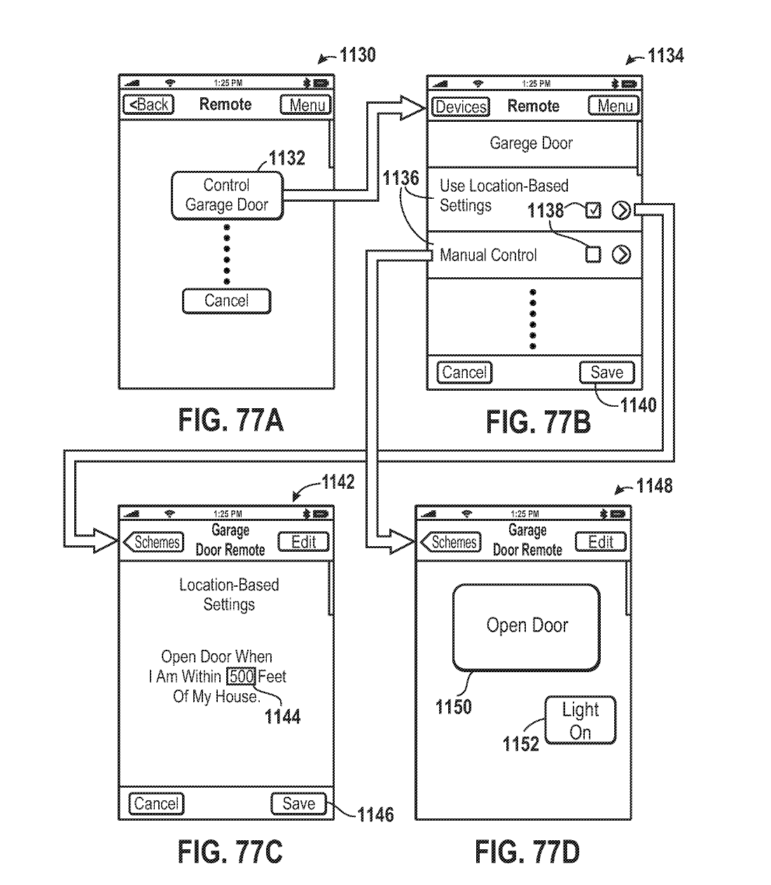

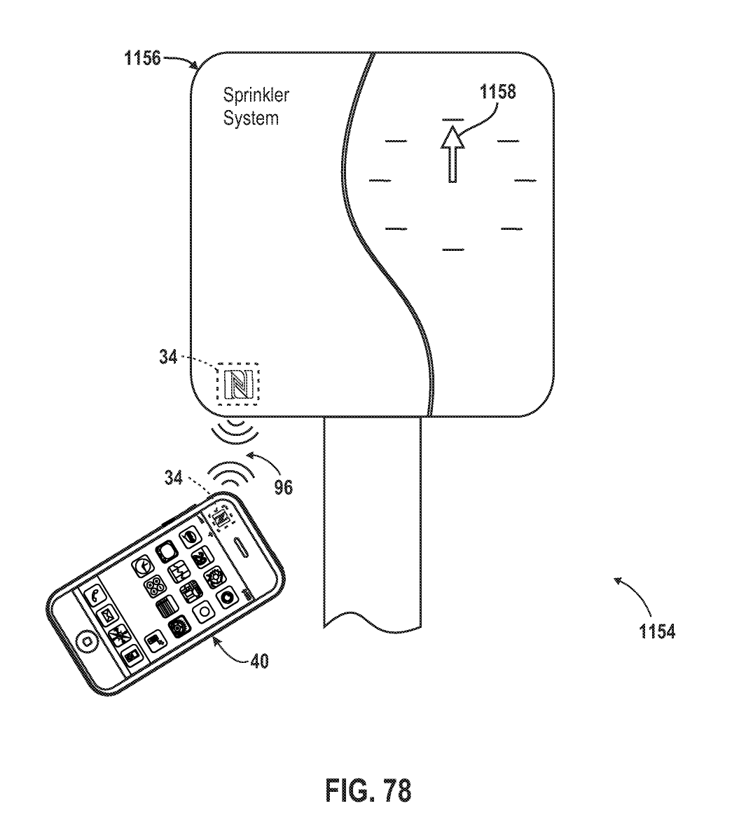

FIGS. 78-79 illustrate controlling a home sprinkler system using the handheld device 40 and the techniques described above. FIG. 78 depicts a control initiation operation 1154 for controlling a sprinkler system 1156 using a handheld device 40. The sprinkler system 1156 may be any sprinkler system capable of being controlled over a network or over the Internet, and may represent an embodiment of the electronic device 10. The sprinkler system 1156 may include various a dial 1158 and a series of buttons, which may enable a user to control the sprinkler system 1156 locally.

The sprinkler system 1156 may or may not include the NFC interface 34. If the NFC 34 is present, a user may tap the handheld device 40 to the NFC interface 34 of the sprinkler system 1156 to create an NFC communication channel 96. Various control information may be transferred across the NFC communication channel 96 according to the techniques described above. If the NFC interface 34 is not present, the sprinkler system 1156 may include an RFID tag 118 or a matrix barcode tag 124, either of which may be used by the handheld device 40 to initiate control using the techniques described above.

FIGS. 79A-D represent screens that may be displayed on the handheld device 40 following the control initiation operation 1154. FIG. 79A depicts a screen 1160, which may represent a prompt to control the sprinkler system 1156 following the control initiation operation 1154 of FIG. 78. The screen 1160 may include a button 1162, labeled “Control Sprinkler System.” Selecting the button 1162 may cause the handheld device 40 to launch the device control application and to display a screen 1172, as illustrated in FIG. 75B. The screen 1172 may represent a control scheme associated with controlling the sprinkler system 1156, and may include a series of list items 1174. The list items 1174 may allow a user to control the sprinkler system 1156 manually or automatically, for example. A button 1178, labeled “Save,” may allow a user to save the preferred settings for controlling the sprinkler system.

Turning to FIG. 79C, a screen 1164 may be displayed on the handheld device 40 when a user elects to control the sprinkler system manually by selecting the list item 1174 labeled “Manual.” The screen 1164 may include a main start button 1166 for beginning a manually started sprinkler session. A series of list items 1168 may represent various zones of the sprinkler system, and a series of list items 1170 may represent an amount of time for supplying water to the various zones of the list items 1168. In the screen 1164 illustrated by FIG. 79C, zones 1, 2, and 3 have been selected. Accordingly, when the user selects the button 1166, labeled “Start,” the sprinkler system may respond by running the sprinklers only in the zones 1, 2, and 3 for the indicated amounts of time.

Turning to FIG. 79D, a screen 1180 may be displayed on the handheld device 40 when the list item 1174 labeled “Automatic,” is selected. The screen 1180 may include, for example, a list 1182 of days on which to run the sprinkler system 1156. Moreover, a start time 1184 may be set by the user as well as a list 1186 of times which correspond to an amount of time run each sprinkler zone corresponding to the zones.

FIGS. 80-81 illustrate controlling a networkable digital camera using the handheld device 40 and the techniques described above. FIG. 80 depicts a control initiation operation 1188 for controlling a digital camera 1190 using a handheld device 40. The digital camera 1190 may be any digital camera capable of being controlled over a network or over the Internet, and may represent an embodiment of the electronic device 10. The digital camera 1190 may include, among other things, an infrared interface 25 that may be used to initiate an image capture on the digital camera 1190.

The digital camera 1190 may or may not include the NFC interface 34. If the NFC 34 is present, a user may tap the handheld device 40 to the NFC interface 34 of the digital camera 1190 to create an NFC communication channel 96. Various control information may be transferred across the NFC communication channel 96 according to the techniques described above. If the NFC interface 34 is not present, the digital camera 1190 may include an RFID tag 118 or a matrix barcode tag 124, either of which may be used by the handheld device 40 to initiate control using the techniques described above.

FIGS. 81A-B represent screens that may be displayed on the handheld device 40 following the control initiation operation 1188. FIG. 81A depicts a screen 1192, which may represent a prompt to control the digital camera 1190 following the control initiation operation 1188 of FIG. 80. The screen 1192 may include a button 1194, labeled “Control Digital Camera.” Selecting the button 1194 may cause the handheld device 40 to launch the device control application and to display a screen 1196, as illustrated in FIG. 81B. The screen 1196 may represent a control scheme associated with controlling the digital camera 1190, and may include, among other things, a preview window 1198 displaying various images from the digital cameral 1190, if the control screen between the handheld device 40 and the digital camera 1190 has sufficient bandwidth. The screen 1196 may further include buttons 1200 and 1202, labeled “Zoom In,” and “Zoom Out,” respectively, which may offer corresponding functionality. A button 1204 may enable a user to initiate image capture with the digital camera 1190 from a distance away. A button 1206 may enable a user to take the image from a distance using a delay 1208 of a certain number of seconds.

One or more specific embodiments of the present invention have described above. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

What is claimed is:

1. A method, comprising:
discovering, on a processor-based handheld device, a plurality of controllable devices via a wireless communications network;
displaying, on a display of the handheld device, a plurality of selectable visual items representing the discovered plurality of controllable devices;
receiving one or more inputs on the handheld device, wherein the one or more inputs correspond to selecting one or more of the discovered plurality of controllable devices;
loading and storing processor-executable instructions to control the selected one or more of the discovered plurality of controllable devices; and
controlling the selected one or more of the discovered plurality of controllable devices by executing the processor-executable instructions via the handheld device.

2. The method of claim 1, wherein discovering the plurality of controllable devices is executed via a near field communication wireless communications network.

3. The method of claim 1, wherein discovering the plurality of controllable devices comprises searching the wireless communications network for identification broadcast protocol messages corresponding to the plurality of controllable devices.

4. The method of claim 1, wherein the plurality of selectable visual items comprises text elements, graphical elements, or combinations thereof.

5. The method of claim 4, wherein the plurality of selectable visual items comprises three-dimensional depictions of the discovered plurality of controllable devices.

6. The method of claim 1, wherein the processor-executable instructions comprise identification broadcast protocol messages corresponding to the selected one or more of the discovered plurality of controllable devices.

7. The method of claim 6, wherein the identification broadcast protocol messages comprise control information corresponding to the selected one or more of the discovered plurality of controllable devices.

8. The method of claim 1, wherein the processor-executable instructions comprise one or more control software plug-ins enabling control of the selected one or more of the discovered plurality of controllable devices via the handheld device.

9. A handheld device, comprising:
a display;
a memory encoding one or more processor-executable instructions; and
a processor configured to load the one or more processor-executable instructions when encoded from the memory, wherein the one or more processor-executable instructions, when executed by the processor, cause acts to be performed comprising:
discovering, a plurality of controllable devices via a wireless communications network;
displaying, on the display, a plurality of selectable visual items representing the discovered plurality of controllable devices;
receiving one or more inputs that correspond to selecting one or more of the discovered plurality of controllable devices;
loading and storing one or more additional processor-executable instructions to control the selected one or more of the discovered plurality of controllable devices; and
controlling the selected one or more of the discovered plurality of controllable devices by executing the one or more additional processor-executable instructions.

10. The handheld device of claim 9, wherein the display comprises a plurality of selectable three-dimensional depictions, text elements, or combinations thereof of the discovered plurality of controllable devices depending on the orientation of the handheld device.

11. The handheld device of claim 9, wherein the one or more processor-executable instructions configures the processor to establish communication with the discovered plurality of controllable devices via a near field communication wireless communications network.

12. The handheld device of claim 9, wherein the one or more processor-executable instructions configures the processor to establish communication with the discovered plurality of controllable devices via a cellular communication wireless communications network.

13. The handheld device of claim 9, wherein the processor is configured to concurrently execute one or more control software plug-ins and telephone functionality.

14. The handheld device of claim 9, wherein the one or more additional processor-executable instructions comprise at least one or more control software plug-ins, matrix-code-reading software, identification broadcast protocol messages, or combinations thereof.

15. The handheld device of claim 14, wherein the one or more control software plug-ins, matrix-code-reading software, or identification broadcast protocol messages comprise control information to configure the processor to control the selected one or more of the discovered plurality of controllable devices.

16. One or more non-transitory computer-readable media encoding one or more processor-executable instructions, wherein the one or more processor-executable instructions, when executed by a processor, cause acts to be performed comprising:
discovering, on a processor-based handheld device, a plurality of controllable devices via a wireless communications network;
displaying, on a display of the handheld device, a plurality of selectable visual items representing the discovered plurality of controllable devices;
receiving one or more inputs on the handheld device, wherein the one or more inputs correspond to selecting one or more of the discovered plurality of controllable devices;
associating a first selected controllable device of the discovered plurality of controllable devices with a second discovered or stored plurality of controllable devices;
loading and storing one or more additional processor-executable instructions to concurrently control the first selected controllable device of the discovered plurality of controllable devices and the second discovered or stored plurality of controllable devices; and
controlling the first selected controllable device of the discovered plurality of controllable devices with the second discovered or stored plurality of controllable devices by executing the one or more additional processor-executable instructions via the handheld device.

17. The one or more non-transitory computer-readable media encoding one or more processor-executable instructions of claim 16, wherein the plurality of selectable visual items comprises text elements, graphical elements, or combinations thereof.

18. The one or more non-transitory computer-readable media encoding one or more processor-executable instructions of claim 16, wherein the one or more additional processor-executable instructions comprise one or more control software plug-ins enabling concurrent control of the first selected controllable device of the discovered plurality of controllable devices and the second discovered or stored plurality of controllable devices via the handheld device.
